(19) United States
(12) Patent Application Publication
(10) Pub. No.: US 2026/0327127 A1
(43) Pub. Date: Oct. 22, 2026

(54) Window Unit Having a Patterned Primer Layer for Reducing Bird Collisions and Methods of Making the Same

(71) Applicant: Vitro Flat Glass LLC, Cheswick, PA (US)

(72) Inventor: Jessica Smith, Cheswick, PA (US)

(21) Appl. No.: 19/578,990

(22) Filed: Mar. 26, 2026

Related U.S. Application Data
(60) Provisional application No. 63/780,864, filed on Mar. 31, 2025.

(51) Int. Cl. C03C 17/36; A01M 29/08

(52) U.S. Cl. CPC C03C 17/3681; A01M 29/08; C03C 17/3639; C03C 17/3642; C03C 17/3644; C03C 17/3649; C03C 2217/211; C03C 2217/212; C03C 2217/256; C03C 2217/258; C03C 2217/27

(57) ABSTRACT

A coated article including a substrate including a first side and a second side and a functional coating positioned over at least a portion of the second side is provided. The functional coating includes a base layer over at least a portion of the second surface, a metallic layer over at least a portion of the base layer, a primer layer comprising a patterned feature over at least a portion of the metallic layer, and a top layer over at least a portion of the primer layer. The primer layer includes a first primer film over at least a portion of the metallic layer and a second primer film over at least a portion of the first primer film, wherein one of the first primer film or the second primer film includes the patterned feature. Methods of making a coated article and an insulating glass unit are also provided.

### CROSS REFERENCE TO RELATED APPLICATIONS

This application claims priority to U.S. Provisional Application No. 63/780,864, filed Mar. 31, 2025, the disclosure of which is incorporated by reference herein in its entirety.

### BACKGROUND OF THE INVENTION

### Field of the Invention

This invention relates generally to coated articles having a functional coating comprising a patterned feature on the second side of a substrate, such as a glass substrate.

### SUMMARY OF THE INVENTION

The invention relates to a coated article. The coated article comprises a substrate comprising a first side comprising a first surface and a second side comprising a second surface, wherein the second surface is opposite the first surface and a functional coating positioned over at least a portion of the second side. The functional coating comprises: a base layer positioned over at least a portion of the second surface; a metallic layer positioned over at least a portion of the base layer; a primer layer comprising a patterned feature positioned over at least a portion of the metallic layer, wherein the primer layer comprises: a first primer film positioned over at least a portion of the metallic layer, and a second primer film positioned over at least a portion of the first primer film, wherein one of the first primer film or the second primer film comprises the patterned feature; and a top layer positioned over at least a portion of the primer layer.

The invention also relates to a method of making a coated article. The method comprises providing a substrate comprising a first side comprising a first surface and a second side comprising a second surface, wherein the second surface is opposite the first surface and forming a functional coating over at least a portion of the second side. Forming the functional coating comprises: forming a base layer over at least a portion of the second surface; forming a metallic layer over at least a portion of the base layer; forming a primer layer comprising a patterned feature over at least a portion of the metallic layer, wherein forming the primer layer comprises: forming a first primer film over at least a portion of the metallic layer, and forming a second primer film over at least a portion of the first primer film, wherein one of the first primer film or the second primer film comprises the patterned feature; and forming a top layer over at least a portion of the metallic layer.

The invention also relates to an insulating glass unit. The insulating glass unit comprises: a first ply comprising a first side comprising a No. 1 surface and a second side comprising a No. 2 surface, wherein the No. 2 surface is opposite the No. 1 surface, a second ply comprising a first side comprising a No. 3 surface and a second side comprising a No. 4 surface, wherein the No. 4 surface opposite the No. 3 surface, wherein the first ply and second ply are connected together; and a functional coating positioned over at least a portion of the second side comprising the No. 2 surface. The functional coating comprises: a base layer positioned over at least a portion of the No. 2 surface; a metallic layer positioned over at least a portion of the base layer; a primer layer comprising a patterned feature positioned over at least a portion of the metallic layer, wherein the primer layer comprises: a first primer film positioned over at least a portion of the metallic layer, and a second primer film positioned over at least a portion of the first primer film, wherein one of the first primer film or the second primer film comprises the patterned feature; and a top layer positioned over at least a portion of the metallic layer.

### BRIEF DESCRIPTION OF THE DRAWINGS

The invention will be described with reference to the following drawing figures wherein like reference numbers identify the parts throughout.

FIGS. 1A-1C are front views (not to scale) of substrates having symmetric patterned features in the primer layer, where the patterned feature is in the form of stripes. Horizontal patterned features are shown in FIG. 1A, vertical patterned features are shown in FIG. 1B, and diagonal patterned features are shown in FIG. 1C, where the patterned features are formed in the functional coating positioned over the second side of a substrate.

FIGS. 2A-2B are sectional views (not to scale) of single metal functional coatings having a symmetric patterned feature, wherein the patterned feature is in a first primer film of a first primer layer (FIG. 2A) or a second primer film of a first primer layer (FIG. 2B).

FIGS. 3A-3D are sectional views (not to scale) of double metal functional coatings having a symmetric patterned feature, wherein the patterned feature is in a first primer film of a first primer layer (FIG. 3A), a second primer film of a first primer layer (FIG. 3B), a first primer film of a second primer layer (FIG. 3C), or a second primer film of a second primer layer (FIG. 3D).

FIGS. 4A-4F are sectional views (not to scale) of triple metal functional coatings having a symmetric patterned feature, wherein the patterned feature is in a first primer film of a first primer layer (FIG. 4A), a second primer film of a first primer layer (FIG. 4B), a first primer film of a second primer layer (FIG. 4C), a second primer film of a second primer layer (FIG. 5D), a first primer film of a third primer layer (FIG. 5E), or a second primer film of a third primer layer (FIG. 5E).

FIGS. 5A-5H are sectional views (not to scale) of quadruple metal functional coatings having a symmetric patterned feature, wherein the patterned feature is in a first primer film of a first primer layer (FIG. 5A), a second primer film of a first primer layer (FIG. 5B), a first primer film of a second primer layer (FIG. 5C), a second primer film of a second primer layer (FIG. 5D), first primer film of a third primer layer (FIG. 5E), a second primer film of a third primer layer (FIG. 5F), a first primer film of a fourth primer layer (FIG. 5G), or a second primer film of a fourth primer layer (FIG. 5H).

FIGS. 6A-6B are sectional views (not to scale) of base layers of the functional coatings according to the invention.

FIG. 7 is a sectional view (not to scale) of a second layer of the functional coatings according to the invention.

FIG. 8 is a sectional view (not to scale) of a third layer of the functional coatings according to the invention.

FIG. 9 is a sectional view (not to scale) of a fourth layer of the functional coatings according to the invention.

FIG. 10 is a sectional view (not to scale) of a top layer of the functional coatings according to the invention.

FIG. 11 is a top down view (not to scale) of an exemplary polymeric mask comprising a plurality of openings.

FIGS. 12A and 12B are top down views (not to scale) of exemplary metallic masks comprising a plurality of openings.

FIG. 13 is a side view (not to scale) of an exemplary insulating glass unit (“IGU”) having a coating of the invention.

### DESCRIPTION OF THE INVENTION

As used herein, spatial or directional terms, such as “left”, “right”, “inner”, “outer”, “above”, “below”, and the like, relate to the invention as it is shown in the drawing figures. However, it is to be understood that the invention can assume various alternative orientations and, accordingly, such terms are not to be considered as limiting. Further, as used herein, all numbers expressing dimensions, physical characteristics, processing parameters, quantities of ingredients, reaction conditions, and the like, used in the specification and claims are to be understood as being modified in all instances by the term “about”. Accordingly, unless indicated to the contrary, the numerical values set forth in the following specification and claims may vary depending upon the desired properties sought to be obtained by the present invention. At the very least, and not as an attempt to limit the application of the doctrine of equivalents to the scope of the claims, each numerical value should at least be construed in light of the number of reported significant digits and by applying ordinary rounding techniques. Moreover, all ranges disclosed herein are to be understood to encompass the beginning and ending range values and any and all subranges subsumed therein. For example, a stated range of “1 to 10” should be considered to include any and all subranges between (and inclusive of) the minimum value of 1 and the maximum value of 10; that is, all subranges beginning with a minimum value of 1 or more and ending with a maximum value of 10 or less, e.g., 1 to 3.3, 4.7 to 7.5, 5.5 to 10, and the like. Further, as used herein, the terms “formed over”, “deposited over”, or “provided over” mean formed, deposited, or provided on but not necessarily in contact with the surface. For example, a coating layer “formed over” a substrate does not preclude the presence of one or more other coating layers or films of the same or different composition located between the formed coating layer and the substrate. The terms “visible region”, “visible light”, or “visible light spectrum” refer to electromagnetic radiation having a wavelength in the range of 380 nm to 800 nm. The terms “infrared region”, “infrared radiation”, or “infrared spectrum” refer to electromagnetic radiation having a wavelength in the range of greater than 800 nm to 100,000 nm. The terms “ultraviolet region”, “ultraviolet radiation”, or “ultraviolet (UV) spectrum” mean electromagnetic energy having a wavelength in the range of 300 nm to less than 380 nm. Additionally, all documents, such as, but not limited to, issued patents and patent applications, referred to herein are to be considered to be “incorporated by reference” in their entirety. As used herein, the term “film” refers to a coating region of a desired or selected coating composition. A “layer” can comprise one or more “films”, and a “coating” or “coating stack” can comprise one or more “layers”. The term “asymmetrical reflectivity” means that the visible light reflectance of the coating from one side is different than that of the coating from the opposite side. The term “critical thickness” means a thickness above which a coating material forms a continuous, uninterrupted layer and below which the coating material forms discontinuous regions or islands of the coating material rather than a continuous layer. The term “subcritical thickness” means a thickness below the critical thickness such that the coating material forms isolated, non-connected regions of the coating material. The term “islanded” means that the coating material is not a continuous layer but, rather, that the material is deposited to form isolated regions or islands.

Weight percentages (wt. %) of the metal oxides, metal alloys, metal nitrides, or metal oxynitrides, as used herein, are based on the total weight of the metal components and exclude the weight of any oxide, nitride, or oxynitride components.

The invention is directed to a coated article. The coated article comprises a substrate comprising a first side comprising a first surface and a second side comprising a second surface, where the second surface is opposite the first surface. The coated article further comprises a functional coating positioned over at least a portion of the second side. The functional coating comprises a base layer positioned over at least a portion of the second surface. The functional coating further comprises a metallic layer positioned over at least a portion of the base layer. The functional coating further comprises a primer layer comprising a patterned feature positioned over at least a portion of the metallic layer, wherein the primer layer comprises: a first primer film positioned over at least a portion of the metallic layer, and a second primer film positioned over at least a portion of the first primer film, wherein one of the first primer film or the second primer film comprises the patterned feature. The functional coating further comprises a top layer positioned over at least a portion of the primer layer. Optionally, the functional coating may further comprise a second layer, a second primer layer, a second metallic layer, a third layer, a third primer layer, a third metallic layer, a fourth layer, a fourth primer layer, a fourth metallic layer, and/or an outermost protective coating. One of the first primer layer, the second primer layer, the third primer layer, or the fourth primer layer comprises the patterned feature, the first primer film, and the second primer film and one of the first primer film or the second primer film comprises the patterned feature.

The coated article 10 comprises a substrate 12. The substrate 12 can be of any desired material having any desired characteristics, such as opaque, translucent, or transparent to visible light. For example, the substrate 12 can be transparent or translucent to visible light. By “transparent” is meant having visible light transmission of greater than 0% up to 100%. Alternatively, the substrate 12 can be translucent. By “translucent” is meant allowing electromagnetic energy (e.g., visible light) to pass through but diffusing this energy such that objects on the side opposite the viewer are not clearly visible. Examples of suitable materials include, but are not limited to, plastic substrates (such as acrylic polymers, such as polyacrylates; polyalkylmethacrylates, such as polymethylmethacrylates, polyethylmethacrylates, polypropylmethacrylates, and the like; polyurethanes; polycarbonates; polyalkylterephthalates, such as polyethyleneterephthalate (PET), polypropyleneterephthalates, polybutyleneterephthalates, and the like; polysiloxane-containing polymers; or copolymers of any monomers for preparing these, or any mixtures thereof); ceramic substrates; glass substrates; or mixtures or combinations of any of the above. For example, the substrate 12 can be conventional soda-lime-silicate glass, borosilicate glass, or leaded glass. The glass can be clear glass. By “clear glass” is meant non-tinted or non-colored glass. Alternatively, the glass can be tinted or otherwise colored glass. The glass can be annealed or heat-treated glass. As used herein, the term “heat treated” means tempered or at least partially tempered. The glass can be of any type, such as conventional float glass, and can be of any composition having any optical properties, e.g., any value of visible transmission, ultraviolet transmission, infrared transmission, and/or total solar energy transmission. By “float glass” is meant glass formed by a conventional float process in which molten glass is deposited onto a molten metal bath and controllably cooled to form a float glass ribbon. Examples of float glass processes are disclosed in U.S. Pat. Nos. 4,466,562 and 4,671,155, which are incorporated herein by reference.

The substrate 12 may comprise, for example, clear float glass or can be tinted or colored glass. The substrate 12 can be of any desired dimensions, e.g., length, width, shape, or thickness. In one non-limiting embodiment in which the substrate is an architectural transparency, the substrate 12 may be 1 mm to 30 mm thick, such as 2.5 mm to 25 mm thick, such as 2.5 mm to 10 mm. As used herein, the term “architectural transparency” refers to any transparency located on a building, such as, but not limited to, windows and sky lights. However, it is to be understood that the invention is not limited to use with such architectural transparencies but could be practiced with transparencies in any desired field, such as, but not limited to, laminated or non-laminated residential and/or commercial windows, insulating glass units, and/or transparencies for land, air, space, above water and underwater vehicles, as well as personal transparencies such as glasses and the like. Therefore, it is to be understood that the specifically disclosed exemplary embodiments are presented simply to explain the general concepts of the invention, and that the invention is not limited to these specific exemplary embodiments. Additionally, while a typical “transparency” can have sufficient visible light transmission such that materials can be viewed through the transparency, in the practice of the invention, the “transparency” need not be transparent to visible light but may be translucent or opaque.

In some embodiments, the substrate 12 can be a monolithic glazing. By “monolithic” is meant having a single structural support or structural member, e.g. having a single substrate.

The substrate 12 comprises a first side comprising a first surface 14 and a second side comprising a second surface 16, where the second surface 16 is opposite the first surface 14.

As used herein, “patterned feature” refers to a design or designs across the substrate, where the design could be a repeated design across the substrate.

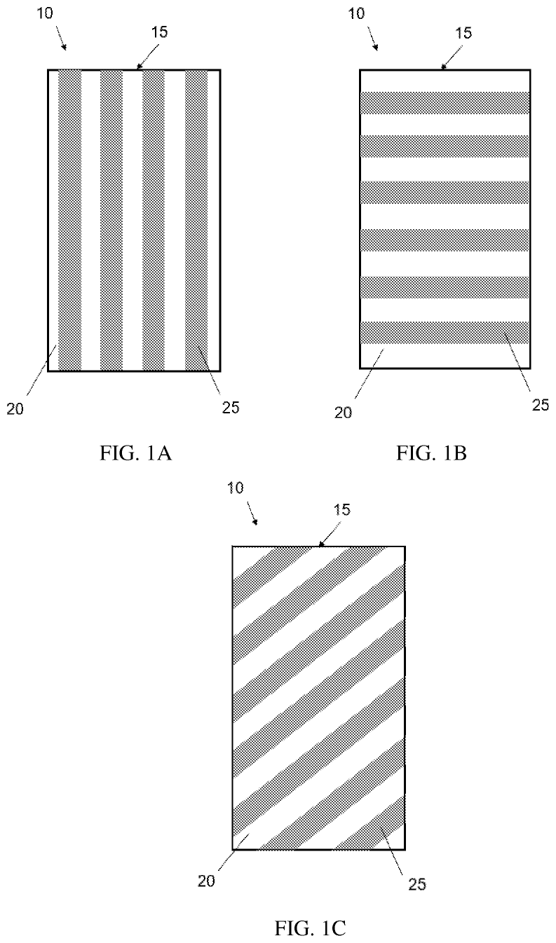

The patterned feature may include a symmetric pattern. For example, the symmetric pattern may comprise stripes 25. The stripes 25 may comprise a width of at least 0.1 inch (2.54 mm), at least 0.25 inch (6.35 mm), at least 0.5 inch (12.7 mm), at least 0.75 inch (19.05 mm), at least 1 inch (25.4 mm), or at least 2 inches (50.8 mm). The stripes 25 may be spaced 1 inch (25.4 mm) or less apart from one another across the substrate 12. For example, the stripes 25 may be spaced at least 0.1 inch (2.54 mm), at least 0.25 inch (6.35 mm), at least 0.5 inch (12.7 mm), at least 0.75 inch (19.05 mm), or 1 inch (25.4 mm) from each other across the substrate 12. Alternatively, the stripes 25 may be spaced by at least 1.5 inches (38.1 mm), at least 1.75 inches (44.5 mm), at least 2 inches (50.8 mm), such as by at least 3 inches (76.2 mm), or such as by at least 4 inches (101.6 mm) apart across the substrate 12. When the substrate 12 is an architectural transparency installed in a building, the top edge 15 of the substrate 12 is positioned closest to the roof of the building and is parallel to the roof of the building. The stripes 25 may be positioned horizontally across the substrate 12 (FIG. 1A). When the stripes 25 are positioned horizontally across the substrate 12, the stripes 25 are parallel to the top edge 15 of the substrate. The stripes 25 may be positioned vertically across the substrate 12, such as in the direction of gravity (FIG. 1B). The stripes 25 maybe positioned diagonally across the substrate 12 (FIG. 1C). In one non-limiting embodiment, the stripes are 25 are positioned horizontally across the substrate 12 and are spaced 1 inch or less apart from one another. In one non-limiting embodiment, the stripes 25 are positioned horizontally across the substrate 12 and are spaced apart from one another by at least 1.5 inches. In another non-limiting embodiment, the stripes are 25 are positioned horizontally across the substrate 12 and are spaced apart from one another by at least 1.75 inches. In another non-limiting embodiment, the stripes 25 are positioned horizontally across the substrate 12 and are spaced apart from one another by at least 2 inches. In another non-limiting embodiment, the stripes are 25 are positioned vertically across the substrate 12 and are spaced 1 inch or less apart from one another. In another non-limiting embodiment, the stripes are 25 are positioned vertically across the substrate 12 and are spaced apart from one another by at least 1.5 inches. In another non-limiting embodiment, the stripes are 25 are positioned vertically across the substrate 12 and are spaced apart from one another by at least 1.75 inches. In another non-limiting embodiment, the stripes are 25 are positioned vertically across the substrate 12 and are spaced apart from one another by at least 2 inches. In another non-limiting embodiment, the stripes 25 are positioned vertically across the substrate 12 and are spaced apart from one another by at least 4 inches.

The patterned feature may include an asymmetric pattern. As used herein, “asymmetric pattern” refers to a non-repeating design or non-repeating designs across the second surface of the substrate. The asymmetric pattern may comprise portions that do not correspond to other portions in shape, size, and/or arrangement.

The asymmetric patterned feature 18 may be in the form of a random arrangement of geometric shapes, free-form shapes, images, or combinations thereof. For example, the asymmetric pattern may be a random arrangement of geometric shapes. For example, the asymmetric pattern may be a random arrangement of images. For example, the asymmetric pattern may be a random arrangement of free-form shapes.

For example, the asymmetric pattern may be in the form of a plurality of overlapping, randomly oriented stripes, such as those described in U.S. Pat. No. 9,247,726 B2. The stripes of the asymmetric pattern may comprise a width of from 0.125 inch (3.175 mm) to 1 inch (25.4 mm). For example, the stripes of the asymmetric pattern may comprise a width of 0.125 inch (3.175 mm), such as 0.25 inch (6.35 mm), such as 0.5 inch, such as 0.75 inch (19.05 mm), or such as 1 inch (25.4 mm). The stripes of the asymmetric pattern may all comprise the same width. The stripes of the asymmetric pattern may comprise different widths. Alternatively, the asymmetric pattern may be in the form of a spider web design, such as the spider web design described in U.S. Pat. No. 9,247,726 B2.

The symmetric pattern or the asymmetric pattern may be visible to birds. The symmetric pattern or the asymmetric pattern may be selected to deter bird collisions from occurring with the substrate 12.

A functional coating 20 is applied onto the second side of the substrate 12, where the second side comprises the second surface 16. The functional coating 20 may be a solar control coating. As used herein, the term “solar control coating” refers to a coating comprised of one or more layers or films that affect the solar properties of the coated article, such as, but not limited to, the amount of solar radiation, for example, visible, infrared, or ultraviolet radiation, reflected from, absorbed by, or passing through the coated article; shading coefficient; emissivity, etc. The functional coating 20 can block, absorb, reflect, or filter selected portions of the solar spectrum, such as, but not limited to, the IR, UV, and/or visible spectrums.

The functional coatings 20 described herein can be deposited by any useful method, such as, but not limited to, conventional chemical vapor deposition (CVD) and/or physical vapor deposition (PVD) methods. Examples of CVD processes include spray pyrolysis. Examples of PVD processes include electron beam evaporation and vacuum sputtering (such as, magnetron sputter vapor deposition (MSVD)). Other coating methods could also be used, such as, but not limited to, sol-gel deposition, slot die coating deposition, or printing depositions, such as, screen printing or ink jet printing. In one non-limiting embodiment, the functional coating 20 is deposited by MSVD. Examples of MSVD coating devices and methods will be well understood by one of ordinary skill in the art and are described, for example, in U.S. Pat. Nos. 4,379,040; 4,861,669; 4,898,789; 4,898,790; 4,900,633; 4,920,006; 4,938,857; 5,328,768; and 5,492,750, which are incorporated herein by reference.

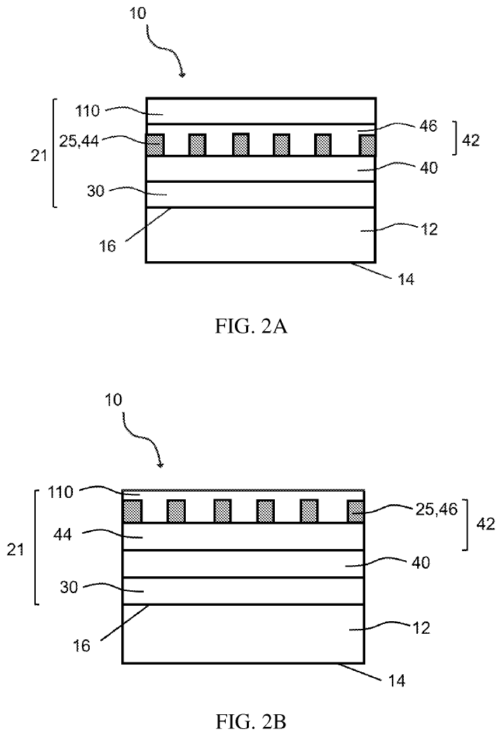

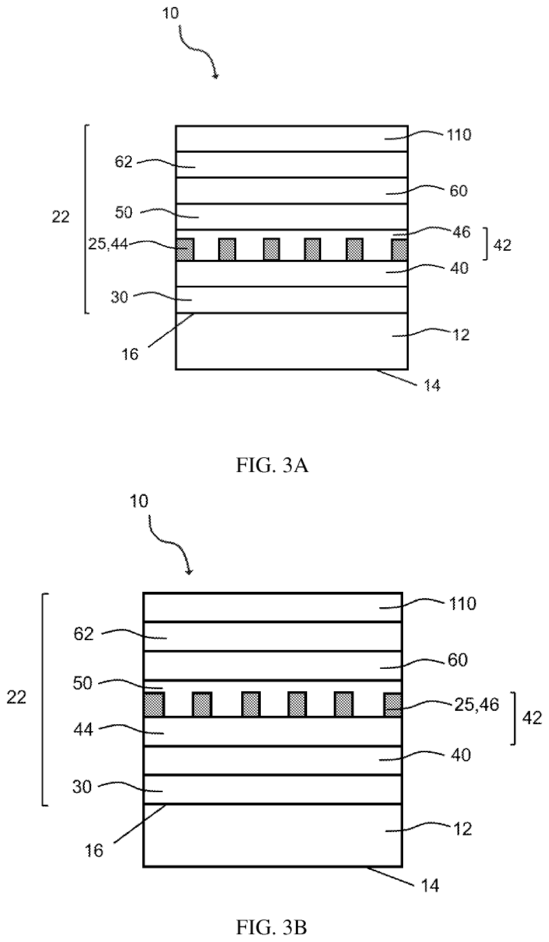

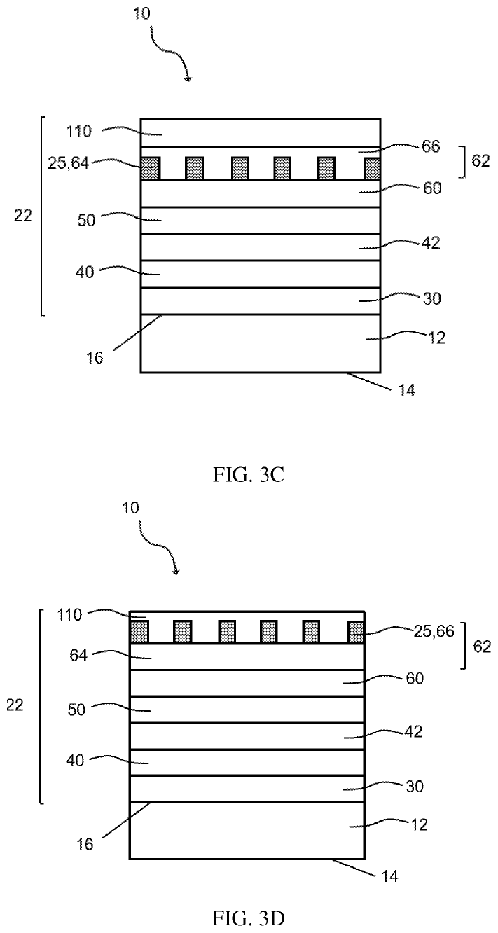

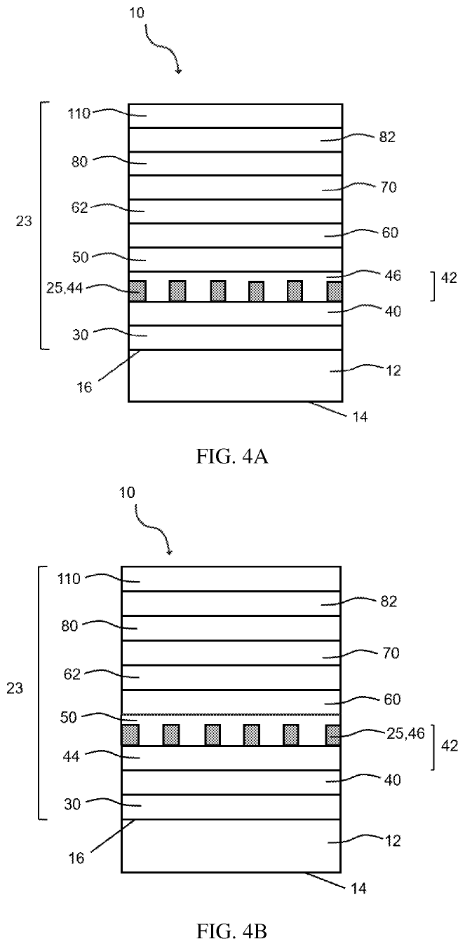

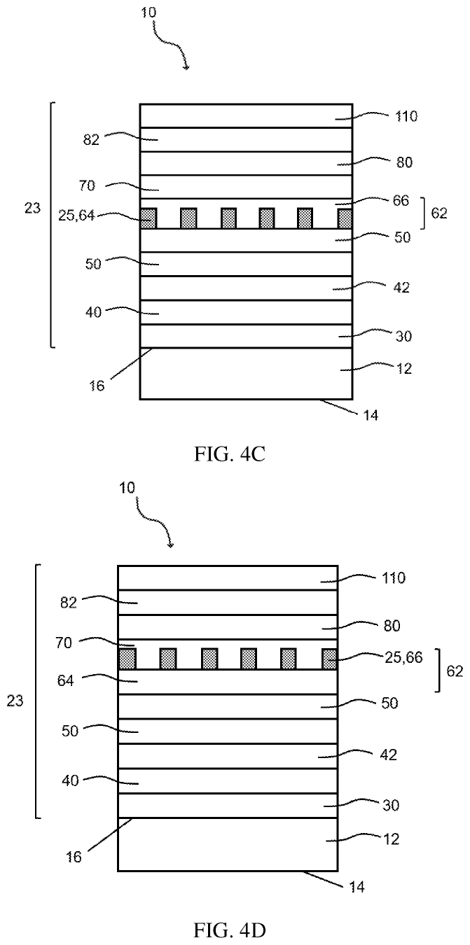

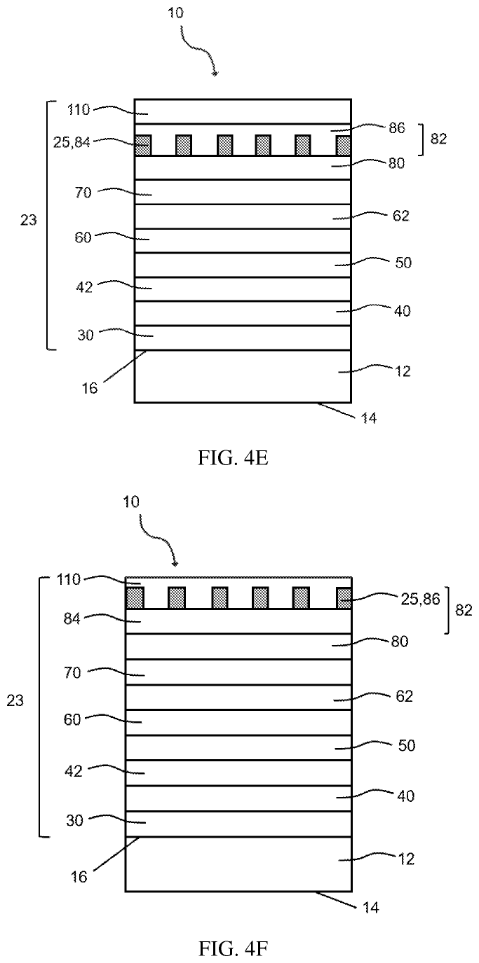

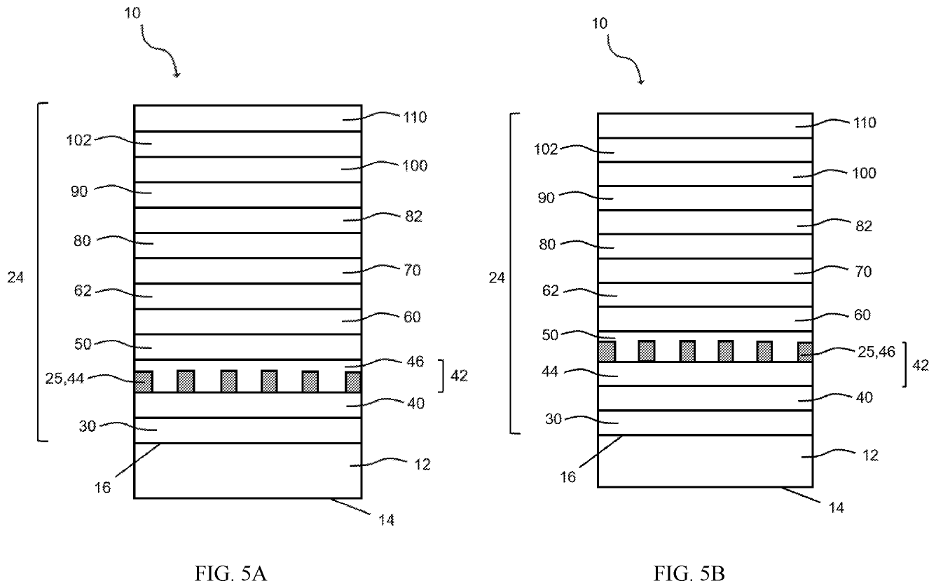

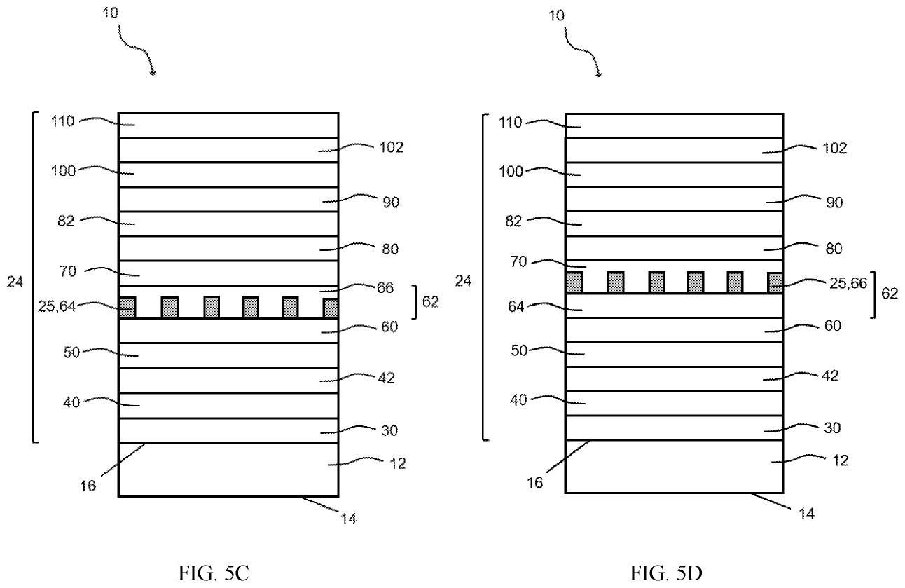

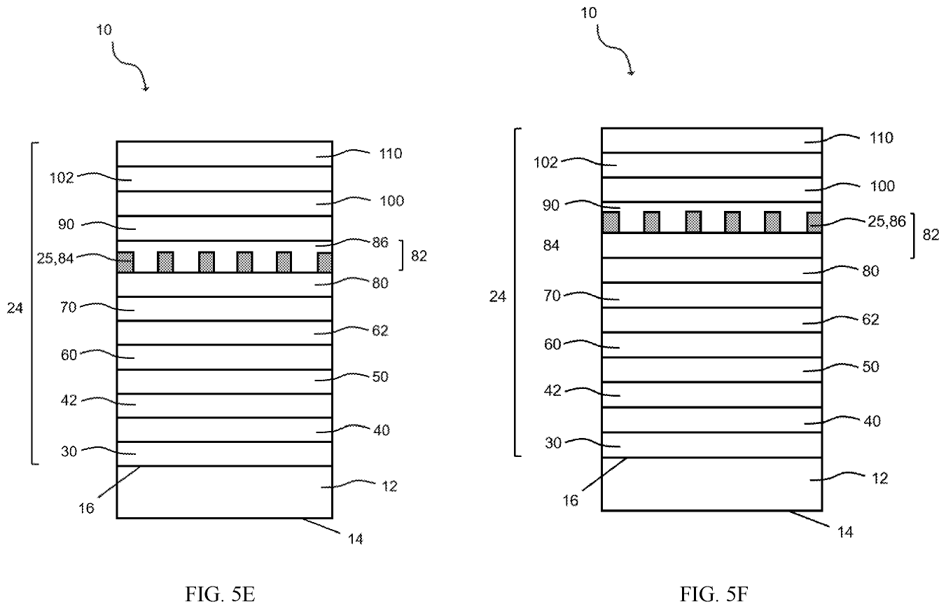

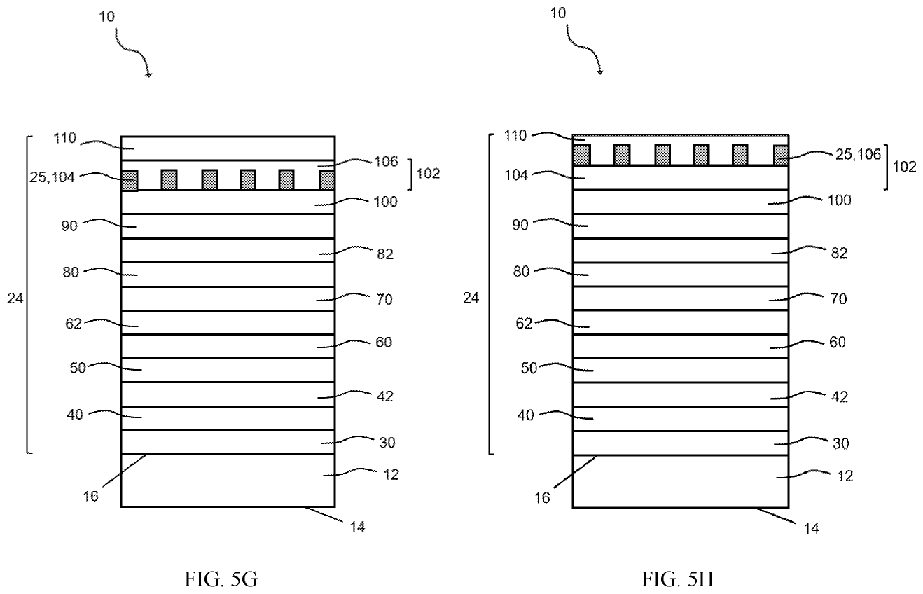

The functional coating 20 can be a single metal functional coating 21 (e.g., one metallic layer), or a double metal functional coating 22 (e.g., two metallic layers), or a triple metal functional coating 23 (e.g., three metallic layers), or a quadruple metal functional coating 24 (e.g., four metallic layers). An exemplary non-limiting coating suitable for the single metal functional coating 21 is shown in FIGS. 2A-2B. Exemplary non-limiting coatings suitable for the double metal functional coating 22 are shown in FIGS. 3A-3D. Exemplary non-limiting coatings suitable for the triple metal functional coating 23 are shown in FIGS. 4A-4F. Exemplary non-limiting coatings suitable for the quadruple metal functional coating 24 are shown in FIGS. 5A-5H.

Exemplary functional coatings 20 including one metallic layer (i.e., a single metal functional coating 21) are shown in FIGS. 2A and 2B. The single metal functional coating 21 includes a base layer 30 positioned over and in direct contact with the second surface 16 of the substrate 12. The base layer 30 may be positioned over and in direct contact with a portion or the entire second surface 16 of the substrate 12. A metallic layer 40 is positioned over or in direct contact with at least a portion of the base layer 30. A first primer layer 42 comprising a patterned feature is positioned over or in direct contact with at least a portion of the metallic layer 40. The first primer layer 42 comprising the patterned feature positioned over at least a portion of the metallic layer 40 comprises a first primer film 44 positioned over at least a portion of the metallic layer 40, and a second primer film 46 positioned over at least a portion of the first primer film 44, wherein one of the first primer film 44 or the second primer film 46 comprises the patterned feature. A top layer 110 is positioned over or in direct contact with at least a portion of the first primer layer 42. An optional outermost protective coating 120 may be positioned over or in direct contact with at least a portion of the top layer 110 (not shown). As shown in FIG. 2A, the first primer film of the first primer layer 42 may comprise the patterned feature. As shown in FIG. 2B, the second primer film of the first primer layer 42 may comprise the patterned feature.

Exemplary functional coatings 20 including two metallic layers (i.e., a double metal coating 22) are shown in FIGS. 3A-3D. The double metal functional coating 22 includes a base layer 30 positioned over and in direct contact with the second surface 16 of the substrate 12. The base layer 30 may be positioned over and in direct contact with a portion of or the entire second surface 16 of the substrate 12. A metallic layer 40 is positioned over or in direct contact with at least a portion of the base layer 30. A first primer layer 42 is positioned over or in direct contact with at least a portion of the metallic layer 40. A second layer 50 is positioned over at least a portion of the optional first primer layer 42. A second metallic layer 60 is positioned over or in direct contact with at least a portion of the second layer 50. A second primer layer 62 is positioned over or in direct contact with at least a portion of the second metallic layer 60. A top layer 110 is positioned over or in direct contact with at least a portion of the optional second primer layer 62. An optional outermost protective coating 120 may be positioned over or in direct contact with at least a portion of the top layer 110 (not shown). One of the first primer layer 42 (FIGS. 3A and 3B) or the second primer layer 60 (FIGS. 3C and 3D) comprises the patterned feature, the first primer film, and the second primer film. As shown in FIG. 3A, the first primer film 44 of the first primer layer 42 may comprise the patterned feature. As shown in FIG. 2B, the second primer film 46 of the first primer layer 42 may comprise the patterned feature. As shown in FIG. 3C, the first primer film 64 of the second primer layer 62 may comprise the patterned feature. As shown in FIG. 3D, the second primer film 66 of the second primer layer 62 may comprise the patterned feature.

Exemplary functional coating 20 including three metallic layers (i.e., a triple metal functional coating 23) are shown in FIGS. 4A-4F. The triple metal functional coating 23 includes a base layer 30 positioned over and in direct contact with the second surface 16 of the substrate 12. The base layer 30 may be positioned over and in direct contact with a portion of or the entire second surface 16 of the substrate 12. A metallic layer 40 is positioned over or in direct contact with at least a portion of the base layer 30. A first primer layer 42 is positioned over or in direct contact with at least a portion of the metallic layer 40. A second layer 50 is positioned over at least a portion of the first primer layer 42. A second metallic layer 60 is positioned over or in direct contact with at least a portion of the second layer 50. A second primer layer 62 is positioned over or in direct contact with at least a portion of the second metallic layer 60. A third layer 70 is positioned over or in direct contact with at least a portion of the second primer layer 62. A third metallic layer 80 is positioned over or in direct contact with at least a portion of the third layer 70. A third primer layer 82 is positioned over or in direct contact with at least a portion of the third metallic layer 80. A top layer 110 is positioned over or in direct contact with at least a portion of the third primer layer 82. An optional outermost protective coating 120 may be positioned over or in direct contact with at least a portion of the top layer 110 (not shown). One of the first primer layer 42 (FIGS. 4A and 4B), the second primer layer 62 (FIGS. 4C and 4D), or the third primer layer 82 (FIGS. 4E and 4F) comprises the patterned feature, the first primer film, and the second primer film. As shown in FIG. 4A, the first primer film 44 of the first primer layer 42 may comprise the patterned feature. As shown in FIG. 4B, the second primer film 46 of the first primer layer 42 may comprise the patterned feature. As shown in FIG. 4C, the first primer film 64 of the second primer layer 62 may comprise the patterned feature. As shown in FIG. 4D, the second primer film 66 of the second primer layer 62 may comprise the patterned feature. As shown in FIG. 4E, the first primer film 64 of the third primer layer 82 may comprise the patterned feature. As shown in FIG. 4F, the second primer film 86 of the third primer layer 82 may comprise the patterned feature.

Exemplary functional coatings 20 including four metallic layers (i.e., a quadruple metal functional coating 24) are shown in FIGS. 5A-5H. The quadruple metal functional coating 24 includes a base layer 30 positioned over and in direct contact with the second surface 16 of the substrate 12. The base layer 30 may be positioned over and in direct contact with a portion of or the entire second surface 16 of the substrate 12. A metallic layer 40 is positioned over or in direct contact with at least a portion of the base layer 30. A first primer layer 42 is positioned over or in direct contact with at least a portion of the metallic layer 40. A second layer 50 is positioned over at least a portion of the first primer layer 42. A second metallic layer 60 is positioned over or in direct contact with at least a portion of the second layer 50. A second primer layer 62 is positioned over or in direct contact with at least a portion of the second metallic layer 60. A third layer 70 is positioned over or in direct contact with at least a portion of the second primer layer 62. A third metallic layer 80 is positioned over or in direct contact with at least a portion of the third layer 70. A third primer layer 82 is positioned over or in direct contact with at least a portion of the third metallic layer 80. A fourth layer 90 is positioned over or in direct contact with at least a portion of the optional third primer layer 82 or third metallic layer 80. A fourth metallic layer 100 is positioned over or in direct contact with at least a portion of the fourth layer 90. A fourth primer layer 102 is positioned over or in direct contact with at least a portion of the fourth metallic layer 100. A top layer 110 is positioned over or in direct contact with at least a portion of the fourth primer layer 102. An optional outermost protective coating 120 may be positioned over or in direct contact with at least a portion of the top layer 110 (not shown). One of the first primer layer 42 (FIGS. 5A and 5B), the second primer layer 62 (FIGS. 5C and 5D), the third primer layer 82 (FIGS. 5E and 5F), or the fourth primer layer 102 (FIGS. 5G and 5H) comprises the patterned feature, the first primer film, and the second primer film. As shown in FIG. 5A, the first primer film 44 of the first primer layer 42 may comprise the patterned feature. As shown in FIG. 5B, the second primer film 46 of the first primer layer 42 may comprise the patterned feature. As shown in FIG. 5C, the first primer film 64 of the second primer layer 62 may comprise the patterned feature. As shown in FIG. 5D, the second primer film 66 of the second primer layer 62 may comprise the patterned feature. As shown in FIG. 5E, the first primer film 64 of the third primer layer 82 may comprise the patterned feature. As shown in FIG. 5F, the second primer film 86 of the third primer layer 82 may comprise the patterned feature. As shown in FIG. 5G, the first primer film 104 of the fourth primer layer 102 may comprise the patterned feature. As shown in FIG. 5H, the second primer film 106 of the fourth primer layer 102 may comprise the patterned feature.

Any of the metallic layers 40, 60, 80, 100 described herein can be continuous or discontinuous.

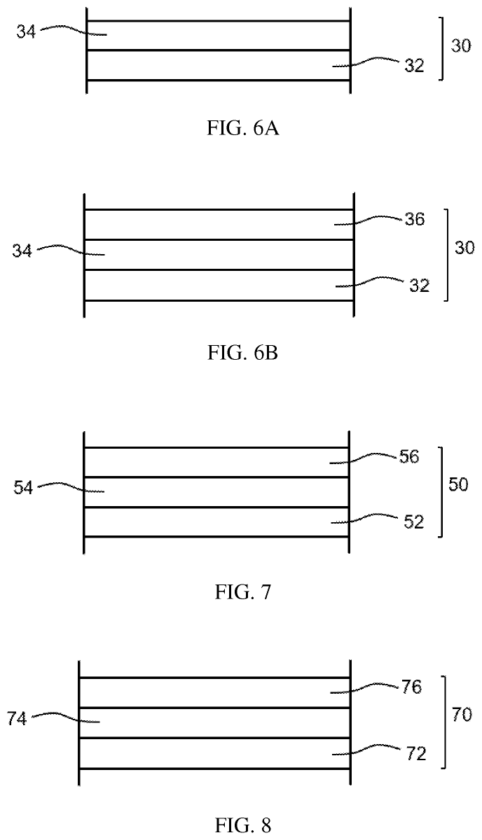

Exemplary non-limiting functional coatings 20 of the invention are shown in FIGS. 2A-2B, 3A-3D, 4A-4F, and 5A-5H. The functional coating 20 is positioned over the second side of the substrate 12 and includes a base layer 30 positioned over and in direct contact with the second surface 16 of the substrate 12. The base layer 30 may include a first film 32 positioned over and in direct contact with the second surface 16 of the substrate 12 and a second film 34 positioned over or in direct contact with the first film 32 (see FIG. 6A). The first film 32 may be positioned over and in direct contact with a portion of the second surface 16 of the substrate 12 or the entire second surface 16 of the substrate 12. The base layer 30 can be transparent to visible light.

The first film 32 of the base layer 30 can comprise metal or metal alloy oxides, nitrides, oxynitrides, or mixtures thereof. Examples of suitable metal oxides, metal nitrides, and/or metal oxynitrides include oxides, nitrides, and/or oxynitrides of titanium, hafnium, zirconium, niobium, zinc, bismuth, lead, indium, tin, aluminum, silicon and mixtures thereof. The metal oxides can have small amounts of other materials, such as manganese in bismuth oxide, tin in indium oxide, etc. Additionally, oxides or nitrides of metal alloys or metal mixtures can be used, such as oxides containing zinc and tin (e.g., zinc stannate, defined below), oxides of indium-tin alloys, silicon nitrides, silicon aluminum nitrides, or aluminum nitrides. Further, doped metal oxides, such as antimony or indium tin oxides or nickel or boron doped silicon oxides, can be used. Alternatively, the first film 32 of the base layer 30 can comprise a transparent conductive oxide. The transparent conductive oxide can be a doped metal oxide such as gallium-doped zinc oxide (GZO), aluminum-doped zinc oxide (AZO), indium-doped zinc oxide (IZO) magnesium-doped zinc oxide (MZO), or tin-doped indium oxide (ITO). The first film 32 of the base layer 30 may comprise silicon nitride, silicon oxide, silicon aluminum nitride, silicon aluminum oxide, silicon oxynitride, silicon aluminum oxynitride, zinc stannate, or tin oxide.

The first film 32 of the base layer 30 may comprise silicon nitride or silicon oxide and be sputtered from a single cathode containing silicon. The first film 32 of the base layer 30 may comprise silicon aluminum nitride or silicon aluminum oxide and be sputtered from two cathodes (e.g., one silicon and one aluminum) or from a single cathode containing both silicon and aluminum. The first film 32 of the base layer 30 may be silicon aluminum nitride or silicon aluminum oxide comprising from 5 wt. % to 20 wt. % aluminum and 95 wt. % to 80 wt. % silicon, such as 10 wt. % to 20 wt. % aluminum and 90 wt. % to 80 wt. % silicon, such as 20 wt. % to 25 wt. % aluminum and 80 wt. % to 75 wt. % silicon. The first film 32 of the base layer 30 may be silicon aluminum nitride or silicon aluminum oxide comprising silicon and aluminum in amount of at least 95 wt. % silicon and at least 5 wt. % aluminum. The first film 32 of the base layer 30 may be silicon aluminum nitride or silicon aluminum oxide comprising silicon and aluminum in an amount of at least 90 wt. % silicon and at least 10 wt. % aluminum. The first film 32 of the base layer 30 may be silicon aluminum nitride or silicon aluminum oxide comprising silicon and aluminum in an amount of at least 85 wt. % silicon and at least 15 wt. % aluminum. The first film 32 of the base layer 30 may be silicon aluminum nitride or silicon aluminum oxide comprising silicon and aluminum in an amount of at least 80 wt. % silicon and at least 20 wt. % aluminum. The first film 32 of the base layer 30 may be silicon aluminum nitride or silicon aluminum oxide comprising silicon and aluminum in an amount of at least 75 wt. % silicon and at least 25 wt. % aluminum.

The tin oxide can be deposited in an oxygen (O₂) environment from a tin target or from a tin target that includes other materials to improve the sputtering characteristics of the target. The tin oxide can be obtained from magnetron sputtering vacuum deposition from a target of tin or a target of tin and zinc. For example, the tin target can include a small amount (e.g., up to 20 wt. %, up to 15 wt. %, up to 10 wt. %, or up to 5 wt. %) of zinc. In which case, the resultant tin oxide film would include a small percentage of zinc oxide, e.g., up to 20 wt. % zinc oxide, e.g., up to 10 wt. % zinc oxide, e.g., up to 5 wt. % zinc oxide. A coating layer deposited from a tin target having up to from 0 wt. % to 20 wt. % zinc is referred to herein as “a tin oxide film”. The first film 32 of the base layer 30 may be a tin oxide film where tin is substantially the only metal in the first film 32. As used herein, “substantially free” means that the tin oxide film contains less than 0.5 wt. % of additional metals other than tin. The tin oxide film 32 may include 80 wt. % tin oxide and 20 wt. % zinc oxide. The tin oxide film 32 may include 90% tin oxide and 10 wt. % zinc oxide.

By “zinc stannate” is meant a composition of Zn_{X}Sn_{1-X}O_{2-X} (Formula 1) where “x” varies in the range of greater than 0 to less than 1. For instance, “x” can be greater than 0 and can be any fraction or decimal between greater than 0 to less than 1. For example, where x=2/3, Formula 1 is Zn_{2/3}Sn_{1/3}O_{4/3}, which is more commonly described as “Zn₂SnO₄”. A zinc stannate-containing film has one or more of the forms of Formula 1 in a predominant amount in the layer.

The first film 32 of the base layer 30 can comprise a total thickness of from 10 nm to 45 nm, such as, from 15 nm to 40 nm, such as, from 20 nm to 35 nm, such as, from 22 to 30 nm.

The second film 34 of the base layer 30 can comprise antireflective materials and/or dielectric materials, such as, but not limited to, metal or metal alloy oxides, nitrides, oxynitrides, or mixtures thereof. Examples of suitable metal oxides for the second film 34 of the base layer 30 include oxides of titanium, hafnium, zirconium, niobium, zinc, bismuth, lead, indium, tin, aluminum, silicon and mixtures thereof. These metal oxides can have small amounts of other materials, such as, manganese in bismuth oxide, tin in indium oxide, etc. Additionally, oxides of metal alloys or metal mixtures can be used, such as, oxides containing zinc and tin, oxides of indium-tin alloys, oxides containing zinc and aluminum, silicon nitrides, silicon aluminum nitrides, or aluminum nitrides. Further, doped metal oxides, such as, antimony or indium doped tin oxides or nickel or boron doped silicon oxides, can be used. The second film 34 of the base layer 30 can comprise a transparent conductive oxide. The transparent conductive oxide of the second film 34 of the base layer can be a doped metal oxide such as gallium-doped zinc oxide (GZO), aluminum-doped zinc oxide (AZO), indium-doped zinc oxide (IZO), magnesium-doped zinc oxide (MZO), or tin-doped indium oxide (ITO).

The second film 34 of the base layer 30 can be a zinc/tin alloy oxide. By “zinc/tin alloy oxide” is meant both true alloys, and mixtures of the oxides. Zinc oxide can be deposited from a zinc target that includes other materials to improve the sputtering characteristics of the target. As such, the zinc/tin alloy oxide can be obtained from magnetron sputtering vacuum deposition from a target of zinc and tin. For example, the zinc target can include a small amount (e.g., up to 20 wt. %, up to 15 wt. %, up to 10 wt. %, or up to 5 wt. %) of tin to improve sputtering. In which case, the resultant zinc oxide film would include a small percentage of tin oxide, e.g., up to 10 wt. % tin oxide, e.g., up to 5 wt. % tin oxide. A coating layer deposited from a zinc target having up to 10 wt. % tin (added to enhance the conductivity of the target) is referred to herein as “a zinc oxide film” even though a small amount of tin may be present. One non-limiting target can comprise zinc and tin in proportions of from 5 wt. % to 95 wt. % zinc and from 95 wt. % to 5 wt. % tin, such as, from 10 wt. % to 90 wt. % zinc and from 90 wt. % to 10 wt. % tin. However, other ratios of zinc to tin could also be used.

The second film 34 of the base layer 30 can comprise a film of zinc oxide or aluminum zinc oxide film (AlₓZn₁₋ₓ oxide). By “aluminum/zinc alloy oxide” is meant both true alloys, and mixtures of the oxides. As such, the aluminum/zinc alloy oxide can be obtained from magnetron sputtering vacuum deposition from a target of zinc and aluminum and can include a small of amount (e.g. less than 10 wt. %, such as, greater than 0 to 5 wt. %) of tin to improve sputtering. In which case, the resultant aluminum zinc oxide film would include a small percentage of tin oxide, e.g. 0 wt. % to less than 10 wt. %, e.g., 0 wt. % to 5 wt. % tin oxide. The second film 34 of the base layer 30 can comprise AlₓZn₁₋ₓ oxide, where x is within the range of 1 wt. % to 25 wt. %, such as, 1 wt. % to 15 wt. %, such as, 1 wt. % to 10 wt. %, such as, 2 wt. % to 5 wt. %. In one non-limiting embodiment, x is 3 wt. %.

The second film 34 of the base layer 30 can comprise a film of titanium oxide, which is defined as a compound comprising both titanium and oxygen. The titanium oxide may comprise, for example, titanium oxide, titanium aluminum oxide, titanium oxynitride, titanium aluminum oxynitride, or any mixtures thereof.

The second film 34 of the base layer 30 can comprise a total thickness of from 5 nm to 20 nm, such as, from 8 nm to 20 nm, such as, from 10 nm to 15 nm.

The first film 32 of the base layer 30 may comprise tin oxide positioned over and in direct contact with the second surface 16 of the substrate 12 and the second film 34 of the base layer 30 may comprise zinc oxide positioned over and in direct contact with the first film 32. Alternatively, the first film 32 of the base layer 30 may comprise zinc stannate positioned over and in direct contact with the second surface 16 of the substrate 12 and the second film 34 of the base layer 30 may comprise zinc oxide positioned over and in direct contact with the first film 32.

The first film 32 and the second film 34 of the base layer 30 may comprise the same material. For example, the first film 32 and the second film 34 of the base layer 30 may both comprise the same transparent conductive oxide, such as gallium-doped zinc oxide (GZO), aluminum-doped zinc oxide (AZO), indium-doped zinc oxide (IZO), magnesium-doped zinc oxide (MZO), or tin-doped indium oxide (ITO).

Alternatively, the base layer 30 may include a first film 32 positioned over and in direct contact with the second surface 16 of the substrate 12, a second film 34 positioned over or in direct contact with at least a portion of the first film 32, and a third film 36 positioned over or in direct contact with at least a portion of the second film 34 (see FIG. 6B). The first film 32 of the base layer 30 may comprise tin oxide positioned over and in direct contact with the second surface 16 of the substrate 12, the second film 34 may comprise zinc stannate positioned over or in direct contact with the first film 32, and the third film 36 may comprise zinc oxide positioned over and in direct contact with the second film 34.

When the base layer 30 comprises a first film 32, a second film 34, and third film 36, the total combined thickness of the first film 32 and second film 34 may be from 10 nm to 45 nm, such as from 15 nm to 40 nm, such as from 20 nm to 35 nm, or such as from 22 to 30 nm and the second film 34 may comprise a total thickness of from 5 nm to 20 nm, such as, from 8 nm to 20 nm, such as, from 10 nm to 15 nm.

Alternatively, the base layer 30 may comprise a single film. For example, the base layer 30 may comprise a single film of a transparent conductive oxide, such as gallium-doped zinc oxide (GZO), aluminum-doped zinc oxide (AZO), indium-doped zinc oxide (IZO), magnesium-doped zinc oxide (MZO), or tin-doped indium oxide (ITO).

The base layer 30 can comprise a total thickness (e.g., combined thickness of the first film 32, the second film 34, and the third film 36 (when present)) of from 20 nm to 50 nm, such as, from 25 nm to 45 nm, such as, from 30 nm to 45 nm.

A metallic layer 40 is deposited over at least a portion of the base layer 30, such as over at least a portion of the second film 34 or the optional third film of the base layer 30. The metallic layer 40 can include a reflective metal, such as, but not limited to, metallic gold, copper, palladium, aluminum, silver, or mixtures, alloys, or combinations thereof. In one embodiment, the metallic layer 40 comprises a metallic silver layer. The metallic layer 40 is a continuous layer. By “continuous layer” is meant that the coating forms a continuous film of the material and not isolated coating regions.

The metallic layer 40 can have a thickness in the range of from 5 nm to 25 nm, such as, from 8 nm to 23 nm, such as, from 8 nm to 20 nm, such as, from 8 nm to 17 nm.

As shown in FIGS. 2A-2B, 3A-3D, 4A-4F, and 5A-5H, the functional coatings 20 (i.e., the single metal functional coating 21, the double metal functional coating 22, the triple metal functional coating 23, and the quadruple metal functional coating 24) comprise a first primer layer 42 positioned over or in direct contact with the metallic layer 40. The first primer layer 42 can be a single film or a multiple film layer. The first primer layer 42 can include an oxygen-capturing material that can be sacrificial during the deposition process to prevent degradation or oxidation of the metallic layer 40 during the sputtering process or subsequent heating processes. The first primer layer 42 can also absorb at least a portion of electromagnetic radiation, such as, visible light, passing through the functional coating 20.

Referring to FIGS. 2A-2B, 3A-3B, 4A-4B, and 5A-5B, the first primer layer 42 comprises the patterned feature. The patterned feature of FIGS. 2A-2B, 3A-3B, 4A-4B, and 5A-5B is shown as stripes 25 but can be any symmetric or asymmetric patterned feature. When the first primer layer 42 comprises the patterned feature, none of the other layers of the functional coating 20 comprise a patterned feature.

Referring to FIGS. 2A, 3A, 4A, and 5A, the first primer layer 42 comprises a first primer film 44 that comprises the patterned feature. The first primer film 44 is positioned over or in direct contact with at least a portion of the metallic layer 40. The first primer layer 42 comprises a second primer film 46 that is a non-patterned film. The second primer film 46 is over or in direct contact with at least a portion of the first primer film 44 and the metallic layer 40. As shown in FIG. 2A, when the functional coating 20 is a single metal functional coating 21, the top layer 110 is positioned over or in direct contact with at least a portion of the second primer film 46. As shown in FIGS. 3A, 4A, and 5A, when the functional coating 20 includes two or more metallic layers (i.e., the functional coating is a double metal functional coating 22, a triple metal functional coating 23, or quadruple metal functional coating 24), a second layer 50 is positioned over or in direct contact with at least a portion of the second primer film 46.

Referring to FIGS. 2B, 3B, 4B, and 5B, the first primer layer 42 comprises a first primer film 44 that is a non-patterned film. The first primer film 44 is positioned over or in direct contact with at least a portion of the metallic layer 40. The first primer layer 42 comprises a second primer film 46 over or in direct contact with at least a portion of the first primer film 44 and the second primer film 46 comprises the patterned feature. As shown in FIG. 2B, when the functional coating 20 is a single metal functional coating 21, the top layer 110 is positioned over or in direct contact with at least a portion of the first primer film 44 and the second primer film 46. As shown in FIGS. 3B, 4B, and 5B, when the functional coating 20 includes two or more metallic layers (i.e., the functional coating is a double metal functional coating 22, a triple metal functional coating 23, or quadruple metal functional coating 24), a second layer 50 is positioned over or in direct contact with at least a portion of the first primer film 44 and the second primer film 46 comprising the patterned feature.

The first primer film 44 and the second primer film 46 may each independently be selected from the group consisting of titanium, silicon, tin, silicon dioxide, silicon nitride, silicon oxynitride, nickel, zirconium, aluminum, cobalt, chromium, titanium, aluminum, an alloy thereof, or a mixture thereof. In one non-limiting embodiment, the first primer film 44 comprises titanium and the second primer film 46 comprises aluminum zinc. As used herein “aluminum zinc” is AlₓZn₁₋ₓ, wherein x is within a range of greater than 0 wt. % and up to 30 wt. %, such as from greater than 0 wt. % and up to 20 wt. %, such as from greater than 0 wt. % and up to 15 wt. %, or such as from 1 wt. % to 12 wt. %. In another non-limiting embodiment, the first primer film 44 comprises titanium and the second primer film 46 comprises tin. In another non-limiting embodiment, the first primer film 44 comprises titanium and the second primer film 46 comprises nickel chromium.

When the first primer film 44 comprises the patterned feature, the patterned feature of the first primer film 44 may comprise a thickness in a range of from 0.5 nm to 20 nm, such as from 1 nm to 15 nm, such as from 1 nm to 10 nm, or such as from 1 nm to 8 nm. This thickness of the first primer film 44 is the thickness of the patterned feature.

When the first primer film 44 of the first primer layer 42 is a non-patterned film, the first primer film 44 of the first primer layer 42 may comprise a thickness in a range of from 0.5 nm to 10 nm such as from 0.5 nm to 8 nm, or such as from 1 nm to 6 nm.

When the second primer film 46 of the first primer layer 42 comprises the patterned feature, the patterned feature of the second primer film 46 may comprise a thickness in a range of from 0.5 nm to 20 nm, such as from 1 nm to 15 nm, such as from 1 nm to 10 nm, or such as from 1 nm to 8 nm. This thickness of the second primer film 46 is the thickness of the patterned feature.

When the second primer film 46 of the first primer layer 42 is a non-patterned film, the second primer film 46 of the first primer layer 42 may comprise a thickness in a range of from 0.5 nm to 10 nm such as from 0.5 nm to 8 nm, or such as from 1 nm to 6 nm.

When the first primer layer 42 does not comprise the patterned feature, as shown in FIGS. 3C-3D, 4C-4F, and 5C-5H, and is a single film, the first primer layer 42 may comprise a thickness in a range of from 0.5 nm to 5 nm such as from 1 nm to 4 nm, or such as from 1 nm to 2.5 nm and may comprise a material selected from a group consisting of titanium, silicon, tin, silicon dioxide, silicon nitride, silicon oxynitride, nickel, zirconium, zinc, aluminum, cobalt, chromium, aluminum, alloys thereof, or mixtures thereof.

In embodiments where there are two or more metallic layers (i.e., a double metal functional coating 22, triple metal functional coating 23, or quadruple metal functional coating 24), a second layer 50 is located over at least a portion of first primer layer 42. The second layer 50 can comprise one or more metal oxide, metal alloy oxide, metal nitride, metal alloy nitride, metal oxynitride, or metal alloy oxynitride-containing films, such as, those described above with respect to the first film 32 and second film 34 of the base layer 30. For example, as shown in FIG. 7A, the second layer 50 can include a first film 52 comprising a metal oxide, e.g., a zinc oxide film or aluminum zinc oxide film, deposited over at least a portion of the first primer layer 42, a second film 54 comprising a metal alloy oxide, e.g., a zinc stannate film, over at least a portion of the first film 52, and a third film 56 comprising a metal oxide, e.g., a zinc oxide film or aluminum zinc oxide film, over at least a portion of the second film 54.

When the functional coating 20 comprises two or more metallic layers (i.e., is a double metal functional coating 22, a triple metal functional coating 23, or a quadruple metal functional coating 24) and the first primer film 44 of the first primer layer 42 comprises the patterned feature, as shown in FIGS. 3A, 4A, and 5A, the first film 52 of the second layer 50 is positioned over or in direct contact with at least a portion of the second primer film 46.

When the functional coating 20 comprises two or more metallic layers (i.e., is a double metal functional coating 22, a triple metal functional coating 23, or a quadruple metal functional coating 24) and the second primer film 46 of the first primer layer 42 comprises the patterned feature, as shown in FIGS. 3B, 4B, and 5B, the first film 52 of the second layer 50 is positioned over or in direct contact with at least a portion of the first primer film 44 and the second primer film 46 comprising the patterned feature.

When the second layer 50 comprises a first film 52, a second film 54, and third film 56, both of the first and third films 54, 56 may each independently have a thicknesses in the range of from 1 nm to 20 nm, such as, from 5 nm to 20 nm, such as, from 6 nm to 15 nm, such as, from 8 nm to 10 nm and the second film 54 can have a thickness in the range of from 5 nm to 80 nm, such as 5 nm to 70 nm, such as from 10 nm to 70 nm, such as from 20 nm to 70 nm, such as from 30 to 70 nm, or such as from 50 nm to 70 nm.

As shown in FIGS. 3A-3D, 4A-4F, and 5A-5H, the functional coatings 20 (i.e., the double metal functional coating 22, the triple metal functional coating 23, and the quadruple metal functional coating 24) comprise a second metallic layer 60 positioned over or in direct contact with a least a portion of the second layer 50, such as over at least a portion of the third film 56 of the second layer 50.

The second metallic layer 60 can include a reflective metal, such as, but not limited to, metallic gold, copper, palladium, aluminum, silver, or mixtures, alloys, or combinations thereof. In one embodiment, the second metallic layer 60 comprises a metallic silver layer.

In one embodiment, the second metallic layer 60 is a continuous layer formed over at least a portion of the second layer 50. The second metallic layer 60 is a continuous layer having a total thickness of from 5 nm to 30 nm, such as, from 10 nm to 20 nm, such as, from 10 nm to 15 nm, or such as, from 10 nm to 12 nm.

In another embodiment, the second metallic layer 60 is a discontinuous layer, having a subcritical thickness, formed over at least a portion of the second layer 50. The metallic material, such as, but not limited to, metallic gold, copper, palladium, aluminum, silver, or mixtures, alloys, or combinations thereof, is applied at a subcritical thickness such that isolated regions or islands of the material are formed, rather than a continuous layer of the material. For silver, it has been determined that the critical thickness is less than 5 nm, such as, less than 4 nm, such as, less than 3 nm, such as, less than 2.5 nm. For silver, the transition between a continuous layer and a subcritical layer occurs in the range of 2.5 nm to 5 nm. For copper, it has been determined that the effective thickness is at most 9 nm; e.g., 5 nm; 4 nm; e.g., 3.6 nm, e.g., 2.6 nm; e.g., 2 nm; e.g., 1.7 nm; and at least 0.1 nm; e.g., 0.2 nm; e.g. 0.3 nm; e.g. 0.4 nm; e.g. 0.5 nm; e.g. 0.6 nm; e.g. 0.7 nm. It is estimated that copper, gold, and palladium would exhibit similar subcritical behavior in this range. In one non-limiting embodiment, the second metallic layer 60 comprises islanded silver with the islands having an effective thickness of at most 7 nm, e.g. at most 4 nm, e.g., at most 3.5 nm, e.g., at most 3 nm, e.g., at most 2.5 nm, e.g., at most 2 nm; e.g., at most 1.7 nm; and at least 0.1 nm; e.g., at least 0.2 nm; e.g., at least 0.4 nm; e.g., at least 0.5 nm; e.g. at least 0.7 nm; e.g., at least 1 nm. In another embodiment, the second metallic layer 60 comprises copper with the islands having an effective thickness is at most 9 nm; e.g., 5 nm; 4 nm; e.g., 3.6 nm, e.g., 2.6 nm; e.g., 2 nm; e.g., 1.7 nm; and at least 0.1 nm; e.g., 0.2 nm; e.g. 0.3 nm; e.g. 0.4 nm; e.g. 0.5 nm; e.g. 0.6 nm; e.g. 0.7 nm; and, optionally, silver with islands having an effective thickness of at most 7 nm, e.g. at most 4 nm, e.g., at most 3.5 nm, e.g., at most 3 nm, e.g., at most 2.5 nm, e.g., at most 2 nm; e.g., at most 1.7 nm; and at least 0.1 nm; e.g., at least 0.2 nm; e.g., at least 0.4 nm; e.g., at least 0.5 nm; e.g. at least 0.7 nm; e.g., at least 1 nm. The second metallic layer 60 absorbs electromagnetic radiation according to the Plasmon Resonance Theory. This absorption depends at least partly on the boundary conditions at the interface of the metallic islands. The second metallic layer 60 is not an infrared reflecting layer, like the metallic layer 40. It is estimated that for silver and copper, the metallic islands or balls of silver metal and copper metal deposited below the subcritical thickness can have a height of about 2 nm to 7 nm, such as, 5 nm to 7 nm. It is estimated that if the subcritical metal layer could be spread out uniformly, it would have a thickness of about 1.1 nm. It is estimated that optically, the discontinuous metal layer behaves as an effective layer thickness of 2.6 nm. Depositing the discontinuous metallic layer over zinc stannate rather than zinc oxide or aluminum zinc oxide appears to increase the visible light absorbance of the coating, e.g., of the discontinuous metallic layer.

As shown in FIGS. 3A-3D, 4A-4F, and 5A-5H, the functional coatings 20 (i.e., the double metal functional coating 22, the triple metal functional coating 23, and the quadruple metal functional coating 24) comprise a second primer layer 62 positioned over or in direct contact with the second metallic layer 60. The second primer layer 62 can be a single film or a multiple film layer. The second primer layer 62 can include an oxygen-capturing material that can be sacrificial during the deposition process to prevent degradation or oxidation of the second metallic layer 60 during the sputtering process or subsequent heating processes. The second primer layer 62 can also absorb at least a portion of electromagnetic radiation, such as, visible light, passing through the functional coating 20.

Referring to FIGS. 3C-3D, 4C-4D, and 5C-5D, the second primer layer 62 comprises the patterned feature. The patterned feature of FIGS. 3C-3D, 4C-4D, and 5C-5D is shown as stripes 25 but can be any symmetric or asymmetric patterned feature. When the second primer layer 62 comprises the patterned feature, none of the other layers of the functional coating 20 comprise a patterned feature.

Referring to FIGS. 3C, 4C, and 5C, the second primer layer 62 comprises a first primer film 64 that comprises the patterned feature. The first primer film 64 is positioned over or in direct contact with at least a portion of the second metallic layer 60. The second primer layer 62 comprises a second primer film 66 that is a non-patterned film. The second primer film 66 is over or in direct contact with at least a portion of the first primer film 64 and the second metallic layer 60. As shown in FIG. 3C, when the functional coating 20 is a double metal functional coating 22, the top layer 110 is positioned over or in direct contact with at least a portion of the second primer film 64. As shown in FIGS. 4C and 5D, when the functional coating 20 includes three or more metallic layers (i.e., the functional coating is a triple metal functional coating 23 or quadruple metal functional coating 24), a third layer 70 is positioned over or in direct contact with at least a portion of the second primer film 66.

Referring to FIGS. 3D, 4D, and 5D, second primer layer 62 comprises a first primer film 64 that is a non-patterned film. The first primer film 64 is positioned over or in direct contact with at least a portion of the second metallic layer 60. The first primer layer 62 comprises a second primer film 46 over or in direct contact with at least a portion of the first primer film 44 and the second primer film 66 comprises the patterned feature. As shown in FIG. 3D, when the functional coating 20 is a double metal functional coating 22, the top layer 110 is positioned over or in direct contact with at least a portion of the first primer film 64 and the second primer film 66. As shown in FIGS. 4D and 5D, when the functional coating 20 includes three or more metallic layers (i.e., the functional coating is a triple metal functional coating 23 or quadruple metal functional coating 24), a third layer 70 is positioned over or in direct contact with at least a portion of the first primer film 64 and the second primer film 66 comprising the patterned feature.

The first primer film 64 and the second primer film 66 may each independently be selected from the group consisting of titanium, silicon, tin, silicon dioxide, silicon nitride, silicon oxynitride, nickel, zirconium, aluminum, cobalt, chromium, titanium, aluminum, an alloy thereof, or a mixture thereof. In one non-limiting embodiment, the first primer film 64 comprises titanium and the second primer film 66 comprises aluminum zinc. In another non-limiting embodiment, the first primer film 64 comprises titanium and the second primer film 66 comprises tin. In another non-limiting embodiment, the first primer film 64 comprises titanium and the second primer film 66 comprises nickel chromium.

When the first primer film 64 comprises the patterned feature, the patterned feature of the first primer film 64 may comprise a thickness in a range of from 0.5 nm to 20 nm, such as from 1 nm to 15 nm, such as from 1 nm to 10 nm, or such as from 1 nm to 8 nm. This thickness of the first primer film 64 is the thickness of the patterned feature.

When the first primer film 64 of the second primer layer 62 is a non-patterned film, the first primer film 64 of the second primer layer 62 may comprise a thickness in a range of from 0.5 nm to 10 nm such as from 0.5 nm to 8 nm, or such as from 1 nm to 6 nm.

When the second primer film 66 of the second primer layer 62 comprises the patterned feature, the patterned feature of the second primer film 66 may comprise a thickness in a range of from 0.5 nm to 20 nm, such as from 1 nm to 15 nm, such as from 1 nm to 10 nm, or such as from 1 nm to 8 nm. This thickness of the second primer film 66 is the thickness of the patterned feature.

When the second primer film 66 of the second primer layer 62 is a non-patterned film, the second primer film 66 of the second primer layer 62 may comprise a thickness in a range of from 0.5 nm to 10 nm such as from 0.5 nm to 8 nm, or such as from 1 nm to 6 nm.

When the second primer layer 62 does not comprise the patterned feature, as shown in FIGS. 3A-3B, 4A-4B, 4E-4F, 5A-5B, and 5E-5H, and is a single film, the second primer layer 62 may comprise a thickness in the range of from 0.5 nm to 5 nm, such as, from 1 nm to 4 nm, or such as, from 1 nm to 2.5 nm and may comprise a material selected from a group consisting of titanium, silicon, tin, silicon dioxide, silicon nitride, silicon oxynitride, nickel, zirconium, zinc, aluminum, cobalt, chromium, aluminum, alloys thereof, or mixtures thereof.

In embodiments where there are three or more metallic layers (i.e., a triple metal functional coating 23 or quadruple metal functional coating 24), a third layer 70 is positioned over or in direct contact with at least a portion of the second primer layer 62. The third layer 70 can comprise one or more metal oxide, metal alloy oxide, metal nitride, metal alloy nitride, metal oxynitride, or metal alloy oxynitride-containing films, such as, those described above with respect to the first film 32 and second film 34 of the base layer 30. For example, as shown in FIG. 8A, the third layer 70 can include a first film 72 comprising a metal oxide, e.g., a zinc oxide film or an aluminum zinc oxide film, deposited over at least a portion of the second primer layer 62, a second film 74 comprising a metal alloy oxide, e.g., a zinc stannate film, over at least a portion of the first film 72, and a third film 76 comprising a metal oxide, e.g., a zinc oxide film or an aluminum zinc oxide film, over at least a portion of the second film 74.

When the functional coating 20 comprises three or more metallic layers (i.e., a triple metal functional coating 23 or a quadruple metal functional coating 24) and the first primer film 64 of the second primer layer 62 comprises the patterned feature, as shown in FIGS. 4C and 5C, the first film 72 of the third layer 70 is positioned over or in direct contact with at least a portion of the second primer film 64 of the second primer layer 62.

When the functional coating 20 comprises three or more metallic layers (i.e., is a triple metal functional coating 23 or a quadruple metal functional coating 24) and the second primer layer 62 comprises the patterned feature 18, as shown in FIGS. 4D and 5D, the first film 72 of the third layer 70 is positioned over or in direct contact with at least a portion of the first primer film 64 and the second primer film 66 comprising the patterned feature.

The third layer 70 comprises a total thickness (e.g., the combined thicknesses of the first film 72, the second film 74, and the third film 76) in the range of from 20 nm to 100 nm, such as, from 20 nm to 80 nm, such as, from 20 nm to 50 nm, or such as, from 25 nm to 40 nm.

When the third layer 70 comprises a first film 72, a second film 74, and a third film 76, both of the first and third films 72, 76 may each independently have a thicknesses in the range of from 5 nm to 20 nm, such as from 5 nm to 20 nm, such as from 7 nm to 15 nm, such as from 8 to 15 nm, or such as from 9.5 nm to 10 nm and the second film 74 can have a thickness in the range of from 10 nm to 80 nm, such as from 20 nm to 70 nm, such as from 30 nm to 60 nm, such as from 38 nm to 50 nm, or such as from 38 nm to 45 nm.

As shown in FIGS. 4A-4F and 5A-5H, the functional coatings 20 (i.e., the triple metal functional coating 23 and the quadruple metal functional coating 24) comprise a third metallic layer 80 positioned over or in direct contact with a least a portion of the third layer 70, such over the third film 76 of the third layer 70. The third metallic layer 80 can include a reflective metal, such as, but not limited to, metallic gold, copper, palladium, aluminum, silver, or mixtures, alloys, or combinations thereof. In one embodiment, the third metallic layer 80 comprises a metallic silver layer.

In one embodiment, the third metallic layer 80 is a continuous layer formed over at least a portion of the third layer 70. The third metallic layer 80 is a continuous layer having a total thickness of such as, from 2.5 nm to 30 nm, such as, from 5 nm to 30 nm, such as, from 5 nm to 20 nm, such as, from 7 nm to 20 nm, such as, from, such as, from 12 nm to 18 nm, or such as, from 15 nm to 18 nm.

In another embodiment, the third metallic layer 80 is a discontinuous layer, having a subcritical thickness, formed over at least a portion of the third layer 70. The metallic material, such as, but not limited to, metallic gold, copper, palladium, aluminum, silver, or mixtures, alloys, or combinations thereof, is applied at a subcritical thickness such that isolated regions or islands of the material are formed rather than a continuous layer of the material. For silver, it has been determined that the critical thickness is less than 5 nm, such as, less than 4 nm, such as, less than 3 nm, such as, less than 2.5 nm. For silver, the transition between a continuous layer and a subcritical layer occurs in the range of 2.5 nm to 5 nm. For copper, it has been determined that the effective thickness is at most 9 nm; e.g., 5 nm; 4 nm; e.g., 3.6 nm, e.g., 2.6 nm; e.g., 2 nm; e.g., 1.7 nm; and at least 0.1 nm; e.g., 0.2 nm; e.g. 0.3 nm; e.g. 0.4 nm; e.g. 0.5 nm; e.g. 0.6 nm; e.g. 0.7 nm. It is estimated that copper, gold, and palladium would exhibit similar subcritical behavior in this range. In one non-limiting embodiment, the third metallic layer 80 comprises islanded silver with the islands having an effective thickness of at most 7 nm, e.g., at most 4 nm, e.g., at most 3.5 nm, e.g., at most 3 nm, e.g., at most 2.5 nm, e.g., at most 2 nm; e.g., at most 1.7 nm; and at least 0.1 nm; e.g., at least 0.2 nm; e.g., at least 0.4 nm; e.g., at least 0.5 nm; e.g., at least 0.7 nm; e.g., at least 1 nm. In another embodiment, the third metallic layer 80 comprises copper with the islands having an effective thickness is at most 9 nm; e.g., 5 nm; 40 nm; e.g., 3.6 nm, e.g., 2.6 nm; e.g., 2 nm; e.g., 1.7 nm; and at least 0.1 nm; e.g., 0.2 nm; e.g., 0.3 nm; e.g. 0.4 nm; e.g., 0.5 nm; e.g., 0.6 nm; e.g., 0.7 nm; and, optionally, silver with islands having an effective thickness of at most 7 nm, e.g., at most 4 nm, e.g., at most 3.5 nm, e.g., at most 3 nm, e.g., at most 2.5 nm, e.g., at most 2 nm; e.g., at most 1.7 nm; and at least 0.1 nm; e.g., at least 0.2 nm; e.g., at least 0.4 nm; e.g., at least 0.5 nm; e.g., at least 0.7 nm; e.g., at least 1 nm. The third metallic layer 80 absorbs electromagnetic radiation according to the Plasmon Resonance Theory. This absorption depends at least partly on the boundary conditions at the interface of the metallic islands. The third metallic layer 80 is not an infrared reflecting layer, like the metallic layer 40. It is estimated that for silver and copper, the metallic islands or balls of silver metal and copper metal deposited below the subcritical thickness can have a height of about 2 nm to 7 nm, such as, 5 nm to 7 nm. It is estimated that if the subcritical metal layer could be spread out uniformly, it would have a thickness of about 1.1 nm. It is estimated that optically, the discontinuous metal layer behaves as an effective layer thickness of 2.6 nm.

As shown in FIGS. 4A-4F and 5A-5H, the functional coatings 20 (i.e., the triple metal functional coating 23 and the quadruple metal functional coating 24) comprise a third primer layer 82 positioned over or in direct contact with the third metallic layer 80. The third primer layer 82 can be a single film or a multiple film layer. The third primer layer 82 can include an oxygen-capturing material that can be sacrificial during the deposition process to prevent degradation or oxidation of the third metallic layer 80 during the sputtering process or subsequent heating processes. The third primer layer 82 can also absorb at least a portion of electromagnetic radiation, such as, visible light, passing through the functional coating 20.

Referring to FIGS. 4E-4F and 5E-5F, the third primer layer 82 comprises the patterned feature. The patterned feature of FIGS. 4E-4F and 5E-5F is shown as stripes 25 but can be any symmetric or asymmetric patterned feature. When the third primer layer 82 comprises the patterned feature, none of the other layers of the functional coating 20 comprise a patterned feature.

Referring to FIGS. 4E and 5E, third primer layer 82 comprises a first primer film 84 that comprises the patterned feature. The first primer film 84 is positioned over or in direct contact with at least a portion of the third metallic layer 80. The third primer layer 82 comprises a second primer film 86 that is a non-patterned film. The second primer film 86 is over or in direct contact with at least a portion of the first primer film 84 and the third metallic layer 80. As shown in FIG. 4E, when the functional coating 20 is a triple metal functional coating 23, the top layer 110 is positioned over or in direct contact with at least a portion of the second primer film 84. As shown in FIG. 5E, when the functional coating 20 includes four or more metallic layers (i.e., the functional coating is a quadruple metal functional coating 24), a fourth layer 90 is positioned over or in direct contact with at least a portion of the second primer film 86.

Referring to FIGS. 4F and 5F, the third primer layer 82 comprises a first primer film 84 that is a non-patterned film. The first primer film 84 is positioned over or in direct contact with at least a portion of the third metallic layer 80. The first primer layer 82 comprises a second primer film 86 over or in direct contact with at least a portion of the first primer film 84 and the second primer film 86 comprises the patterned feature. As shown in FIG. 4F, when the functional coating 20 is a triple metal functional coating 23, the top layer 110 is positioned over or in direct contact with at least a portion of the first primer film 84 and the second primer film 86. As shown in FIG. 5F, when the functional coating 20 includes four or more metallic layers (i.e., is a quadruple metal functional coating 24), a fourth layer 90 is positioned over or in direct contact with at least a portion of the first primer film 84 and the second primer film 86 comprising the patterned feature.

The first primer film 84 and the second primer film 86 may each independently be selected from the group consisting of titanium, silicon, tin, silicon dioxide, silicon nitride, silicon oxynitride, nickel, zirconium, aluminum, cobalt, chromium, titanium, aluminum, an alloy thereof, or a mixture thereof. In one non-limiting embodiment, the first primer film 84 comprises titanium and the second primer film 86 comprises aluminum zinc. In another non-limiting embodiment, the first primer film 84 comprises titanium and the second primer film 86 comprises tin. In another non-limiting embodiment, the first primer film 84 comprises titanium and the second primer film 86 comprises nickel chromium.

When the first primer film 84 of the third primer layer 82 comprises the patterned feature, the patterned feature of the first primer film 84 may comprise a thickness in a range of from 0.5 nm to 20 nm, such as from 1 nm to 15 nm, such as from 1 nm to 10 nm, or such as from 1 nm to 8 nm. This thickness of the first primer film 64 is the thickness of the patterned feature.

When the first primer film 84 of the third primer layer 82 is a non-patterned film, the first primer film 84 of the third primer layer 82 may comprise a thickness in the range of from 0.5 nm to 10 nm, such as, from 0.5 nm to 8 nm, or such as, from 1 nm to 6 nm.

When the second primer film 86 of the third primer layer 82 comprises the patterned feature, the patterned feature of the second primer film 86 may comprise a thickness in a range of from 0.5 nm to 20 nm, such as from 1 nm to 15 nm, such as from 1 nm to 10 nm, or such as from 1 nm to 8 nm. This thickness of the second primer film 86 is the thickness of the patterned feature.

When the second primer film 86 of the third primer layer 82 is a non-patterned film, the second primer film 86 of the third primer layer 82 may comprise a thickness in a range of from 0.5 nm to 10 nm such as from 0.5 nm to 8 nm, or such as from 1 nm to 6 nm.

When the third primer layer 82 does not comprise the patterned feature, as shown in FIGS. 4A-4D, 5A-5D, and 5G-5H, and is a single film, the third primer layer 82 may comprise a thickness in a range of from 0.5 nm to 5 nm such as from 1 nm to 4 nm, or such as from 1 nm to 2.5 nm and may comprise a material selected from a group consisting of titanium, silicon, tin, silicon dioxide, silicon nitride, silicon oxynitride, nickel, zirconium, zinc, aluminum, cobalt, chromium, aluminum, alloys thereof, or mixtures thereof.

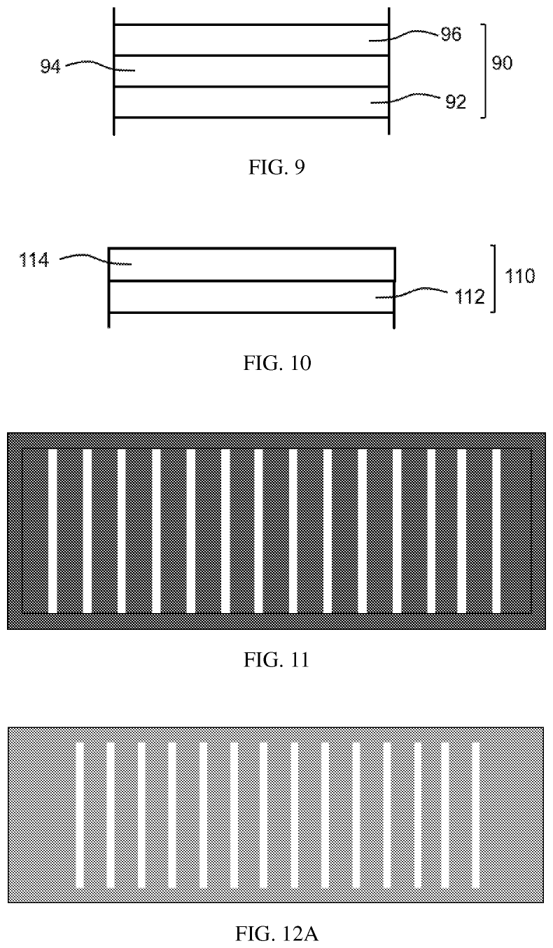

In embodiments where there are four or more metallic layers (i.e., a quadruple metal functional coating 24), a fourth layer 90 is positioned over or in direct contact with at least a portion of the third primer layer 82. The fourth layer 90 can comprise one or more metal oxide, metal alloy oxide, metal nitride, metal alloy nitride, metal oxynitride, or metal alloy oxynitride-containing films, such as, those described above with respect to the first film 32 and second film 34 of the base layer 30. For example, as shown in FIG. 9, the fourth layer 90 can include a first film 92 comprising a metal oxide, e.g., a zinc oxide film or an aluminum zinc oxide film, deposited over at least a portion of the third primer layer 82, a second film 94 comprising a metal oxide, e.g., a zinc stannate film, over at least a portion of the first film 92, and a third film 96 comprising a metal oxide, e.g., a zinc oxide film or an aluminum zinc oxide film, over at least a portion of the second film 94.

When the functional coating 20 comprises four or more metallic layers (i.e., is a quadruple metal functional coating 24) and the first primer film 84 of the third primer layer 82 comprises the patterned feature, as shown in FIG. 5E, the first film 92 of the fourth layer 90 is positioned over or in direct contact with at least a portion of the second primer film 86 of the third primer layer 82.

When the functional coating 20 comprises four or more metallic layers (i.e., is a quadruple metal functional coating 24) and the third primer layer 82 comprises the patterned feature, as shown in FIG. 5F, the first film 92 of the fourth layer 90 is positioned over or in direct contact with at least a portion of the first primer film 84 and the second primer film 86 comprising the patterned feature.

The fourth layer 90 comprises a total thickness (e.g., the combined thicknesses of the layers) in the range of from 20 nm to 100 nm, such as, from 40 nm to 90 nm, such as, from 50 nm to 90 nm, such as, from 65 nm to 80 nm, such as, from 30 nm to 40 nm.

In one example, both of the first and third films 92, 96 are present and each has a thicknesses in the range of from 5 nm to 20 nm, such as, from 7.5 nm to 15 nm, such as, from 8 nm to 15 nm, or such as, from 9.5 to 10 nm. The second film 94 can have a thickness in the range of from 10 nm to 80 nm, such as, from 20 nm to 70 nm, such as, from 30 nm to 60 nm, such as, from 38 nm to 50 nm, such as, from 38 nm to 45 nm.

As shown in FIGS. 5A-5H, the functional coatings 20 (i.e., the quadruple metal functional coatings 24) comprise a fourth metallic layer 100 positioned over or in direct contact with a least a portion of the fourth layer 90. The fourth metallic layer 100 can include a reflective metal, such as, but not limited to, metallic gold, copper, palladium, aluminum, silver, or mixtures, alloys, or combinations thereof. The fourth metallic layer 100 is a continuous layer. In some embodiments, the fourth metallic layer 100 comprises a metallic silver layer.

The fourth metallic layer 100 is a continuous layer having a total thickness of from 5 nm to 30 nm, such as, from 6 nm to 15 nm, such as, from 6 nm to 10 nm, such as, from 10 nm to 25 nm, such as, from 15 nm to 25 nm, such as, from 20 nm to 25 nm, such as, from 21 nm to 23 nm.

As shown in FIGS. 5A-5H, the functional coatings 20 (i.e., the quadruple metal functional coating 24) comprise a fourth primer layer 102 positioned over or in direct contact with at least a portion of the fourth metallic layer 100. The fourth primer layer 102 can be a single film or a multiple film layer. The fourth primer layer 102 can include an oxygen-capturing material that can be sacrificial during the deposition process to prevent degradation or oxidation of the fourth metallic layer 100 during the sputtering process or subsequent heating processes. The fourth primer layer 102 can also absorb at least a portion of electromagnetic radiation, such as, visible light, passing through the functional coating 20.

Referring to FIGS. 5G and 5H, the fourth primer layer 102 comprises the patterned feature. The patterned feature of FIGS. 5G and 5H is shown as stripes 25 but can be any symmetric or asymmetric patterned feature. When the fourth primer layer 102 comprises the patterned feature, none of the other layers of the functional coating 20 comprise a patterned feature.

Referring to FIG. 5G, the fourth primer layer 102 comprises a first primer film 104 that comprises the patterned feature. The first primer film 104 is positioned over or in direct contact with at least a portion of the fourth metallic layer 100. The fourth primer layer 102 comprises a second primer film 106 that is a non-patterned film. The second primer film 106 is over or in direct contact with at least a portion of the first primer film 104 and the fourth metallic layer 100. As shown in FIG. 5G, the top layer 110 is positioned over or in direct contact with at least a portion of the second primer film 106.

Referring to FIG. 5H, the fourth primer layer 102 comprises a first primer film 104 that is a non-patterned film. The first primer film 104 is positioned over or in direct contact with at least a portion of the fourth metallic layer 100. The fourth primer layer 102 comprises a second primer film 106 over or in direct contact with at least a portion of the first primer film 104 and the second primer film 106 comprises the patterned feature. As shown in FIG. 5H, when the functional coating 20 is a quadruple metal functional coating 24, the top layer 110 is positioned over or in direct contact with at least a portion of the first primer film 104 and the second primer film 106 comprising the patterned feature.

The first primer film 104 and the second primer film 106 may each independently be selected from the group consisting of titanium, silicon, tin, silicon dioxide, silicon nitride, silicon oxynitride, nickel, zirconium, aluminum, cobalt, chromium, titanium, aluminum, an alloy thereof, or a mixture thereof. In one non-limiting embodiment, the first primer film 104 comprises titanium and the second primer film 106 comprises aluminum zinc. In another non-limiting embodiment, the first primer film 104 comprises titanium and the second primer film 106 comprises tin. In another non-limiting embodiment, the first primer film 104 comprises titanium and the second primer film 106 comprises nickel chromium.

When the first primer film 104 comprises the patterned feature, the patterned feature of the first primer film 104 may comprise a thickness in a range of from 0.5 nm to 20 nm, such as from 1 nm to 15 nm, such as from 1 nm to 10 nm, or such as from 1 nm to 8 nm. This thickness of the first primer film 104 is the thickness of the patterned feature.

When the first primer film 104 of the fourth primer layer 102 is a non-patterned film, the first primer film 104 of the fourth primer layer 102 may comprise a thickness in the range of from 0.5 nm to 10 nm, such as, from 0.5 nm to 8 nm, or such as, from 1 nm to 6 nm.

When the second primer film 106 of the fourth primer layer 102 comprises the patterned feature, the patterned feature of the second primer film 106 may comprise a thickness in a range of from 0.5 nm to 20 nm, such as from 1 nm to 15 nm, such as from 1 nm to 10 nm, or such as from 1 nm to 8 nm. This thickness of the second primer film 106 is the thickness of the patterned feature.

When the second primer film 106 of the fourth primer layer 102 is a non-patterned film, the second primer film 106 of the second primer layer 102 may comprise a thickness in a range of from 0.5 nm to 10 nm such as from 0.5 nm to 8 nm, or such as from 1 nm to 6 nm.

A top layer 110 is located over the uppermost primer layer. In a single metallic layer functional coating 21, the top layer 110 is formed over at least a portion of the first primer layer 42. In a double metallic layer functional coating 22, the top layer 110 is formed over at least a portion of the second primer layer 62. In a triple metallic layer functional coating 23, the top layer 110 is formed over at least a portion of the third primer layer 82. In a quadruple metallic layer functional coating 24, the top layer 110 is formed over at least a portion of the fourth primer layer 102.

The top layer 110 can comprise one or more metal oxide, metal alloy oxide, metal nitride, metal alloy nitride, metal oxynitride, or metal alloy oxynitride-containing films, such as, those described above with respect to the first film 32 and second film 34 of the base layer 30. For example, as shown in FIG. 10, the top layer 110 can include a first metal oxide film 112, e.g., a zinc oxide film, deposited over the uppermost primer layer and a second metal alloy film 114, e.g., a zinc stannate film, deposited over at least a portion of the first metal oxide film 112. The top layer 110 may optionally comprise a third metal alloy or metal alloy oxynitride film, e.g., a zinc stannate film or a silicon aluminum oxynitride film, deposited over at least a portion of the second metal alloy film 114 (not shown). For example, the top layer 110 can include a first metal alloy film 112, e.g., a zinc stannate film, deposited over the uppermost primer layer and a metal oxynitride film 114, e.g., a silicon aluminum oxynitride film, deposited over at least a portion of the first metal alloy film 112. The top layer 110 can include a first metal oxide film 112, e.g., a zinc oxide film or an aluminum zinc oxide film, deposited over the uppermost metallic layer (e.g., uppermost primer layer), a second metal alloy film 114, e.g., a zinc stannate film, deposited over at least a portion of the first film 112, and optionally a third metal alloy oxynitride film, e.g., a silicon aluminum oxynitride film, deposited over the second zinc stannate film. The top layer 110 can include a first metal oxide film 112, e.g., a zinc oxide film or an aluminum zinc oxide film, deposited over the uppermost metallic layer (e.g., uppermost primer layer), a second metal alloy film 114, e.g., a zinc stannate film, or a second metal oxide film 114, e.g., a tin oxide film, deposited over at least a portion of the first film 112, and optionally a third metal alloy film, e.g., a zinc stannate film, or optionally a third metal oxide film, e.g., a tin oxide film, deposited over the second zinc stannate film 114. In some non-limiting embodiments, the second film 114 of the top layer 110 and the optional third film of the top layer 110 may comprise the same material. For example, the second film 114 of the top layer 110 may comprise zinc stannate and the optional third film of the top layer 110 may comprise zinc stannate. Alternatively, the second film 114 of the top layer 110 may comprise tin oxide and the optional third film of the top layer 110 may comprise tin oxide.

The top layer 110 can have a total thickness (e.g., the combined thicknesses of the layers) in the range of from 25 nm to 100 nm, such as, from 25 nm to 95 nm, from 30 to 95 nm, from 35 nm to 95 nm, from 40 nm to 95 nm, from 45 nm to 95 nm, from 50 nm to 95 nm, from 25 nm to 45 nm, or from 25 nm to 40 nm.

The functional coating 20 that includes one metallic layer (i.e., a single metal functional coating 21) may comprise a symmetric patterned feature comprising stripes 25 in first primer film 44 of the first primer layer 42. Alternatively, the functional coating 20 that includes one metallic layer (i.e., a single metal functional coating 21) may comprise a symmetric patterned feature comprising stripes 25 in second primer film 46 of the first primer layer 42. Alternatively, the functional coating 20 that includes one metallic layer (i.e., a single metal functional coating 21) may comprise an asymmetric patterned feature in the first primer film 44 of the first primer layer 42. Alternatively, the functional coating 20 that includes one metallic layer (i.e., a single metal functional coating 21) may comprise an asymmetric patterned feature in the second primer film 46 first primer layer 42.

The functional coating 20 that includes two metallic layers (i.e., a double metal functional coating 22) may comprise a symmetric patterned feature comprising stripes 25 in the first primer film 42 of the first primer layer 42. Alternatively, the functional coating 20 that includes two metallic layers (i.e., a double metal functional coating 22) may comprise a symmetric patterned feature comprising stripes 25 in the second primer film 46 of the first primer layer 42. Alternatively, the functional coating 20 that includes two metallic layers (i.e., a double metal functional coating 22) may comprise an asymmetric patterned feature in the first primer film 44 of the first primer layer 62. Alternatively, the functional coating 20 that includes two metallic layers (i.e., a double metal functional coating 22) may comprise an asymmetric patterned feature in the second primer film 46 of the first primer layer 62. The functional coating 20 that includes two metallic layers (i.e., a double metal functional coating 22) may comprise a symmetric patterned feature comprising stripes 25 in the first primer film 64 of the second primer layer 62. Alternatively, the functional coating 20 that includes two metallic layers (i.e., a double metal functional coating 22) may comprise a symmetric patterned feature comprising stripes 25 in the second primer film 66 of the second primer layer 62. Alternatively, the functional coating 20 that includes two metallic layers (i.e., a double metal functional coating 22) may comprise an asymmetric patterned feature in the first primer film 64 of the second primer layer 62. Alternatively, the functional coating 20 that includes two metallic layers (i.e., a double metal functional coating 22) may comprise an asymmetric patterned feature in the second primer film 66 of the second primer layer 62.

The functional coating 20 that includes three metallic layers (i.e., a triple metal functional coating 23) may comprise a symmetric patterned feature comprising stripes 25 in the first primer film 44 of the first primer layer 42. Alternatively, the functional coating 20 that includes three metallic layers (i.e., a triple metal functional coating 23) may comprise a symmetric patterned feature comprising stripes 25 in the second primer film 46 of the first primer layer 42. Alternatively, the functional coating 20 that includes three metallic layers (i.e., a triple metal functional coating 23) may comprise an asymmetric patterned feature in the first primer film 44 of the first primer layer 42. Alternatively, the functional coating 20 that includes three metallic layers (i.e., a triple metal functional coating 23) may comprise an asymmetric patterned feature in the second primer film 46 of the first primer layer 42. The functional coating 20 that includes three metallic layers (i.e., a triple metal functional coating 23) may comprise a symmetric patterned feature comprising stripes 25 in the first primer film 64 of the second primer layer 62. Alternatively, the functional coating 20 that includes three metallic layers (i.e., a triple metal functional coating 23) may comprise a symmetric patterned feature comprising stripes 25 in the second primer film 66 of the second primer layer 62. Alternatively, the functional coating 20 that includes three metallic layers (i.e., a triple metal functional coating 23) may comprise an asymmetric patterned feature in the first primer film 64 of the second primer layer 62. Alternatively, the functional coating 20 that includes three metallic layers (i.e., a triple metal functional coating 23) may comprise an asymmetric patterned feature in the second primer film 66 of the second primer layer 62. The functional coating 20 that includes three metallic layers (i.e., a triple metal functional coating 23) may comprise a symmetric patterned feature comprising stripes 25 in the first primer film 84 of the third primer layer 82. Alternatively, the functional coating 20 that includes three metallic layers (i.e., a triple metal functional coating 23) may comprise a symmetric patterned feature comprising stripes 25 in the second primer film 86 of the third primer layer 82. Alternatively, the functional coating 20 that includes three metallic layers (i.e., a triple metal functional coating 23) may comprise an asymmetric patterned feature in the first primer film 84 of the third primer layer 82. Alternatively, the functional coating 20 that includes three metallic layers (i.e., a triple metal functional coating 23) may comprise an asymmetric patterned feature in the second primer film 86 of the third primer layer 82.

The functional coating 20 that includes four metallic layers (i.e., a quadruple metal functional coating 24) may comprise a symmetric patterned feature comprising stripes 25 in the first primer film 44 of the first primer layer 42. Alternatively, the functional coating 20 that includes four metallic layers (i.e., a quadruple metal functional coating 24) may comprise a symmetric patterned feature comprising stripes 25 in the second primer film 46 of the first primer layer 42. Alternatively, the functional coating 20 that includes four metallic layers (i.e., a quadruple metal functional coating 24) may comprise an asymmetric patterned feature in the first primer film 44 of the first primer layer 42. Alternatively, the functional coating 20 that includes four metallic layers (i.e., a quadruple metal functional coating 24) may comprise an asymmetric patterned feature in the second primer film 46 of the first primer layer 42. The functional coating 20 that includes four metallic layers (i.e., a quadruple metal functional coating 24) may comprise a symmetric patterned feature comprising stripes 25 in the first primer film 64 of the second primer layer 62. Alternatively, the functional coating 20 that includes four metallic layers (i.e., a quadruple metal functional coating 24) may comprise a symmetric patterned feature comprising stripes 25 in the second primer film 66 of the second primer layer 62. Alternatively, the functional coating 20 that includes four metallic layers (i.e., a quadruple metal functional coating 24) may comprise an asymmetric patterned feature in the first primer film 64 of the second primer layer 62. Alternatively, the functional coating 20 that includes four metallic layers (i.e., a quadruple metal functional coating 24) may comprise an asymmetric patterned feature in the second primer film 66 of the second primer layer 62. The functional coating 20 that includes four metallic layers (i.e., a quadruple metal functional coating 24) may comprise a symmetric patterned feature comprising stripes 25 in the first primer film 84 of the third primer layer 82. Alternatively, the functional coating 20 that includes four metallic layers (i.e., a quadruple metal functional coating 24) may comprise a symmetric patterned feature comprising stripes 25 in the second primer film 86 of the third primer layer 82. Alternatively, the functional coating 20 that includes four metallic layers (i.e., a quadruple metal functional coating 24) may comprise an asymmetric patterned feature in the first primer film 84 of the third primer layer 82. Alternatively, the functional coating 20 that includes four metallic layers (i.e., a quadruple metal functional coating 24) may comprise an asymmetric patterned feature in the second primer film 86 of the third primer layer 82. The functional coating 20 that includes four metallic layers (i.e., a quadruple metal functional coating 23) may comprise a symmetric patterned feature comprising stripes 25 in the first primer film 104 of the fourth primer layer 102. Alternatively, the functional coating 20 that includes four metallic layers (i.e., a quadruple metal functional coating 23) may comprise a symmetric patterned feature comprising stripes 25 in the second primer film 106 of the fourth primer layer 102. Alternatively, the functional coating 20 that includes four metallic layers (i.e., a quadruple metal functional coating 24) may comprise an asymmetric patterned feature in the first primer film 104 of the fourth primer layer 102. Alternatively, the functional coating 20 that includes four metallic layers (i.e., a quadruple metal functional coating 24) may comprise an asymmetric patterned feature in the second primer film 106 of the fourth primer layer 102.

The functional coating 20 comprises only one layer that comprises a patterned feature.

The functional coating 20 may be the only coating on the second side of the substrate 12.

An optional outermost protective coating 120 can be formed over at least a portion of the top layer 110 of the functional coating 20 and can be the outermost coating of the coated article 10. The outermost protective coating 120 can help protect the underlying functional coating layers, from mechanical and/or chemical attack. The outermost protective coating 120 can be an oxygen barrier coating layer to prevent or reduce the passage of ambient oxygen into the underlying layers of the coating, such as, during heating or bending. The outermost protective coating 120 can be of any desired material or mixture of materials and can be comprised of one or more protective films. The outermost protective coating 120 comprises a protective layer, wherein the protective layer comprises at least one of Si₃N₄, SiAlN, SiAlON, SiAlO, TiAlO, titania, alumina, silica, zirconia, or combinations thereof.

In one embodiment, the outermost protective coating 120 may be comprised of a first protective film 122 and second protective film 124 over at least a portion of the first protective film 122. In one embodiment, the first protective film 122 comprises a metal nitride film, e.g., a silicon aluminum nitride, disposed over and in contact with metal oxynitride film (e.g., silicon aluminum oxynitride) of the top layer 110 and the second protective film 124 comprises a metal alloy oxide, such as titanium aluminum oxide, disposed over and in contact with the first protective film 122.

In one embodiment, the metal oxynitride film of the top layer 110 is a metal oxynitride of the same metal as in the first protective metal nitride film 122 that contacts the metal oxynitride film of the top layer 110. In another embodiment, the metal oxynitride film of the top layer 110 is a gradient layer wherein the portion of the metal oxynitride film that is closest to the uppermost metal alloy film of the top layer 110 comprises a greater amount of oxygen, and the opposite portion of the metal oxynitride film, e.g., that is closest to the first protective metal nitride film 122, comprises a greater amount of nitrogen, for example, in atomic ratios described above. In one embodiment, the metal oxynitride film of the top layer 110 and the first protective metal nitride film 122 form a continuous, single gradient layer. In another embodiment, the metal oxynitride film of the top layer 110 is applied over a metal alloy oxide film and/or in between a metal alloy oxide film and the first protective metal nitride film 122. In another embodiment, the first protective metal nitride film 122 is not present, and the metal oxynitride film of the top layer 110 is a gradient layer, wherein amount of oxygen in the metal oxynitride film of the top layer 110 decreases with increased distance from the metal alloy oxide film of top layer 110. For example, the portion of the metal oxynitride film of the top layer 110 that is closest to the uppermost metal alloy oxide film of the top layer 110 comprises a greater amount of oxygen, and the opposite portion of the oxynitride film of the top layer 110, comprises a greater amount of nitrogen, where the atomic ratio of oxygen and nitrogen in metal oxynitrides is an approximation based on the flow rate of nitrogen (N₂) and the flow rate of O₂. The oxynitride film of the top layer 110 comprises 0 wt. % oxygen, and not more than 50 wt. % oxygen; not more than 40 wt. % oxygen; not more than 30 wt. % oxygen; not more than 20 wt. % oxygen; not more than 10 wt. % oxygen; not more than 5 wt. % oxygen. Non-limiting examples of useful atomic ratios of oxygen and nitrogen in the oxynitride film of the top layer 110 include, for example, and without limitation, from 5% to 45% O with from 95% to 55% N; from 10 to 50% O with from 90% to 50% N; from 15% to 40% O to 85% to 60% N; from 20% to 50% O to 80% to 50% N; from 25% to 45% O to 75% to 55% N; from 30% to 50% O to 70% to 50% N; from 40% to 50% O to 60% to 50% N; or 50% O with 50% N.

The metal oxynitride film of the top layer 110 can have a thickness in the range of from >0 nm to 40 nm, such as, from 7 nm to 40 nm, from 10 nm to 40 nm, from 28 nm to 33 nm, or from 12 nm to 22 nm. In embodiments where the metal oxynitride film of the top layer 110 is a gradient layer, or where there is no metal nitride film in the outermost protective coating, it may have a thickness of from 20 nm to 40 nm, such as, from 22.5 nm to 39 nm, such as, from 25 nm to 38 nm, such as, from 28 nm to 37.5 nm.

The first protective metal nitride film 122 can have a thickness in the range of from >0 nm to 40 nm, such as, from 7 nm to 40 nm, such as, from 10 nm to 40 nm, such as, from 25 nm to 40 nm, such as, from 28 nm to 33 nm, such as, from 20 nm to 25 nm, such as, from 20 nm to 40 nm, such as, from 10 nm to 16 nm. In embodiments where there is no metal oxynitride film of the top layer 110 and/or no second protective film, the first protective metal nitride film 122 can have a thickness in the range of 10 nm to 40 nm, preferably, 25 nm to 40 nm, most preferably, 28 nm to 33 nm. In embodiments where the top layer 110 has a metal oxynitride film and the outermost protective coating 120 has a second protective film 124, the first protective metal nitride film 122 can have a thickness of 10 nm to 40 nm, such as, from 10 nm to 33 nm, such as, from 10.5 nm to 30 nm, such as, from 11.5 nm to 25 nm. In embodiments where the protective coating 120 has both a first protective metal nitride 122 film and a second protective film 124, the metal oxynitride film of the top layer 110 can have a thickness of from 5 nm to 28 nm, such as, from 7.5 nm to 26 nm, such as, from 10 nm to 24 nm, such as, from 12 nm to 22 nm.

In certain embodiments, the invention has a combined thickness of the metal oxynitride film of the top layer 110 (if present) and/or the first protective metal nitride film 122 (if present) of between 20 nm and 80 nm, for example, 32 nm to 80 nm, 32 nm to 38 nm, or 28 nm to 37 nm.

In certain embodiments, the outermost protective coating 120 can comprise a second protective film 124 comprising TiAlO. Non-limiting examples of the second protective film 124 may have a thickness range of such as, from 10 nm to 40 nm, such as, from 20 nm to 37 nm, such as, from 24.5 nm to 30 nm, such as, from 28.5 nm to 30 nm. It is to be understood that the second protective film 124 may be applied, e.g., as the top-most layer, to any other configuration of the top layer, metal nitride films, and metal oxynitride films consistent with the present disclosure. Alternatively, additional functional layers or protective layers may be applied over the second protective film 124 (not shown). This additional protective film can be any of the materials used to form the protective coating 120, or the second protective film 124, or any material that may be used as a topcoat. Similarly, it is to be understood that a coated article need not include a second protective film 124.

The outermost protective coating 120 has a total thickness (i.e., the sum of all of the thickness of the layers or films within the protective coating 120) in the range of from 20 nm to 80 nm, such as, from 30 nm to 70 nm, such as, from 35 nm to 60 nm, such as, from 40 nm to 55 nm.

The outermost protective coating 120 can also comprise a single titania film. The single titania film can have a thickness of from 1 nm to 10 nm, such as, from 2 nm to 8 nm, or such as, from 2 nm to 3 nm.

In the practice of the invention, by selecting a particular metal for the metallic layers, selecting a primer material and thickness, and selecting dielectric material(s) and thickness, the absorbed color (e.g., tint) of the coating can be varied. The coated articles of the present invention may be non-temperable. The coated articles of the present invention may be temperable. In the practice of the invention, it is desired to maintain the color of the coated article before and after tempering.

The present invention is also directed to a method of making a coated article. A substrate 12 comprising a first side comprising a first surface 14 and a second side comprising a second surface 16, where the second surface 16 is opposite the first surface 14 is provided. A functional coating 20 is formed over at least a portion of the second side of the substrate 12. Forming the functional coating 20, includes forming a base layer 30 over at least a portion of the second surface 16. The base layer 30 can be any base layer 30 described herein. A metallic layer is formed over at least a portion of the base layer 30. The metallic layer can be any metallic layer as described herein. A primer layer comprising a patterned feature is formed over at least a portion of the metallic layer. Forming the primer layer comprises: forming a first primer film over at least a portion of the metallic layer, and forming a second primer film over at least a portion of the first primer film, wherein the one of the first primer film or the second primer film comprises the patterned feature. A top layer 110 is formed over at least a portion of the primer layer. The top layer 110 can be any top layer 110 as described herein. The forming of the base layer 30, metallic layer, the primer layer comprising the patterned feature, and top layer 110 creates the functional coating 20 of the coated article 10. The functional coating 20 may comprise additional layers as described herein. The patterned feature may be a symmetric pattern. The patterned feature may be an asymmetric pattern.

When the functional coating 20 includes one metallic layer (i.e., a single metal functional coating 21), the patterned feature is formed in the first primer layer 42 (FIGS. 2A-2B). The patterned feature may be formed in the first primer film 44 (FIG. 2A) or the second primer film 46 (FIG. 2B).

When the functional coating 20 comprises two metallic layers (i.e., a double metal functional coating 22), the patterned feature may be formed in one of the first primer layer 42 (FIGS. 3A-3B) or the second primer layer 62 (FIG. 3C-3D). The patterned feature may be formed in the first primer film 44 of the first primer layer 42 (FIG. 3A), the second primer film 46 of the first primer layer 42 (FIG. 3B), the first primer film 64 of the second primer layer 62 (FIG. 3C), or the second primer film 66 of the second primer layer 62 (FIG. 3D).

When the functional coating 20 comprises three metallic layers (i.e., a triple metal functional coating 23), the patterned feature may be formed in one of the first primer layer 42 (FIGS. 4A-4B), the second primer layer 62 (FIGS. 4C-4D), or the third primer layer 82 (FIGS. 4E-4F). The patterned feature may be formed in the first primer film 44 of the first primer layer 42 (FIG. 4A), the second primer film 46 of the first primer layer 42 (FIG. 4B), the first primer film 64 of the second primer layer 62 (FIG. 4C), the second primer film 66 of the second primer layer 62 (FIG. 4D), the first primer film 84 of the third primer layer 82 (FIG. 4E), or the second primer film 86 of the third primer layer 82 (FIG. 4F).

When the functional coating 20 comprises four metallic layers (i.e., a quadruple metal functional coating 24), the patterned feature may be formed in one of the first primer layer 42 (FIGS. 5A-5B), the second primer layer 62 (FIGS. 5C-5D), the third primer layer 82 (FIGS. 5E-5F), or the fourth primer layer 102 (FIGS. 5G-5H). The patterned feature may be formed in the first primer film 44 of the first primer layer 42 (FIG. 5A), the second primer film 46 of the first primer layer 42 (FIG. 5B), the first primer film 64 of the second primer layer 62 (FIG. 5C), the second primer film 66 of the second primer layer 62 (FIG. 5D), the first primer film 84 of the third primer layer 82 (FIG. 5E), the second primer film 86 of the third primer layer 82 (FIG. 5F), the first primer film 104 of the fourth primer layer 102 (FIG. 5G), or the second primer film 106 of the fourth primer film (FIG. 5H).

The patterned feature may be formed in the first primer film 44, 64, 84, 104 of the first primer layer 42, the second primer layer 62, the third primer layer 82, or the fourth primer layer 42 of the functional coating 20 using any method known in the art, such as by masking, laser ablation, chemical etching, ion beam for material removal, ultraviolet radiation treatment, and combinations thereof.

The patterned features may be formed in the second primer film 46, 66, 86, 106 of the first primer layer 42, the second primer layer 62, the third primer layer 82, or the fourth primer layer 42 of the functional coating 20 using any method known in the art, such as by masking, laser ablation, chemical etching, ion beam for material removal, ultraviolet radiation treatment, and combinations thereof.

For example, masking may be used to form the patterned feature in the first primer film 44, 64, 84, 104 or the second primer film 46, 66, 86, 106.

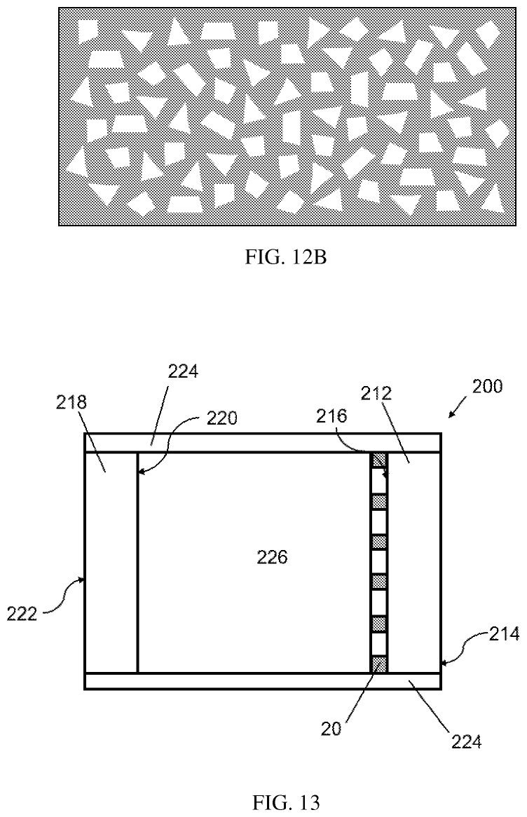

The mask comprises a polymeric sheet or a metallic sheet (e.g., a stainless steel sheet) comprising at least one opening. The at least one opening in the polymeric sheet or metallic sheet creates the patterned feature in the first primer film 44, 64, 84, 104 or the second primer film 46, 66, 86, 106. Alternatively, the mask may comprise a polymeric sheet or a metallic sheet (e.g., a stainless steel sheet) comprising a plurality of openings. The plurality of openings in the polymeric sheet or metallic sheet creates the patterned feature in the first primer film 44, 64, 84, 104 or the second primer film 46, 66, 86, 106. An exemplary polymeric mask having a plurality of openings is provided in FIG. 11. Exemplary metallic masks having a plurality of openings are provided in FIGS. 12A and 12B, where the mask in FIG. 12A creates a symmetric pattern in the first primer film 44, 64, 84, 104 or the second primer film 46, 66, 86, 106 and the mask in FIG. 12B creates an asymmetric pattern in the first primer film 44, 64, 84, 104 or the second primer film 46, 66, 86, 106.

At least one mask may be used to form the patterned feature of the first primer film 44, 64, 84, 104 or the second primer film 46, 66, 86, 106.

Alternatively, two or more masks may be used to form the patterned feature of the first primer film 44, 64, 84, 104 or the second primer film 46, 66, 86, 106. For example, two or more masks may be connected together with a gap present between adjacent masks. As used herein, “gap” is the distance between adjacent masks. Alternatively, two or more masks may be connected together with no gap present between adjacent masks.

To form the patterned feature in the first primer film 44 of the first primer layer 42, the mask may be positioned over at least a portion of the substrate 12 comprising the base layer 30 and the metallic layer 40. The mask may be in direct contact with at least a portion of the metallic layer 40. The mask may be any of the masks described herein. The material for forming the first primer film 44 may then be applied through the at least one opening of the mask and onto the metallic layer 40 to form the patterned feature. The mask may then be removed from the substrate 12. The second primer film 46 of the first primer layer 42 is then applied over the metallic layer 40 and the first primer film 44 such that the second primer film 46 is in direct contact with at least a portion of the metallic layer 40 and the first primer film 44.

To form the patterned feature in the second primer film 46 of the first primer layer 42, a mask may be positioned over at least a portion of the substrate 12 comprising the base layer 30, the metallic layer 40, and the first primer film 44. The mask may be in direct contact with at least a portion of the first primer film 44. The mask may be any of the masks described herein. The material for forming the second primer film 46 may then be applied through the at least one opening of the mask and onto the first primer film 44 to form the patterned feature. The mask may then be removed from the substrate 12. When the functional coating 20 is a single metal functional coating 21, the top layer 110 (e.g., the first film 112 of the top layer 110) is then applied over the first primer film 44 and the second primer film 46 such that the top layer 110 (e.g., the first film 112 of the top layer 110) is in direct contact with at least a portion of the first primer film 44 and is in direct contact with at least a portion of the second primer film 46. When the functional coating 20 comprises two or more metallic layers (i.e., is a double metal functional coating 22, a triple metal functional coating 23, or quadruple metal functional coating 24), the second layer 50 (e.g., the first film 52 of the second layer 50) is then applied over the first primer film 44 and the second primer film 46 such that the second layer 50 (e.g., the first film 52 of the second layer 50) is in direct contact with at least a portion of the first primer film 44 and is in direct contact with at least a portion of the second primer film 46. The remaining layers of the functional coating 20 may then be applied.

Alternatively, to form the patterned feature in the first primer film 44 of the first primer layer 42, a mask may be positioned between the substrate 12 comprising the base layer 30 and the metallic layer 40 and a target comprising a material for forming the first primer film 44. The mask may be any of the masks described herein. The material for forming the first primer film 44 may then be applied through the at least one opening of the mask and onto the metallic layer 40 to form the patterned feature. The substrate 12 comprising the base layer 30, the metallic layer 40, and the first primer film 44 comprising the patterned feature may then be positioned under a second target comprising a material for forming the second primer film 46 and the material for forming the second primer film 46 of the first primer layer 42 is then applied over the metallic layer 40 and the first primer film 44 such that the second primer film 46 is in direct contact with at least a portion of the metallic layer 40 and the first primer film 44.

Alternatively, to form the patterned feature in the second primer film 46 of the first primer layer 42, a mask may be positioned between the substrate 12 comprising the base layer 30, the metallic layer 40, and the first primer film 44 and a target comprising a material for forming the second primer film 46. The mask may be any of the masks described herein. The material for forming the second primer film 46 may then be applied through the at least one opening of the mask and onto the first primer film 44 to form the patterned feature. When the functional coating 20 is a single metal functional coating 21, the substrate 12 comprising the base layer 30, the metallic layer 40, the first primer film 44, and the second primer film 46 comprising the patterned feature may then be positioned under a second target comprising a material for forming the top layer 110 (e.g., a material for the first film 112 of the top layer 110). The material for forming the top layer 110 (e.g., the material for the first film 112 of the top layer 110), may then be applied over the first primer film 44 and the second primer film 46, such that the top layer 110 (e.g., the first film 112 of the top layer 110) is in direct contact with at least a portion of the first primer film 44 and is in direct contact with at least a portion of the second primer film 46. When the functional coating comprises two or more metallic layers (i.e., is a double metal functional coating 22, a triple metal functional coating 23, or quadruple metal functional coating 24), the substrate 12 comprising the base layer 30, the metallic layer 40, the first primer film 44, and the second primer film 46 comprising the patterned feature may then be positioned under a second target comprising a material for forming the second layer 50 (e.g., a material for forming the first film 52 of the second layer 50). The material for forming the second layer 50 (e.g., the material for forming the first film 52 of the second layer 50) is then applied over the first primer film 44 and the second primer film 46 such that the second layer 50 (e.g., the first film 52 of the second layer 50) is in direct contact with at least a portion of the first primer film 44 and is in direct contact with at least a portion of the second primer film 46. The remaining layers of the functional coating 20 may then be applied.

To form patterned feature in the first primer film 64 of the second primer layer 62, a mask may be positioned over at least a portion of the substrate 12 comprising the base layer 30, the metallic layer 40, the first primer layer 42, the second layer 50, and the second metallic layer 60. The mask may be in direct contact with at least a portion of the second metallic layer 60. The mask may be any of the masks described herein. The material for forming the first primer film 64 may then be applied through the at least one opening of the mask and onto the second metallic layer 60 to form the patterned feature. The mask may then be removed from the substrate 12. The second primer film 66 of the second primer layer 62 is then applied over the second metallic layer 60 and the first primer film 64 such that the second primer film 66 is in direct contact with at least a portion of the second metallic layer 60 and the first primer film 64.

To form the patterned feature in the second primer film 66 of the second primer layer 62, a mask may be positioned over at least a portion of the substrate 12 comprising the base layer 30, the metallic layer 40, the first primer layer 42, the second layer 50, the second metallic layer 60, and the first primer film 64. The mask may be in direct contact with at least a portion of the first primer film 64. The mask may be any of the masks described herein. The material for forming the second primer film 66 may then be applied through the at least one opening of the mask and onto the first primer film 64 to form the patterned feature. The mask may then be removed from the substrate 12. When the functional coating 20 is double metal functional coating 22, the top layer 110 (e.g., the first film 112 of the top layer 110) is applied over the first primer film 64 and the second primer film 66 such that the top layer 110 (e.g., the first film 112 of the top layer 110) is in direct contact with at least a portion of the first primer film 64 and is in direct contact with at least a portion of the second primer film 66. When the functional coating 20 comprises three or more metallic layers (i.e., is a triple metal functional coating 23 or quadruple metal functional coating 24), the third layer 70 (e.g., the first film 72 of the third layer 70) is then applied over the first primer film 64 and the second primer film 66 such that the third layer 70 (e.g., the first film 72 of the third layer 70) is in direct contact with at least a portion of the first primer film 64 and is in direct contact with at least a portion of the second primer film 66. The remaining layers of the functional coating 20 may then be applied.

Alternatively, to form the patterned feature in the first primer film 64 of the second primer layer 62, a mask may be positioned between the substrate 12 comprising the base layer 30, metallic layer 40, first primer layer 42, the second layer 50, and the second metallic layer 60 and a target comprising a material for forming the first primer film 64. The mask may be any of the masks described herein. The material for forming the first primer film 64 may then be applied through the at least one opening of the mask and onto the second metallic layer 60 to form the patterned feature. The substrate 12 comprising the base layer 30, the metallic layer 40, the first primer layer 42, the second layer 50, the second metallic layer 60, and the first primer film 64 comprising the patterned feature may then be positioned under a second target comprising a material for forming the second primer film 66. The material for forming the second primer film 66 of the second primer layer 62 may then be applied over the second metallic layer 60 and the first primer film 64 such that the second primer film 66 is in direct contact with at least a portion of the second metallic layer 60 and the first primer film 64.

Alternatively, to form the patterned feature in the second primer film 66 of the second primer layer 62, a mask may be positioned between the substrate 12 comprising the base layer 30, the metallic layer 40, the first primer layer 42, the second layer 50, the second metallic layer 60, and the first primer film 44 and a target comprising a material for forming the second primer film 66. The mask may be any of the masks described herein. The material for forming the second primer film 66 may then be applied through the at least one opening of the mask and onto the first primer film 44 to form the patterned feature. When the functional coating 20 is a double metal functional coating 22, the substrate 12 comprising the base layer 30, the metallic layer 40, the first primer layer 42, the second layer 50, the second metallic layer 60, the first primer film 44, and the second primer film 66 comprising the patterned feature may then be positioned under a second target comprising a material for forming the top layer 110 (e.g., a material for forming the first film 112 of the top layer 110). The material for forming the top layer 110 (e.g., the material for forming the first film 112 of the top layer 110), may then be applied over the first primer film 64 and the second primer film 66, such that the top layer 110 (e.g., the first film 112 of the top layer 110) is in direct contact with at least a portion of the first primer film 64 and is in direct contact with at least a portion of the second primer film 66. When the functional coating comprises three or more metallic layers (i.e., is a triple metal functional coating 23 or quadruple metal functional coating 24), the substrate 12 comprising the base layer 30, the metallic layer 40, the first primer layer 42, the second layer 50, the second metallic layer 60, the first primer film 44, and the second primer film 66 comprising the patterned feature may then be positioned under a second target comprising a material for forming the third layer 70 (e.g., a material for forming the first film 72 of the third layer 70). The material for forming the third layer 70 (e.g., the material for forming the first film 72 of the third layer 70) is then applied over the first primer film 64 and the second primer film 66 such that the third layer 70 (e.g., the first film 72 of the third layer 70) is in direct contact with at least a portion of the first primer film 64 and is in direct contact with at least a portion of the second primer film 66. The remaining layers of the functional coating 20 may then be applied.

To form the patterned feature in the first primer film 84 of the third primer layer 82, a mask may be positioned over at least a portion of the substrate 12 comprising the base layer 30, the metallic layer 40, the first primer layer 42, the second layer 50, the second metallic layer 60, the second primer layer 62, the third layer 70, and the third metallic layer 80. The mask may be in direct contact with at least a portion of the third metallic layer 80. The mask may be any of the masks described herein. The material for forming the first primer film 84 may then be applied through the at least one opening of the mask and onto the third metallic layer 80 to form the patterned feature. The mask may then be removed from the substrate 12. The second primer film 86 of the third primer layer 82 is then applied over the third metallic layer 80 and the first primer film 84 such that the second primer film 86 is in direct contact with at least a portion of the third metallic layer 80 and the first primer film 84.

To form the patterned feature in the second primer film 86 of the third primer layer 82, a mask may be applied over at least a portion of the substrate 12 comprising the base layer 30, the metallic layer 40, the first primer layer 42, the second layer 50, the second metallic layer 60, the second primer layer 62, the third layer 70, the third metallic layer 80, and the first primer film 84. The mask may be in direct contact with at least a portion of the first primer film 84. The mask may be any of the masks described herein. The material for forming the second primer film 86 may then be applied through the at least one opening of the mask and onto the first primer film 84 to form the patterned feature. The mask may then be removed from the substrate 12. When the functional coating 20 is triple metal functional coating 22, the top layer 110 (e.g., the first film 112 of the top layer 110) is applied over the first primer film 84 and the second primer film 86 such that the top layer 110 (e.g., the first film 112 of the top layer 110) is in direct contact with at least a portion of the first primer film 84 and is in direct contact with at least a portion of the second primer film 86. When the functional coating 20 comprises four or more metallic layers (i.e., is a quadruple metal functional coating 24), the fourth layer 90 (e.g., the first film 92 of the fourth layer 90) is then applied over the first primer film 84 and the second primer film 86 such that the fourth layer 90 (e.g., the first film 92 of the fourth layer 90) is in direct contact with at least a portion of the first primer film 84 and is in direct contact with at least a portion of the second primer film 86. The remaining layers of the functional coating 20 may then be applied.

Alternatively, to form the patterned feature in the first primer film 84 of the third primer layer 82, a mask may be positioned between the substrate 12 comprising the base layer 30, the metallic layer 40, the first primer layer 42, the second layer 50, the second metallic layer 60, the second primer layer 62, the third layer 70, and the third metallic layer 80 and a target comprising a material for forming the first primer film 84. The mask may be any of the masks described herein. The material for forming the first primer film 84 may then be applied through the at least one opening of the mask and onto the third metallic layer 30 to form the patterned feature. The substrate 12 comprising the base layer 30, the metallic layer 40, the first primer layer 42, the second layer 50, the second metallic layer 60, the second primer layer 62, the third layer 70, the third metallic layer 80, and the first primer film 84 comprising the patterned feature may then be positioned under a second target comprising a material for forming the second primer film 86. The material for forming the second primer film 86 of the third primer layer 82 is then applied over the third metallic layer 80 and the first primer film 84 such that the second primer film 86 is in direct contact with at least a portion of the third metallic layer 80 and the first primer film 84.

Alternatively, to form the patterned feature in the second primer film 86 of the third primer layer 82, a mask may be positioned between the substrate 12 comprising the base layer 30, the metallic layer 40, the first primer layer 42, the second layer 50, the second metallic layer 60, the second primer layer 62, the third layer 70, and the third metallic layer 80, and the first primer film 84 and a target comprising a material for forming the second primer film 86. The material for forming the second primer film 86 may then be applied through the at least one opening of the mask and onto the first primer film 84 to form the patterned feature. When the functional coating 20 is a triple metal functional coating 23, the substrate 12 comprising the base layer 30, the metallic layer 40, the first primer layer 42, the second layer 50, the second metallic layer 60, the second primer layer 62, the third layer 70, and the third metallic layer 80, the first primer film 84, and the second primer film 86 comprising the patterned feature may then be positioned under a second target comprising a material for forming the top layer 110 (e.g., a material for forming the first film 112 of the top layer 110). The material for forming the top layer 110 (e.g., the material for the first film 112 of the top layer 110), may then be applied over the first primer film 84 and the second primer film 86, such that the top layer 110 (e.g., the first film 112 of the top layer 110) is in direct contact with at least a portion of the first primer film 84 and is in direct contact with at least a portion of the second primer film 86. When the functional coating comprises four or more metallic layers (i.e., is a quadruple 24 metal functional coating), the substrate 12 comprising the base layer 30, the metallic layer 40, the first primer layer 42, the second layer 50, the second metallic layer 60, the second primer layer 62, the third layer 70, and the third metallic layer 80, the first primer film 84, and the second primer film 86 comprising the patterned feature may then be positioned under a second target comprising a material for forming the fourth layer 90 (e.g., a material for forming the first film 92 of the fourth layer 90). The material for forming the fourth layer 90 (e.g., the material for forming the first film 92 of the fourth layer 90) is then applied over the first primer film 84 and the second primer film 86 such that the fourth layer 90 (e.g., the first film 92 of the fourth layer 90) is in direct contact with at least a portion of the first primer film 84 and is in direct contact with at least a portion of the second primer film 86. The remaining layers of the functional coating 20 may then be applied.

To form the patterned feature in the first primer film 104 of the fourth primer layer 102, a mask may be positioned over at least a portion of the substrate 12 comprising the base layer 30, the metallic layer 40, the first primer layer 42, the second layer 50, the second metallic layer 60, the second primer layer 62, the third layer 70, the third metallic layer 80, the third primer layer 82, the fourth layer 90, and the fourth metallic layer 100. The mask may be in direct contact with at least a portion of the fourth metallic layer 100. The mask may be any of the mask described herein. The material for forming the first primer film 104 may be applied through the at least one opening of the mask and onto the fourth metallic layer 100 to form the patterned feature. The mask may then be removed from the substate 12. The second primer film 106 of the fourth primer layer 102 is then applied over the fourth metallic layer 100 and the first primer film 104 such that the second primer film 106 is in direct contact with at least a portion of the fourth metallic layer 100 and the first primer film 104.

To form the patterned feature in the second primer film 106 of the fourth primer layer 102, a mask may be positioned over at least a portion of the substrate 12 comprising the base layer 30, the metallic layer 40, the first primer layer 42, the second layer 50, the second metallic layer 60, the second primer layer 62, the third layer 70, the third metallic layer 80, the third primer layer 82, the fourth layer 90, the fourth metallic layer 100, and the first primer film 104. The mask may be in direct contact with at least a portion of the first primer film 104. The mask may be any of the masks described herein. The material for forming the second primer film 106 may then be applied through the at least one opening of the mask and onto the first primer film 104 to form the patterned feature. The mask may then be removed from the substrate 12. The top layer 110 (e.g., the first film 112 of the top layer 110) is applied over the first primer film 104 and the second primer film 106 such that the top layer 110 (e.g., the first film 112 of the top layer 110) is in direct contact with at least a portion of the first primer film 104 and is in direct contact with at least a portion of the second primer film 106. The remaining layers of the functional coating 20 may then be applied.

Alternatively, to form the patterned feature in the first primer film 104 of the fourth primer layer 102, a mask may be positioned between the substrate 12 comprising the base layer 30, the metallic layer 40, the first primer layer 42, the second layer 50, the second metallic layer 60, the second primer layer 62, the third layer 70, the third metallic layer 80, the third primer layer 82, the fourth layer 90, and the fourth metallic layer 100 and a target comprising a material for forming the first primer film 104. The mask may be any of the masks described herein. The material for forming the first primer film 104 may then be applied through the at least one opening of the mask and onto the fourth metallic layer 100 to form the patterned feature. The substrate 12 comprising the base layer 30, the metallic layer 40, the first primer layer 42, the second layer 50, the second metallic layer 60, the second primer layer 62, the third layer 70, the third metallic layer 80, the third primer layer 82, the fourth layer 90, the fourth metallic layer 100, and the first primer film 104 comprising the patterned feature may then be positioned under a second target comprising a material for forming the second primer film 106. The material for forming the second primer film 106 of the fourth primer layer 102 is then applied over the fourth metallic layer 100 and the first primer film 104 such that the second primer film 106 is in direct contact with at least a portion of the fourth metallic layer 100 and the first primer film 104.

Alternatively, to form the patterned feature in the second primer film 106 of the fourth primer layer 102, a mask may be positioned between the substrate 12 comprising the base layer 30, the metallic layer 40, the first primer layer 42, the second layer 50, the second metallic layer 60, the second primer layer 62, the third layer 70, the third metallic layer 80, the third primer layer 82, the fourth layer 90, the fourth metallic layer 100, and the first primer film 104 and a target comprising a material for forming the second primer film 106. The mask may be any of the masks described herein. The material for forming the second primer film 106 may then be applied through the at least one opening of the mask and onto the first primer film 104 to form the patterned feature. The substrate 12 comprising the base layer 30, the metallic layer 40, the first primer layer 42, the second layer 50, the second metallic layer 60, the second primer layer 62, the third layer 70, the third metallic layer 80, the third primer layer 82, the fourth layer 90, the fourth metallic layer 100, the first primer film 104, and the second primer film 106 comprising the patterned feature may then be positioned under a second target comprising a material for forming the top layer 110 (e.g., a material for forming the first film 112 of the top layer 110). The material for forming the top layer 110 (e.g., the material for the first film 112 of the top layer 110), may then be applied over the first primer film 104 and the second primer film 106, such that the top layer 110 (e.g., the first film 112 of the top layer 110) is in direct contact with at least a portion of the first primer film 104 and is in direct contact with at least a portion of the second primer film 106.

The coated articles described herein can be used in an architectural transparency or architectural glazing, such as, but not limited to, an insulating glass unit. A non-limiting insulating glass unit 200 incorporating the features of the invention is provided in FIG. 13. The insulating glass unit 200 includes a first ply 212 comprising a first side comprising a No. 1 surface 214 and second side comprising a No. 2 surface 216, where the No. 2 surface 216 is opposite the No. 1 surface 214. In the illustrated non-limiting embodiment, the first major surface 214 faces the building exterior, i.e., is an outer major surface, and the second major surface 216 faces the interior of the building. The insulated glass unit 200 also includes a second ply 218 comprising a first side comprising a No. 3 surface 220 and a second side comprising a No. 4 surface 222, where the No. 4 surface is opposite the No. 3 surface 220. The second ply 18 is spaced from the first ply 12. In some embodiments, the insulating glass unit 200 includes a third ply with a first side and a second side. The first side of the third ply comprises a first major surface (No. 5 surface) and an opposed second side of the third ply comprises a second major surface (No. 6 surface). This numbering of the ply surfaces is in keeping with conventional practice in the fenestration art. The plies 212, 218 can have any desired visible light, infrared radiation, or ultraviolet radiation transmission and/or reflection. For example, the plies 212, 128 can have a visible light transmission of any desired amount, e.g., greater than 0% up to 100%. The plies 212, 218 can each be, for example, clear float glass or can be tinted or colored glass or one ply 212, 218 can be clear glass and the other ply 212, 218 colored glass. Although not limiting to the invention, examples of glass suitable for the first ply 212 and/or second ply 218 are described in U.S. Pat. Nos. 4,746,347; 4,792,536; 5,030,593; 5,030,594; 5,240,886; 5,385,872; and 5,393,593, which are incorporated herein by reference. Examples of insulating glass units are found, for example, in U.S. Pat. Nos. 4,193,236; 4,464,874; 5,088,258; and 5,106,663, which are incorporated herein by reference.

The first ply 212 and second ply 218 are connected together in any suitable manner, such as, by being adhesively bonded to a conventional spacer frame 224. A gap or chamber 226 is formed between the first ply 212 and the second ply 218. The chamber 226 can be filled with a selected atmosphere, such as, air, or a non-reactive gas such as, argon or krypton gas.

A functional coating 20 (or any of the other coatings described herein) is positioned over at least a portion of the second side comprising the No. 2 surface 216 of the first ply 212. The functional coating 20 may comprise, consist essentially of, or consist of any of the functional coatings described herein. The functional coating 20 is not over at least a portion of the first side comprising the No. 1 surface 214 of the first ply 212. The functional coating 20 is not over at least a portion of the first side comprising the No. 3 surface 220 of the second ply 218. The functional coating 210 is not over at least a portion of the second side comprising the No. 4 surface 222 of the second ply 218.

When the functional coating 20 includes one metallic layer (i.e., a single metal functional coating 21), the patterned feature is formed in the first primer layer 42. The patterned feature may be formed in the first primer film 44 (FIG. 2A) or the second primer film 46 (FIG. 2B).

When the functional coating 20 comprises two metallic layers (i.e., a double metal functional coating 22), the patterned feature may be formed in one of the first primer layer 42 (FIG. 3A-3B) or the second primer layer 62 (FIGS. 3C-3D). The patterned feature may be formed in the first primer film 44 of the first primer layer 42 (FIG. 3A), the second primer film 46 of the first primer layer 42 (FIG. 3B), the first primer film 64 of the second primer layer 62 (FIG. 3C), or the second primer film 66 of the second primer layer 62 (FIG. 3D).

When the functional coating 20 comprises three metallic layers (i.e., a triple metal functional coating 23), the patterned feature may be formed in one of the first primer layer 42 (FIGS. 4A-4B), the second primer layer 62 (FIGS. 4C-4D), or the third primer layer 82 (FIGS. 4E-4F). The patterned feature may be formed in the first primer film 44 of the first primer layer 42 (FIG. 4A), the second primer film 46 of the first primer layer 42 (FIG. 4B), the first primer film 64 of the second primer layer 62 (FIG. 4C), the second primer film 66 of the second primer layer 62 (FIG. 4D), the first primer film 84 of the third primer layer 82 (FIG. 4E), or the second primer film 86 of the third primer layer 82 (FIG. 4F).

When the functional coating 20 comprises four metallic layers (i.e., a quadruple metal functional coating 24), the patterned feature may be formed in one of the first primer layer 42 (FIGS. 5A-5B), the second primer layer 62 (FIGS. 5C-5D), the third primer layer 82 (FIGS. 5E-5F), or the fourth primer layer 102 (FIGS. 5G-5H). The patterned feature may be formed in the first primer film 44 of the first primer layer 42 (FIG. 5A), the second primer film 46 of the first primer layer 42 (FIG. 5B), the first primer film 64 of the second primer layer 62 (FIG. 5C), the second primer film 66 of the second primer layer 62 (FIG. 5D), the first primer film 84 of the third primer layer 82 (FIG. 5E), the second primer film 86 of the third primer layer 82 (FIG. 5F), the first primer film 104 of the fourth primer layer 102 (FIG. 5G), or the second primer film 106 of the fourth primer film (FIG. 5H).

The following numbered clauses are illustrative of various aspects of the invention:

Clause 1: A coated article comprising: a substrate comprising a first side comprising a first surface and a second side comprising a second surface, wherein the second surface is opposite the first surface; and a functional coating positioned over at least a portion of the second side, the functional coating comprising: a base layer positioned over at least a portion of the second surface; a metallic layer positioned over at least a portion of the base layer; a primer layer comprising a patterned feature positioned over at least a portion of the metallic layer, wherein the primer layer comprises: a first primer film positioned over at least a portion of the metallic layer, and a second primer film positioned over at least a portion of the first primer film, wherein one of the first primer film or the second primer film comprises the patterned feature; and a top layer positioned over at least a portion of the primer layer.

Clause 2: The coated article of clause 1, wherein the coated article is temperable.

Clause 3: The coated article of clause 1 or 2, wherein the first primer film is selected from the group consisting of titanium, silicon, tin, silicon dioxide, silicon nitride, silicon oxynitride, nickel, zirconium, zinc, aluminum, cobalt, chromium, alloys thereof, and mixtures thereof.

Clause 4: The coated article of clause 1 or 2, wherein the second primer film is selected from the group consisting of titanium, silicon, tin, silicon dioxide, silicon nitride, silicon oxynitride, nickel, zirconium, zinc, aluminum, cobalt, chromium, alloys thereof, and mixtures thereof.

Clause 5: The coated article of any one of clauses 1 to 4, wherein when the first primer film comprises the patterned feature, the patterned feature of the first primer film comprises a thickness in a range of from 1 nm to 20 nm, such as from 1 nm to 15 nm, such as from 1 nm to 10 nm, or such as from 1 nm to 8 nm and the second primer film comprises a thickness in a range of from 0.5 nm to 8 nm, such as from 0.5 nm to 7 nm, or such as from 1 nm to 6 nm.

Clause 6: The coated article of any one of clauses 1 to 4, wherein when the second primer film comprises the patterned feature, the first primer film comprises a thickness in a range of from 0.5 nm to 10 nm, such as from 0.5 nm to 8 nm, or such as from 1 nm to 6 nm and the patterned feature of the second primer film comprises a thickness in the range of from 1 nm to 20 nm, such as from 1 nm to 15 nm, such as from 1 nm to 10 nm, or such as from 1 nm to 8 nm.

Clause 7: The coated article of any one of clauses 1 to 6, wherein the first primer film comprises titanium and the second primer film comprises aluminum zinc.

Clause 8: The coated article of any one of claims 1 to 6, wherein the first primer film comprises titanium and the second primer film comprises tin.

Clause 9: The coated article of any one of claims 1 to 6, wherein the first primer film comprises titanium and the second primer film comprises nickel chromium.

Clause 10: The coated article of any one of clauses 1 to 9, wherein the patterned feature is a symmetric feature comprising stripes.

Clause 11: The coated article of clause 10, wherein the stripes comprise a width of at least 0.1 inch.

Clause 12: The coated article of clause 10 or 11, wherein the stripes are spaced apart from one another by at least 1.5 inches.

Clause 13: The coated article of any of clauses 10 to 12, wherein the stripes are positioned horizontally, vertically, or diagonally across the second surface.

Clause 14: The coated article of clause 13, wherein the stripes are positioned horizontally across the second surface.

Clause 15: The coated article of clause 13, wherein the stripes are positioned vertically across the second surface.

Clause 16: The coated article of any one of clauses 1 to 9, wherein the patterned feature is an asymmetric pattern.

Clause 17: The coated article of any one of clauses 1 to 16, wherein the base layer comprises a first film positioned over at least a portion of the second surface and a second film over at least a portion of the first film.

Clause 18: The coated article of clause 17, wherein the first film comprises zinc stannate, silicon nitride, silicon oxide, silicon aluminum nitride, silicon aluminum oxide, silicon oxynitride, silicon aluminum oxynitride, or tin oxide and the second film comprises zinc oxide or aluminum zinc oxide.

Clause 19: The coated article of clause 17, wherein the base layer further comprises a third film over at least a portion of the second film, wherein the first film comprises zinc stannate, silicon nitride, silicon oxide, silicon aluminum nitride, silicon aluminum oxide, silicon oxynitride, silicon aluminum oxynitride, or tin oxide, the second film comprises zinc stannate, and the third film comprises zinc oxide or aluminum zinc oxide.

Clause 20: The coated article of any of clauses 1 to 19, wherein the metallic layer comprises silver, gold, palladium, copper, alloys thereof, mixtures thereof, or combinations thereof.

Clause 21: The coated article of any of clauses 1 to 20, wherein the metallic layer comprises silver.

Clause 22: The coated article of any of clauses 1 to 21, wherein the top layer comprises a first film over at least a portion of the primer layer and a second film over at least a portion of the first film.

Clause 23: The coated article of clause 22, wherein the first film comprises zinc oxide.

Clause 24: The coated article of clause 22, wherein the second film comprises zinc stannate or tin oxide.

Clause 25: The coated article of any of clauses 1 to 24, wherein the functional coating further comprises an outermost protective coating comprising a protective layer, wherein the protective layer comprises at least one of Si₃N₄, SiAlN, SiAlON, SiAlO, TiAlO, titania, alumina, silica, zirconia, or combinations thereof.

Clause 26: The coated article of clause 25, wherein the protective layer comprises titania.

Clause 27: The coated article of clause 25, wherein the protective layer comprises a first protective film and a second protective film, wherein the second protective film is positioned over at least a portion of the first protective film.

Clause 28: The coated article of clause 27, wherein the first protective film comprises SiAlO.

Clause 29: The coated article of clause 27, wherein the second protective film comprises TiAlO.

Clause 30: The coated article of any of clauses 1 to 29, wherein the substrate comprises glass.

Clause 31: The coated article of any of clauses 1 to 30, wherein the coated article is an architectural glazing.

Clause 32: The coated article of any of clauses 1 to 31, wherein the patterned feature is visible to birds.

Clause 33: The coated article of any of clauses 1 to 32, wherein the functional coating positioned over at least a portion of the second side comprises: the base layer positioned over at least a portion of the second surface; a first metallic layer positioned over at least a portion of the base layer; a first primer layer positioned over at least a portion of the first metallic layer; a second layer over at least a portion of the first primer layer; a second metallic layer over at least a portion of the second layer; and a second primer layer over at least a portion of the second metallic layer, wherein the top layer is over at least a portion of the second primer layer, wherein one of the first primer layer or the second primer layer comprises the patterned feature, the first primer film, and the second primer film, and wherein one of the first primer film or the second primer film comprises the patterned feature.

Clause 34: The coated article of clause 33, wherein the patterned feature is formed in the first primer layer positioned over at least a portion of the first metallic layer, wherein the first primer layer comprises the first primer film positioned over at least a portion of the first metallic layer and the second primer film positioned over at least a portion of the first primer film.

Clause 35: The coated article of clause 34, wherein the first primer film is selected from the group consisting of titanium, silicon, tin, silicon dioxide, silicon nitride, silicon oxynitride, nickel, zirconium, zinc, aluminum, cobalt, chromium, alloys thereof, and mixtures thereof.

Clause 36: The coated article of clause 34, wherein the second primer film is selected from the group consisting of titanium, silicon, tin, silicon dioxide, silicon nitride, silicon oxynitride, nickel, zirconium, zinc, aluminum, cobalt, chromium, alloys thereof, and mixtures thereof.

Clause 37: The coated article of any one of clauses 34 to 36, wherein when the first primer film comprises the patterned feature, the patterned feature of the first primer film comprises a thickness in the range of from 1 nm to 20 nm, such as from 1 nm to 15 nm, such as from 1 nm to 10 nm, or such as from 1 nm to 8 nm and the second primer film comprises a thickness in a range of from 0.5 nm to 10 nm, such as from 0.5 nm to 8 nm, or such as from 1 nm to 6 nm.

Clause 38: The coated article of any one of clauses 34 to 36, wherein when the second primer film comprises the patterned feature, the first primer film comprises a thickness in a range of from 0.5 nm to 10 nm, such as from 0.5 nm to 8 nm, or such as from 1 nm to 6 nm and the patterned feature of the second primer film comprises a thickness in the range of from 1 nm to 20 nm, such as from 1 nm to 15 nm, such as from 1 nm to 10 nm, or such as from 1 nm to 8 nm.

Clause 39: The coated article of any one of clauses 34 to 38, wherein the first primer film comprises titanium and the second primer film comprises aluminum zinc.

Clause 40: The coated article of any one of clauses 34 to 38, wherein the first primer film comprises titanium and the second primer film comprises tin.

Clause 41: The coated article of any one of clauses 34 to 38, wherein the first primer film comprises titanium and the second primer film comprises nickel chromium.

Clause 42: The coated article of any one of clauses 34 to 41, wherein the patterned feature is a symmetric feature comprising stripes.

Clause 43: The coated article of clause 42, wherein the stripes comprise a width of at least 0.1 inch.

Clause 44: The coated article of clause 42 or 43, wherein the stripes are spaced apart from one another by at least 1.5 inches.

Clause 45: The coated article of any of clauses 42 to 44, wherein the stripes are positioned horizontally, vertically, or diagonally across the second surface.

Clause 46: The coated article of clause 45, wherein the stripes are positioned horizontally across the second surface.

Clause 47: The coated article of clause 45, wherein the stripes are positioned vertically across the second surface.

Clause 48: The coated article of any one of clauses 34 to 41, wherein the patterned feature is an asymmetric pattern.

Clause 49: The coated article of clause 33, wherein the patterned feature is formed in the second primer layer positioned over at least a portion of the second metallic layer, wherein the second primer layer comprises the first primer film positioned over at least a portion of the second metallic layer and the second primer film positioned over at least a portion of the first primer film.

Clause 50: The coated article of clause 49, wherein the first primer film is selected from the group consisting of titanium, silicon, tin, silicon dioxide, silicon nitride, silicon oxynitride, nickel, zirconium, zinc, aluminum, cobalt, chromium, alloys thereof, and mixtures thereof.

Clause 51: The coated article of any one of clause 49, wherein the second primer film is selected from the group consisting of titanium, silicon, tin, silicon dioxide, silicon nitride, silicon oxynitride, nickel, zirconium, zinc, aluminum, cobalt, chromium, alloys thereof, and mixtures thereof.

Clause 52: The coated article of any one of clauses 49 to 51, wherein when the first primer film comprises the patterned feature, the patterned feature of the first primer film comprises a thickness in a range of from 1 nm to 20 nm, such as from 1 nm to 15 nm, such as from 1 nm to 10 nm, or such as from 1 nm to 8 nm and the second primer film comprises from 0.5 nm to 10 nm, such as from 0.5 nm to 8 nm, or such as from 1 nm to 6 nm.

Clause 53: The coated article of any one of clauses 49 to 51, wherein when the second primer film comprises the patterned feature, the first primer film comprises a thickness in a range of from 0.5 nm to 10 nm, such as from 0.5 nm to 8 nm, or such as from 1 nm to 6 nm and the patterned feature of the second primer film comprises a thickness in the range of from 1 nm to 20 nm, such as from 1 nm to 15 nm, such as from 1 nm to 10 nm, or such as from 1 nm to 8 nm.

Clause 54: The coated article of any one of clauses 49 to 53, wherein the first primer film comprises titanium and the second primer film comprises aluminum zinc.

Clause 55: The coated article of any one of clauses 49 to 53, wherein the first primer film comprises titanium and the second primer film comprises tin.

Clause 56: The coated article of any one of clauses 49 to 53, wherein the first primer film comprises titanium and the second primer film comprises nickel chromium.

Clause 57: The coated article of any one of clauses 49 to 56, wherein the patterned feature is a symmetric feature comprising stripes.

Clause 58: The coated article of clause 57, wherein the stripes comprise a width of at least 0.1 inch.

Clause 59: The coated article of clause 57 or 58, wherein the stripes are spaced apart from one another by at least 2 inches.

Clause 60: The coated article of any of clauses 57 to 59, wherein the stripes are positioned horizontally, vertically, or diagonally across the second surface.

Clause 61: The coated article of clause 60, wherein the stripes are positioned horizontally across the second surface.

Clause 62: The coated article of clause 60, wherein the stripes are positioned vertically across the second surface.

Clause 63: The coated article of any one of clauses 49 to 56, wherein the patterned feature is an asymmetric pattern.

Clause 64: The coated article of any one of clauses 33 to 63, wherein the second layer comprises a first film over at least a portion of the first primer layer, a second film over at least a portion of the first film, and a third film over at least a portion of the second film, wherein the first film comprises zinc oxide, the second film comprises zinc stannate, and the third film comprises zinc oxide.

Clause 65: The coated article of any of clauses 33 to 64, wherein the first metallic layer and the second metallic layer each independently comprise silver, gold, palladium, copper, alloys thereof, mixtures thereof, or combinations thereof.

Clause 66: The coated article of any of clauses 33 to 65, wherein the first metallic layer and the second metallic layer comprise silver.

Clause 67: The coated article of any of clauses 33 to 66, wherein the second metallic layer is a continuous layer.

Clause 68: The coated article of any of clauses 33 to 66, wherein the second metallic layer is a discontinuous layer.

Clause 69: The coated article of any one of clauses 1 to 32, wherein the functional coating positioned over at least a portion of the second side comprises: the base layer positioned over a least a portion of the second surface; a first metallic layer positioned over at least a portion of the base layer; a first primer layer positioned over at least a portion of the first metallic layer; a second layer positioned over at least a portion of the first primer layer; a second metallic layer positioned over at least a portion of the second layer; a second primer layer positioned over at least a portion of the second metallic layer; a third layer positioned over at least a portion of the second primer layer; a third metallic layer positioned over at least a portion of the third layer; and a third primer layer positioned over at least a portion of the third metallic layer, wherein the top layer is over at least a portion of the third primer layer, wherein one of the first primer layer, the second primer layer, or the third primer layer comprises the patterned feature, the first primer film, and the second primer film, and wherein one of the first primer film or the second primer film comprises the patterned feature.

Clause 70: The coated article of clause 69, wherein the patterned feature is formed in the first primer layer positioned over at least a portion of the first metallic layer, wherein the first primer layer comprises the first primer film positioned over at least a portion of the first metallic layer and the second primer film positioned over at least a portion of the first primer film.

Clause 71: The coated article of clause 70, wherein the first primer film is selected from the group consisting of titanium, silicon, tin, silicon dioxide, silicon nitride, silicon oxynitride, nickel, zirconium, zinc, aluminum, cobalt, chromium, alloys thereof, and mixtures thereof.

Clause 72: The coated article of clause 70, wherein the second primer film is selected from the group consisting of titanium, silicon, tin, silicon dioxide, silicon nitride, silicon oxynitride, nickel, zirconium, zinc, aluminum, cobalt, chromium, alloys thereof, and mixtures thereof.

Clause 73: The coated article of any one of clauses 70 to 72, wherein when the first primer film comprises the patterned feature, the patterned feature of the first primer film comprises a thickness in a range of from 1 nm to 20 nm, such as from 1 nm to 15 nm, such as from 1 nm to 10 nm, or such as from 1 nm to 8 nm and the second primer film comprises a thickness in a range of from 0.5 nm to 10 nm, such as from 0.5 nm to 8 nm, or such as from 1 nm to 6 nm.

Clause 74: The coated article of any one of clauses 70 to 72, wherein when the second primer film comprises the patterned feature, the first primer film comprises a thickness in a range of from 0.5 nm to 10 nm, such as from 0.5 nm to 8 nm, or such as from 1 nm to 6 nm and the patterned feature of the second primer film comprises a thickness in the range of from 1 nm to 20 nm, such as from 1 nm to 15 nm, such as from 1 nm to 10 nm, or such as from 1 nm to 8 nm.

Clause 75: The coated article of any one of clauses 70 to 74, wherein the first primer film comprises titanium and the second primer film comprises aluminum zinc.

Clause 76: The coated article of any one of clauses 70 to 74, wherein the first primer film comprises titanium and the second primer film comprises tin.

Clause 77: The coated article of any one of clauses 70 to 74, wherein the first primer film comprises titanium and the second primer film comprises nickel chromium.

Clause 78: The coated article of any one of clauses 70 to 77, wherein the patterned feature is a symmetric feature comprising stripes.

Clause 79: The coated article of clause 78, wherein the stripes comprise a width of at least 0.1 inch.

Clause 80: The coated article of clause 78 or 79, wherein the stripes are spaced apart from one another by at least 1.5 inches.

Clause 81: The coated article of any of clauses 78 to 80, wherein the stripes are positioned horizontally, vertically, or diagonally across the second surface.

Clause 82: The coated article of clause 81, wherein the stripes are positioned horizontally across the second surface.

Clause 83: The coated article of clause 81, wherein the stripes are positioned vertically across the second surface.

Clause 84: The coated article of any one of clauses 70 to 77, wherein the patterned feature is an asymmetric pattern.

Clause 85: The coated article of clause 69, wherein the patterned feature is formed in the second primer layer positioned over at least a portion of the second metallic layer, wherein the second primer layer comprises the first primer film positioned over at least a portion of the second metallic layer and the second primer film positioned over at least a portion of the first primer film.

Clause 86: The coated article of clause 85, wherein the first primer film is selected from the group consisting of titanium, silicon, tin, silicon dioxide, silicon nitride, silicon oxynitride, nickel, zirconium, zinc, aluminum, cobalt, chromium, alloys thereof, and mixtures thereof.

Clause 87: The coated article of clause 85, wherein the second primer film is selected from the group consisting of titanium, silicon, tin, silicon dioxide, silicon nitride, silicon oxynitride, nickel, zirconium, zinc, aluminum, cobalt, chromium, alloys thereof, and mixtures thereof.

Clause 88: The coated article of any one of clauses 85 to 87, wherein when the first primer film comprises the patterned feature, the patterned feature of the first primer film comprises a thickness in a range of from 1 nm to 20 nm, such as from 1 nm to 15 nm, such as from 1 nm to 10 nm, or such as from 1 nm to 8 nm and the second primer film comprises a thickness in a range of from 0.5 nm to 10 nm, such as from 0.5 nm to 8 nm, or such as from 1 nm to 6 nm.

Clause 89: The coated article of any one of clauses 85 to 87, wherein when the second primer film comprises the patterned feature, the first primer film comprises a thickness in a range of from 0.5 nm to 10 nm, such as from 0.5 nm to 8 nm, or such as from 1 nm to 6 nm and the patterned feature of the second primer film comprises a thickness in the range of from 1 nm to 20 nm, such as from 1 nm to 15 nm, such as from 1 nm to 10 nm, or such as from 1 nm to 8 nm.

Clause 90: The coated article of any one of clauses 85 to 89, wherein the first primer film comprises titanium and the second primer film comprises aluminum zinc.

Clause 91: The coated article of any one of clauses 85 to 89, wherein the first primer film comprises titanium and the second primer film comprises tin.

Clause 92: The coated article of any one of clauses 85 to 89, wherein the first primer film comprises titanium and the second primer film comprises nickel chromium.

Clause 93: The coated article of any one of clauses 85 to 92, wherein the patterned feature is a symmetric feature comprising stripes.

Clause 94: The coated article of clause 93, wherein the stripes comprise a width of at least 0.1 inch.

Clause 95: The coated article of clause 93 or 94, wherein the stripes are spaced apart from one another by at least 1.5 inches.

Clause 96: The coated article of any of clauses 93 to 95, wherein the stripes are positioned horizontally, vertically, or diagonally across the second surface.

Clause 97: The coated article of clause 96, wherein the stripes are positioned horizontally across the second surface.

Clause 98: The coated article of clause 96, wherein the stripes are positioned vertically across the second surface.

Clause 99: The coated article of any one of clauses 85 to 92, wherein the patterned feature is an asymmetric pattern.

Clause 100: The coated article of clause 69, wherein the patterned feature is formed in the third primer layer positioned over at least a portion of the third metallic layer, wherein the third primer layer comprises the first primer film positioned over at least a portion of the third metallic layer and the second primer film positioned over at least a portion of the first primer film.

Clause 101: The coated article of clause 100, wherein the first primer film is selected from the group consisting of titanium, silicon, tin, silicon dioxide, silicon nitride, silicon oxynitride, nickel, zirconium, zinc, aluminum, cobalt, chromium, alloys thereof, and mixtures thereof.

Clause 102: The coated article of clause 100, wherein the second primer film is selected from the group consisting of titanium, silicon, tin, silicon dioxide, silicon nitride, silicon oxynitride, nickel, zirconium, zinc, aluminum, cobalt, chromium, alloys thereof, and mixtures thereof.

Clause 103: The coated article of any one of clauses 100 to 102, wherein when the first primer film comprises the patterned feature, the patterned feature of the first primer film comprises a thickness in a range of from 1 nm to 20 nm, such as from 1 nm to 15 nm, such as from 1 nm to 10 nm, or such as from 1 nm to 8 nm and the second primer film comprises a thickness in range of from 0.5 nm to 10 nm, such as from 0.5 nm to 8 nm, or such as from 1 nm to 6 nm.

Clause 104: The coated article of any one of clauses 100 to 102, wherein when the second primer film comprises the patterned feature, the first primer film comprises a thickness in range of from 0.5 nm to 10 nm, such as from 0.5 nm to 8 nm, or such as from 1 nm to 6 nm and the patterned feature of the second primer film comprises a thickness in the range of from 1 nm to 20 nm, such as from 1 nm to 15 nm, such as from 1 nm to 10 nm, or such as from 1 nm to 8 nm.

Clause 105: The coated article of any one of clauses 100 to 104, wherein the first primer film comprises titanium and the second primer film comprises aluminum zinc.

Clause 106: The coated article of any one of clauses 100 to 104, wherein the first primer film comprises titanium and the second primer film comprises tin.

Clause 107: The coated article of any one of clauses 100 to 104, wherein the first primer film comprises titanium and the second primer film comprises nickel chromium.

Clause 108: The coated article of any one of clauses 100 to 107, wherein the patterned feature is a symmetric feature comprising stripes.

Clause 109: The coated article of clause 108, wherein the stripes comprise a width of at least 0.1 inch.

Clause 110: The coated article of clause 108 or 109, wherein the stripes are spaced apart from one another by at least 1.5 inches.

Clause 111: The coated article of any of clauses 108 to 110, wherein the stripes are positioned horizontally, vertically, or diagonally across the second surface.

Clause 112: The coated article of clause 111, wherein the stripes are positioned horizontally across the second surface.

Clause 113: The coated article of clause 111, wherein the stripes are positioned vertically across the second surface.

Clause 114: The coated article of any one of clauses 100 to 107, wherein the patterned feature is an asymmetric pattern.

Clause 115: The coated article of any one of clauses 69 to 114, wherein the second layer comprises a first film positioned over at least a portion of the first primer layer, a second film positioned over at least a portion of the first film, and a third film positioned over at least a portion of the second film, wherein the first film comprises zinc oxide, the second film comprises zinc stannate, and the third film comprises zinc oxide.

Clause 116: The coated article of any one of clauses 69 to 115, wherein the third layer comprises a first film positioned over at least a portion of the second primer layer, a second film positioned over at least a portion of the first film, and a third film positioned over at least a portion of the second film, wherein the first film comprises zinc oxide, the second film comprises zinc stannate, and the third film comprises zinc oxide.

Clause 117: The coated article of any one of clauses 69 to 116, wherein the first metallic layer, the second metallic layer, and the third metallic layer each independently comprise silver, gold, palladium, copper, alloys thereof, mixtures thereof, or combinations thereof.

Clause 118: The coated article of any one of clauses 69 to 117, wherein the first metallic layer is a continuous metallic layer.

Clause 119: The coated article of any one of clauses 69 to 118, wherein the second metallic layer is a continuous metallic layer.

Clause 120: The coated article of any one of clauses 69 to 118, wherein the second metallic layer is a discontinuous metallic layer.

Clause 121: The coated article of any one of clauses 69 to 120, wherein the third metallic layer is a continuous metallic layer.

Clause 122: The coated article of any one of clauses 69 to 120, wherein the third metallic layer is a discontinuous metallic layer.

Clause 123: The coated article of any one of clauses 1 to 32, wherein the functional coating positioned over at least a portion of the second side comprises: the base layer positioned over at least a portion of the second surface; a first metallic layer positioned over at least a portion of the base layer; a first primer layer positioned over at least a portion of the first metallic layer; a second layer positioned over at least a portion of the first primer layer; a second metallic layer positioned over at least a portion of the second layer; a second primer layer positioned over at least a portion of the second metallic layer; a third layer positioned over at least a portion of the second primer layer; a third metallic layer positioned over at least a portion of the third layer; a third primer layer positioned over at least a portion of the third metallic layer; a fourth layer positioned over at least a portion of the third primer layer; a fourth metallic layer positioned over at least a portion of the fourth layer; and a fourth primer layer positioned over at least a portion of the fourth metallic layer, wherein the top layer is over at least a portion of the fourth primer layer, wherein one of the first primer layer, the second primer layer, the third primer layer, or the fourth primer layer comprises the patterned feature, the first primer film, and the second primer film, and wherein one of the first primer film or the second primer film comprises the patterned feature.

Clause 124: The coated article of clause 123, wherein the patterned feature is formed in the first primer layer positioned over at least a portion of the first metallic layer, wherein the first primer layer comprises the first primer film positioned over at least a portion of the first metallic layer and the second primer film positioned over at least a portion of the first primer film.

Clause 125: The coated article of clause 124, wherein the first primer film is selected from the group consisting of titanium, silicon, tin, silicon dioxide, silicon nitride, silicon oxynitride, nickel, zirconium, zinc, aluminum, cobalt, chromium, alloys thereof, and mixtures thereof.

Clause 126: The coated article of clause 124, wherein the second primer film is selected from the group consisting of titanium, silicon, tin, silicon dioxide, silicon nitride, silicon oxynitride, nickel, zirconium, zinc, aluminum, cobalt, chromium, alloys thereof, and mixtures thereof.

Clause 127: The coated article of any one of clauses 124 to 126, wherein when the first primer film comprises the patterned feature, the patterned feature of the first primer film comprises a thickness in a range of from 1 nm to 20 nm, such as from 1 nm to 15 nm, such as from 1 nm to 10 nm, or such as from 1 nm to 8 nm and the second primer film comprises a thickness in a range of from 0.5 nm to 10 nm, such as from 0.5 nm to 8 nm, or such as from 1 nm to 6 nm.

Clause 128: The coated article of any one of clauses 124 to 126, wherein when the second primer film comprises the patterned feature, the first primer film comprises a thickness in a range of from 0.5 nm to 10 nm, such as from 0.5 nm to 8 nm, or such as from 1 nm to 6 nm and the patterned feature of the second primer film comprises a thickness in the range of from 1 nm to 20 nm, such as from 1 nm to 15 nm, such as from 1 nm to 10 nm, or such as from 1 nm to 8 nm.

Clause 129: The coated article of any one of clauses 124 to 128, wherein the first primer film comprises titanium and the second primer film comprises aluminum zinc.

Clause 130: The coated article of any one of clauses 124 to 128, wherein the first primer film comprises titanium and the second primer film comprises tin.

Clause 131: The coated article of any one of clauses 124 to 128, wherein the first primer film comprises titanium and the second primer film comprises nickel chromium.

Clause 132: The coated article of any one of clauses 124 to 131, wherein the patterned feature is a symmetric feature comprising stripes.

Clause 133: The coated article of clause 132, wherein the stripes comprise a width of at least 0.1 inch.

Clause 134: The coated article of clause 132 or 133, wherein the stripes are spaced apart from one another by at least 1.5 inches.

Clause 135: The coated article of any of clauses 132 to 134, wherein the stripes are positioned horizontally, vertically, or diagonally across the second surface.

Clause 136: The coated article of clause 135, wherein the stripes are positioned horizontally across the second surface.

Clause 137: The coated article of clause 135, wherein the stripes are positioned vertically across the second surface.

Clause 138: The coated article of any one of clauses 124 to 131, wherein the patterned feature is an asymmetric pattern.

Clause 139: The coated article of clause 123, wherein the patterned feature is formed in the second primer layer positioned over at least a portion of the second metallic layer, wherein the second primer layer comprises the first primer film positioned over at least a portion of the second metallic layer and the second primer film positioned over at least a portion of the first primer film.

Clause 140: The coated article of clause 139, wherein the first primer film is selected from the group consisting of titanium, silicon, tin, silicon dioxide, silicon nitride, silicon oxynitride, nickel, zirconium, zinc, aluminum, cobalt, chromium, alloys thereof, and mixtures thereof.

Clause 141: The coated article of clause 139, wherein the second primer film is selected from the group consisting of titanium, silicon, tin, silicon dioxide, silicon nitride, silicon oxynitride, nickel, zirconium, zinc, aluminum, cobalt, chromium, alloys thereof, and mixtures thereof.

Clause 142: The coated article of any one of clauses 139 to 141, wherein when the first primer film comprises the patterned feature, the patterned feature of the first primer film comprises a thickness in a range of from 1 nm to 20 nm, such as from 1 nm to 15 nm, such as from 1 nm to 10 nm, or such as from 1 nm to 8 nm and the second primer film comprises a thickness in a range of from 0.5 nm to 10 nm, such as from 0.5 nm to 8 nm, or such as from 1 nm to 6 nm.

Clause 143: The coated article of any one of clauses 139 to 141, wherein when the second primer film comprises the patterned feature, the first primer film comprises a thickness in a range of from 0.5 nm to 10 nm, such as from 0.5 nm to 8 nm, or such as from 1 nm to 6 nm and the patterned feature of the second primer film comprises a thickness in the range of from 1 nm to 20 nm, such as from 1 nm to 15 nm, such as from 1 nm to 10 nm, or such as from 1 nm to 8 nm.

Clause 144: The coated article of any one of clauses 139 to 143, wherein the first primer film comprises titanium and the second primer film comprises aluminum zinc.

Clause 145: The coated article of any one of clauses 139 to 143, wherein the first primer film comprises titanium and the second primer film comprises tin.

Clause 146: The coated article of any one of clauses 139 to 143, wherein the first primer film comprises titanium and the second primer film comprises nickel chromium.

Clause 147: The coated article of any one of clauses 139 to 146, wherein the patterned feature is a symmetric feature comprising stripes.

Clause 148: The coated article of clause 147, wherein the stripes comprise a width of at least 0.1 inch.

Clause 149: The coated article of clause 147 or 148, wherein the stripes are spaced apart from one another by at least 1.5 inches.

Clause 150: The coated article of any of clauses 147 to 149, wherein the stripes are positioned horizontally, vertically, or diagonally across the second surface.

Clause 151: The coated article of clause 150, wherein the stripes are positioned horizontally across the second surface.

Clause 152: The coated article of clause 150, wherein the stripes are positioned vertically across the second surface.

Clause 153: The coated article of any one of clauses 139 to 146, wherein the patterned feature is an asymmetric pattern.

Clause 154: The coated article of clause 123, wherein the patterned feature is formed in the third primer layer positioned over at least a portion of the third metallic layer, wherein the third primer layer comprises the first primer film positioned over at least a portion of the third metallic layer and the second primer film positioned over at least a portion of the first primer film.

Clause 155: The coated article of clause 154, wherein the first primer film is selected from the group consisting of titanium, silicon, tin, silicon dioxide, silicon nitride, silicon oxynitride, nickel, zirconium, zinc, aluminum, cobalt, chromium, alloys thereof, and mixtures thereof.

Clause 156: The coated article of clause 154, wherein the second primer film is selected from the group consisting of titanium, silicon, tin, silicon dioxide, silicon nitride, silicon oxynitride, nickel, zirconium, zinc, aluminum, cobalt, chromium, alloys thereof, and mixtures thereof.

Clause 157: The coated article of any one of clauses 154 to 156, wherein when the first primer film comprises the patterned feature, the patterned feature of the first primer film comprises a thickness in a range of from 1 nm to 20 nm, such as from 1 nm to 15 nm, such as from 1 nm to 10 nm, or such as from 1 nm to 8 nm and the second primer film comprises a thickness in a range of from 0.5 nm to 10 nm, such as from 0.5 nm to 8 nm, or such as from 1 nm to 6 nm.

Clause 158: The coated article of any one of clauses 154 to 156, wherein when the second primer film comprises the patterned feature, the first primer film comprises a thickness in a range of from 0.5 nm to 10 nm, such as from 0.5 nm to 8 nm, or such as from 1 nm to 6 nm and the patterned feature of the second primer film comprises a thickness in the range of from 1 nm to 20 nm, such as from 1 nm to 15 nm, such as from 1 nm to 10 nm, or such as from 1 nm to 8 nm.

Clause 159: The coated article of any one of clauses 154 to 158, wherein the first primer film comprises titanium and the second primer film comprises aluminum zinc.

Clause 160: The coated article of any one of clauses 154 to 158, wherein the first primer film comprises titanium and the second primer film comprises tin.

Clause 161: The coated article of any one of clauses 154 to 158, wherein the first primer film comprises titanium and the second primer film comprises nickel chromium.

Clause 162: The coated article of any one of clauses 154 to 161, wherein the patterned feature is a symmetric feature comprising stripes.

Clause 163: The coated article of clause 162, wherein the stripes comprise a width of at least 0.1 inch.

Clause 164: The coated article of clause 162 or 163, wherein the stripes are spaced apart from one another by at least 1.5 inches.

Clause 165: The coated article of any of clauses 162 to 164, wherein the stripes are positioned horizontally, vertically, or diagonally across the second surface.

Clause 166: The coated article of clause 165, wherein the stripes are positioned horizontally across the second surface.

Clause 167: The coated article of clause 165, wherein the stripes are positioned vertically across the second surface.

Clause 168: The coated article of any one of clauses 154 to 161, wherein the patterned feature is an asymmetric pattern.

Clause 169: The coated article of clause 123, wherein the patterned feature is formed in the fourth primer layer positioned over at least a portion of the fourth metallic layer, wherein the fourth primer layer comprises the first primer film positioned over at least a portion of the fourth metallic layer and the second primer film positioned over at least a portion of the first primer film.

Clause 170: The coated article of clause 169, wherein the first primer film is selected from the group consisting of titanium, silicon, tin, silicon dioxide, silicon nitride, silicon oxynitride, nickel, zirconium, zinc, aluminum, cobalt, chromium, alloys thereof, and mixtures thereof.

Clause 171: The coated article of clause 169, wherein the second primer film is selected from the group consisting of titanium, silicon, tin, silicon dioxide, silicon nitride, silicon oxynitride, nickel, zirconium, zinc, aluminum, cobalt, chromium, alloys thereof, and mixtures thereof.

Clause 172: The coated article of any one of clauses 169 to 171, wherein when the first primer film comprises the patterned feature, the patterned feature of the first primer film comprises a thickness in a range of from 1 nm to 20 nm, such as from 1 nm to 15 nm, such as from 1 nm to 10 nm, or such as from 1 nm to 8 nm and the second primer film comprises a thickness in a range of from 0.5 nm to 10 nm, such as from 0.5 nm to 8 nm, or such as from 1 nm to 6 nm.

Clause 173: The coated article of any one of clauses 169 to 172, wherein when the second primer film comprises the patterned feature, the first primer film comprises a thickness in a range of 0.5 nm to 10 nm, such as from 0.5 nm to 8 nm, or such as from 1 nm to 6 nm and the patterned feature of the second primer film comprises a thickness in the range of from 1 nm to 20 nm, such as from 1 nm to 15 nm, such as from 1 nm to 10 nm, or such as from 1 nm to 8 nm.

Clause 174: The coated article of any one of clauses 169 to 173, wherein the first primer film comprises titanium and the second primer film comprises aluminum zinc.

Clause 175: The coated article of any one of clauses 169 to 173, wherein the first primer film comprises titanium and the second primer film comprises tin.

Clause 176: The coated article of any one of clauses 169 to 173, wherein the first primer film comprises titanium and the second primer film comprises nickel chromium.

Clause 177: The coated article of any one of clauses 169 to 176, wherein the patterned feature is a symmetric feature comprising stripes.

Clause 178: The coated article of clause 177, wherein the stripes comprise a width of at least 0.1 inch.

Clause 179: The coated article of clause 177 or 178, wherein the stripes are spaced apart from one another by at least 1.5 inches.

Clause 180: The coated article of any of clauses 177 to 179, wherein the stripes are positioned horizontally, vertically, or diagonally across the second surface.

Clause 181: The coated article of clause 180, wherein the stripes are positioned horizontally across the second surface.

Clause 182: The coated article of clause 180, wherein the stripes are positioned vertically across the second surface.

Clause 183: The coated article of any one of clauses 169 to 176, wherein the patterned feature is an asymmetric pattern.

Clause 184: The coated article of any one of clauses 123 to 183, wherein the second layer comprises a first film positioned over at least a portion of the first primer layer, a second film positioned over at least a portion of the first film, and a third film positioned over at least a portion of the second film, wherein the first film comprises zinc oxide, the second film comprises zinc stannate, and the third film comprises zinc oxide.

Clause 185: The coated article of any one of clauses 123 to 184, wherein the third layer comprises a first film positioned over at least a portion of the second primer layer, a second film positioned over at least a portion of the first film, and a third film positioned over at least a portion of the second film, wherein the first film comprises zinc oxide, the second film comprises zinc stannate, and the third film comprises zinc oxide.

Clause 186: The coated article of any one of clauses 123 to 185, wherein the fourth layer comprises a first film positioned over at least a portion of the third primer layer, a second film positioned over at least a portion of the first film, and a third film positioned over at least a portion of the second film.

Clause 187: The coated article of clause 186, wherein the first film comprises zinc oxide, the second film comprises zinc stannate, and the third film comprises zinc oxide.

Clause 188: The coated article of any one of clauses 123 to 187, wherein the first metallic layer, the second metallic layer, the third metallic layer, and the fourth metallic layer each independently comprise silver, gold, palladium, copper, alloys thereof, mixtures thereof, or combinations thereof.

Clause 189: The coated article of any one of clauses 123 to 188, wherein the first metallic layer is a continuous metallic layer.

Clause 190: The coated article of any one of clauses 123 to 189, wherein the second metallic layer is a continuous metallic layer.

Clause 191: The coated article of any one of clauses 123 to 189, wherein the second metallic layer is a discontinuous metallic layer.

Clause 192: The coated article of any one of clauses 123 to 191, wherein the third metallic layer is a continuous metallic layer.

Clause 193: The coated article of any one of clauses 123 to 191, wherein the third metallic layer is a discontinuous metallic layer.

Clause 194: The coated article of any one of clauses 123 to 193, wherein the fourth metallic layer is a continuous metallic layer.

Clause 195: A method of making a coated article, the method comprising: providing a substrate comprising a first side comprising a first surface and a second side comprising a second surface, wherein the second surface is opposite the first surface; and forming a functional coating over at least a portion of the second side, wherein forming the functional coating comprises: forming a base layer over at least a portion of the second surface; forming a metallic layer over at least a portion of the base layer; forming a primer layer comprising a patterned feature over at least a portion of the metallic layer, wherein forming the primer layer comprises: forming a first primer film over at least a portion of the metallic layer, and forming a second primer film over at least a portion of the first primer film, wherein one of the first primer film or the second primer film comprises the patterned feature; and forming a top layer over at least a portion of the metallic layer.

Clause 196: The method of clause 195, wherein the patterned feature is formed in the first primer film, wherein the patterned feature is formed by: positioning a mask over at least a portion of the substrate comprising the base layer and the metallic layer, wherein the mask comprises at least one opening; applying a material for forming the first primer film through the at least one opening of the mask and onto the metallic layer; removing the mask from the substate; and applying the second primer film over at least a portion of the first primer film.

Clause 197: The method of clause 195, wherein the patterned feature is formed in the second primer film, wherein the patterned feature is formed by: applying the first primer film over at least a portion of the metallic layer; positioning a mask over at least a portion of the substrate comprising the base layer, the metallic layer, and the first primer film, wherein the mask comprises at least one opening; and applying the second primer film through the at least one opening of the mask and onto the first primer film; and removing the mask from the substrate.

Clause 198: The method of clause 195, wherein the patterned feature is formed in the first primer film, wherein the patterned feature is formed by: positioning a mask between the substrate comprising the base layer and the metallic layer and a target comprising a material for forming the first primer film, wherein the mask comprises at least one opening; applying the material for the first primer film through the at least one opening of the mask and onto the metallic layer to form the patterned feature; positioning the substrate comprising the base layer, the metallic layer, and the first primer film comprising the patterned feature under a second target comprising a material for forming the second primer film; and applying the material for forming the second primer film over at least a portion of the patterned feature of the first primer film.

Clause 199: The method of clause 195, wherein the patterned feature is formed in the second primer film, wherein the patterned feature is formed by: applying the first primer film over at least a portion of the metallic layer; positioning a mask between the substrate comprising the base layer, the metallic layer, and the first primer film and a target comprising a material for forming the second primer film, wherein the mask comprises at least one opening; and applying the material for forming the second primer film through the at least one opening of the mask and onto the first primer film.

Clause 200: The method of any one of clauses 195 to 199, wherein the first primer film is selected from the group consisting of titanium, silicon, tin, silicon dioxide, silicon nitride, silicon oxynitride, nickel, zirconium, zinc, aluminum, cobalt, chromium, alloys thereof, and mixtures thereof.

Clause 201: The method of any one of clauses 195 to 199, wherein the second primer film is selected from the group consisting of titanium, silicon, tin, silicon dioxide, silicon nitride, silicon oxynitride, nickel, zirconium, zinc, aluminum, cobalt, chromium, alloys thereof, and mixtures thereof.

Clause 202: The method of any one of clauses 196, 198, 200, and 201, wherein when the first primer film comprises the patterned feature, the patterned feature of the first primer film comprises a thickness in a range of from 1 nm to 20 nm, such as from 1 nm to 15 nm, such as from 1 nm to 10 nm, or such as from 1 nm to 8 nm and the second primer film comprises a thickness in a range of from 0.5 nm to 10 nm, such as from 0.5 nm to 8 nm, or such as from 1 nm to 6 nm.

Clause 203: The method of any one of clauses 197, 199, 200, and 201, wherein when the second primer film comprises the patterned feature, the first primer film comprises a thickness in a range of from 0.5 nm to 10 nm, such as from 0.5 nm to 8 nm, or such as from 1 nm to 6 nm and the patterned feature of the second primer film comprises a thickness in the range of from 1 nm to 20 nm, such as from 1 nm to 15 nm, such as from 1 nm to 10 nm, or such as from 1 nm to 8 nm.

Clause 204: The method of any one of clauses 195 to 203, wherein the first primer film comprises titanium and the second primer film comprises aluminum zinc.

Clause 205: The method of any one of clauses 195 to 203, wherein the first primer film comprises titanium and the second primer film comprises tin.

Clause 206: The method of any one of clauses 195 to 203, wherein the first primer film comprises titanium and the second primer film comprises nickel chromium.

Clause 207: The method of any one of clauses 195 to 206, wherein the patterned feature is a symmetric feature comprising stripes.

Clause 208: The method of clause 207, wherein the stripes comprise a width of at least 0.1 inch.

Clause 209: The method of clause 207 or 208, wherein the stripes are spaced apart from one another by at least 1.5 inches.

Clause 210: The method of any of clauses 207 to 209, wherein the stripes are positioned horizontally, vertically, or diagonally across the second surface.

Clause 211: The method of clause 210, wherein the stripes are positioned horizontally across the second surface.

Clause 212: The method of clause 210, wherein the stripes are positioned vertically across the second surface.

Clause 213: The method of any one of clauses 195 to 206, wherein the patterned feature is an asymmetric pattern.

Clause 214: The method of any one of clauses 195 to 213, wherein forming the base layer comprises forming a first film over at least a portion of the second surface and forming a second film over at least a portion of the first film.

Clause 215: The method of clause 214, wherein the first film comprises zinc stannate, silicon nitride, silicon oxide, silicon aluminum nitride, silicon aluminum oxide, silicon oxynitride, silicon aluminum oxynitride, or tin oxide and the second film comprises zinc oxide or aluminum zinc oxide.

Clause 216: The method of clause 214, wherein forming the base layer further comprises forming a third film over at least a portion of the second film, wherein the first film comprises zinc stannate, silicon nitride, silicon oxide, silicon aluminum nitride, silicon aluminum oxide, silicon oxynitride, silicon aluminum oxynitride, or tin oxide, the second film comprises zinc stannate, and the third film comprises zinc oxide or aluminum zinc oxide.

Clause 217: The method of any one of clauses 195 to 216, wherein the metallic layer comprises silver, gold, palladium, copper, alloys thereof, mixtures thereof, or combinations thereof.

Clause 218: The method of any of clauses 195 to 217, wherein the metallic layer comprises silver.

Clause 219: The method of any of clauses 195 to 218, wherein forming the top layer comprises forming a first film over at least a portion of the primer layer and forming a second film over at least a portion of the first film.

Clause 220: The method of clause 219, wherein the first film comprises zinc oxide.

Clause 221: The method of clause 219, wherein the second film comprises zinc stannate or tin oxide.

Clause 222: The method of any one of clauses 195 to 221, wherein forming the functional coating further comprises forming an outermost protective coating comprising a protective layer, wherein the protective layer comprises at least one of Si₃N₄, SiAlN, SiAlON, SiAlO, TiAlO, titania, alumina, silica, zirconia, or combinations thereof.

Clause 223: The method of clause 222, wherein the protective layer comprises titania.

Clause 224: The method of clause 222, wherein the protective layer comprises a first protective film and a second protective film, wherein the second protective film is positioned over at least a portion of the first protective film.

Clause 225: The method of clause 224, wherein the first protective film comprises SiAlO.

Clause 226: The method of clause 224, wherein the second protective film comprises TiAlO.

Clause 227: The method of any of clauses 195 to 226, wherein the substrate comprises glass.

Clause 228: The method of any of clauses 195 to 227, wherein the coated article is an architectural glazing.

Clause 229: The method of any of clauses 195 to 228, wherein the patterned feature is visible to birds.

Clause 230: The method of any one of clauses 195 to 229, wherein forming the functional coating over at least a portion of the second side comprises: forming the base layer over at least a portion of the second surface; forming a first metallic layer over at least a portion of the base layer; forming a first primer layer over at least a portion of the first metallic layer; forming a second layer over at least a portion of the first primer layer; forming a second metallic layer over at least a portion of the second layer; and forming a second primer layer over at least a portion of the second metallic layer, wherein the top layer is over at least a portion of the second primer layer, wherein one of the first primer layer or the second primer layer comprises the patterned feature, the first primer film, and the second primer film, and wherein one of the first primer film or the second primer film comprises the patterned feature.

Clause 231: The method of clause 230, wherein the patterned feature is formed in the first primer film of the first primer layer, wherein the patterned feature is formed by: positioning a mask over at least a portion of the substrate comprising the base layer and the first metallic layer, wherein the mask comprises at least one opening; applying a material for forming the first primer film through the at least one opening of the mask and onto the first metallic layer; removing the mask from the substrate; and applying the second primer film over at least a portion of the first primer film.

Clause 232: The method of clause 230, wherein the patterned feature is formed in the first primer film of the first primer layer, wherein the patterned feature is formed by: positioning a mask between the substrate comprising the base layer and the first metallic layer and a target comprising a material for forming the first primer film, wherein the mask comprises at least one opening; applying the material for forming the first primer film through the at least one opening of the mask and onto the first metallic layer to form the patterned feature; positioning the substrate comprising the base layer, the first metallic layer, and the first primer film comprising the patterned feature under a second target comprising a material for forming the second primer film; and applying the material for forming the second primer film over at least a portion of the patterned feature of the first primer film.

Clause 233: The method of clause 230, wherein the patterned feature is formed in the second primer film of the first primer layer, wherein the patterned feature is formed by: applying the first primer film over at least a portion of the first metallic layer; positioning a mask over at least a portion of the substrate comprising the base layer, the metallic layer, and the first primer film, wherein the mask comprises at least one opening; and applying a material for forming the second primer film through the at least one opening of the mask and onto the first primer film; and removing the mask from the substrate.

Clause 234: The method of clause 230, wherein the patterned feature is formed in the second primer film of the first primer layer, wherein the patterned feature is formed by: applying the first primer film over at least a portion of the first metallic layer; positioning a mask between the substrate comprising the base layer, the metallic layer, and the first primer film and a target comprising a material for forming the second primer film, wherein the mask comprises at least one opening; and applying the material for the second primer film through the at least one opening of the mask and onto the first primer film.

Clause 235: The method of any one of clauses 231 to 234, wherein the first primer film is selected from the group consisting of titanium, silicon, tin, silicon dioxide, silicon nitride, silicon oxynitride, nickel, zirconium, zinc, aluminum, cobalt, chromium, alloys thereof, and mixtures thereof.

Clause 236: The method of any one of clauses 231 to 234, wherein the second primer film is selected from the group consisting of titanium, silicon, tin, silicon dioxide, silicon nitride, silicon oxynitride, nickel, zirconium, zinc, aluminum, cobalt, chromium, alloys thereof, and mixtures thereof.

Clause 237: The method of any one of clauses 231, 232, 235, and 236, wherein when the first primer film comprises the patterned feature, the patterned feature of the first primer film comprises a thickness in a range of from 1 nm to 20 nm, such as from 1 nm to 15 nm, such as from 1 nm to 10 nm, or such as from 1 nm to 8 nm and the second primer film comprises a thickness in a range of from 0.5 nm to 10 nm, such as from 0.5 nm to 8 nm, or such as from 1 nm to 6 nm.

Clause 238: The method of any one of clauses 233 to 236, wherein when the second primer film comprises the patterned feature, the first primer film comprises a thickness in a range of from 0.5 nm to 10 nm, such as from 0.5 nm to 8 nm, or such as from 1 nm to 6 nm and the patterned feature of the second primer film comprises a thickness in the range of from 1 nm to 20 nm, such as from 1 nm to 15 nm, such as from 1 nm to 10 nm, or such as from 1 nm to 8 nm.

Clause 239: The method of any one of clauses 231 to 238, wherein the first primer film comprises titanium and the second primer film comprises aluminum zinc.

Clause 240: The method of any one of clauses 231 to 238, wherein the first primer film comprises titanium and the second primer film comprises tin.

Clause 241: The method of any one of clauses 231 to 238, wherein the first primer film comprises titanium and the second primer film comprises nickel chromium.

Clause 242: The method of any one of clauses 231 to 241, wherein the patterned feature is a symmetric pattern comprising stripes.

Clause 243: The method of clause 242, wherein the stripes comprise a width of at least 0.1 inch.

Clause 244: The method of clause 242 or 243, wherein the stripes are spaced apart from one another by at least 1.5 inches.

Clause 245: The method of any of clauses 242 to 244, wherein the stripes are positioned horizontally, vertically, or diagonally across the second surface.

Clause 246: The method of clause 245, wherein the stripes are positioned horizontally across the second surface.

Clause 247: The method of clause 245, wherein the stripes are positioned vertically across the second surface.

Clause 248: The method of any one of clauses 231 to 241, wherein the patterned feature is an asymmetric pattern.

Clause 249: The method of clause 230, wherein the patterned feature is formed in the first primer film of the second primer layer, wherein the patterned feature is formed by: positioning a mask over at least a portion of the substrate comprising the base layer, the first metallic layer, the first primer layer, the second layer, and the second metallic layer, wherein the mask comprises at least one opening; applying a material for forming the first primer film through the at least one opening of the mask and onto the second metallic layer; removing the mask from the substrate; and applying the second primer film over at least a portion of the first primer film.

Clause 250: The method of clause 230, wherein the patterned feature is formed in the first primer film of the second primer layer, wherein the patterned feature is formed by: positioning a mask between the substrate comprising the base layer, the first metallic layer, the first primer layer, the second layer, and the second metallic layer and a target comprising a material for forming the first primer film, wherein the mask comprises at least one opening; applying the material for forming the first primer film through the at least one opening of the mask and onto the second metallic layer to form the patterned feature; positioning the substrate comprising the base layer, the first metallic layer, the first primer layer, the second layer, the second metallic layer, and the first primer film comprising the patterned feature under a second target comprising a material for forming the second primer film; and applying the material for forming the second primer film over at least a portion of the patterned feature of the first primer film.

Clause 251: The method of clause 230, wherein the patterned feature is formed in the second primer film of the second primer layer, wherein the patterned feature is formed by: applying the first primer film over at least a portion of the second metallic layer; positioning a mask over at least a portion of the substrate comprising the base layer, the first metallic layer, the first primer layer, the second layer, the second metallic layer, and the first primer film, wherein the mask comprises at least one opening; applying a material for forming the second primer film through the at least one opening of the mask and onto the first primer film; and removing the mask from the substrate.

Clause 252: The method of clause 230, wherein the patterned feature is formed in the second primer film of the second primer layer, wherein the patterned feature is formed by: applying the first primer film over at least a portion of the second metallic layer; positioning a mask between the substrate comprising the base layer, the first metallic layer, the first primer layer, the second layer, the second metallic layer, and the first primer film and a target comprising a material for forming the second primer film, wherein the mask comprises at least one opening; and applying the material for the second primer film through the at least one opening of the mask and onto the first primer film.

Clause 253: The method of any one of clauses 249 to 252, wherein the first primer film is selected from the group consisting of titanium, silicon, tin, silicon dioxide, silicon nitride, silicon oxynitride, nickel, zirconium, zinc, aluminum, cobalt, chromium, alloys thereof, and mixtures thereof.

Clause 254: The method of any one of clauses 249 to 252, wherein the second primer film is selected from the group consisting of titanium, silicon, tin, silicon dioxide, silicon nitride, silicon oxynitride, nickel, zirconium, zinc, aluminum, cobalt, chromium, alloys thereof, and mixtures thereof.

Clause 255: The method of any one of clauses 249, 250, 253, and 254, wherein when the first primer film comprises the patterned feature, the patterned feature of the first primer film comprises a thickness in a range of from 1 nm to 20 nm, such as from 1 nm to 15 nm, such as from 1 nm to 10 nm, or such as from 1 nm to 8 nm and the second primer film comprises a thickness in a range of from 0.5 nm to 10 nm, such as from 0.5 nm to 8 nm, or such as from 1 nm to 6 nm.

Clause 256: The method of any one of clauses 251 to 254, wherein when the second primer film comprises the patterned feature, the first primer film comprises a thickness in a range of from 0.5 nm to 10 nm, such as from 0.5 nm to 8 nm, or such as from 1 nm to 6 nm and the patterned feature of the second primer film comprises a thickness in the range of from 1 nm to 20 nm, such as from 1 nm to 15 nm, such as from 1 nm to 10 nm, or such as from 1 nm to 8 nm.

Clause 257: The method of any one of clauses 249 to 256, wherein the first primer film comprises titanium and the second primer film comprises aluminum zinc.

Clause 258: The method of any one of clauses 249 to 256, wherein the first primer film comprises titanium and the second primer film comprises tin.

Clause 259: The method of any one of clauses 249 to 256, wherein the first primer film comprises titanium and the second primer film comprises nickel chromium.

Clause 260: The method of any one of clauses 249 to 259, wherein the patterned feature is a symmetric pattern comprising stripes.

Clause 261: The method of clause 260, wherein the stripes comprise a width of at least 0.1 inch.

Clause 262: The method of clause 260 or 261, wherein the stripes are spaced apart from one another by at least 1.5 inches.

Clause 263: The method of any of clauses 260 to 262, wherein the stripes are positioned horizontally, vertically, or diagonally across the second surface.

Clause 264: The method of clause 263, wherein the stripes are positioned horizontally across the second surface.

Clause 265: The method of clause 263, wherein the stripes are positioned vertically across the second surface.

Clause 266: The method of any one of clauses 249 to 259, wherein the patterned feature is an asymmetric pattern.

Clause 267: The method of any one of clauses 230 to 266, wherein forming the second layer comprises forming a first film over at least a portion of the first primer layer, forming a second film over at least a portion of the first film, and forming a third film over at least a portion of the second film, wherein the first film comprises zinc oxide, the second film comprises zinc stannate, and the third film comprises zinc oxide.

Clause 268: The method of any of clauses 230 to 267, wherein the first metallic layer and the second metallic layer each independently comprise silver, gold, palladium, copper, alloys thereof, mixtures thereof, or combinations thereof.

Clause 269: The method of any of clauses 230 to 268, wherein the first metallic layer and the second metallic layer comprise silver.

Clause 270: The method of any of clauses 230 to 269, wherein the second metallic layer is a continuous layer.

Clause 271: The method of any of clauses 230 to 270, wherein the second metallic layer is a discontinuous layer.

Clause 272: The method of any one of clauses 195 to 229, wherein forming the functional coating over at least a portion of the second side comprises: forming the base layer over a least a portion of the second surface; forming a first metallic layer over at least a portion of the base layer; forming a first primer layer over at least a portion of the first metallic layer; forming a second layer over at least a portion of the first primer layer; forming a second metallic layer over at least a portion of the second layer; forming a second primer layer over at least a portion of the second metallic layer; forming a third layer over at least a portion of the second primer layer; forming a third metallic layer over at least a portion of the third layer; and forming a third primer layer over at least a portion of the third metallic layer, wherein the top layer is over at least a portion of the third primer layer, wherein one of the first primer layer, the second primer layer, or the third primer layer comprises the patterned feature, the first primer film, and the second primer film, and wherein one of the first primer film and the second primer film comprises the patterned feature.

Clause 273: The method of clause 272, wherein the patterned feature is formed in the first primer film of the first primer layer, wherein the patterned feature is formed by: positioning a mask over at least a portion of the substrate comprising the base layer and the first metallic layer, wherein the mask comprises at least one opening; applying a material for forming the first primer film through the at least one opening of the mask and onto the metallic layer; removing the mask from the substrate; and applying the second primer film over at least a portion of the first primer film.

Clause 274: The method of clause 272, wherein the patterned feature is formed in the first primer film of the first primer layer, wherein the patterned feature is formed by: positioning a mask between the substrate comprising the base layer and the first metallic layer and a target comprising a material for forming the first primer film, wherein the mask comprise at least one opening; applying the material for forming the first primer film through the at least one opening of the mask and onto the first metallic layer to form the patterned feature; positioning the substrate comprising the base layer, the first metallic layer, and the first primer film comprising the patterned feature under a second target comprising a material for forming the second primer film; and applying the material for forming the second primer film over at least a portion of the patterned feature of the first primer film.

Clause 275: The method of clause 272, wherein the patterned feature is formed in the second primer film of the first primer layer, wherein the patterned feature is formed by: applying the first primer film over at least a portion of the first metallic layer; positioning a mask over at least a portion of the substrate comprising the base layer, the first metallic layer, and the first primer film, wherein the mask comprises at least one opening; applying a material for forming the second primer film through the at least one opening of the mask and onto the first primer film; and removing the mask from the substrate.

Clause 276: The method of clause 272, wherein the patterned feature is formed in the second primer film of the first primer layer, wherein the patterned feature is formed by: applying the first primer film over at least a portion of the first metallic layer; positioning a mask between the substrate comprising the base layer, the first metallic layer, and the first primer film and a target comprising a material for forming the second primer film, wherein the mask comprises at least one opening; and applying the material for forming the second primer film through the at least one opening of the mask and onto the first primer film.

Clause 277: The method of any one of clauses 273 to 276, wherein the first primer film is selected from the group consisting of titanium, silicon, tin, silicon dioxide, silicon nitride, silicon oxynitride, nickel, zirconium, zinc, aluminum, cobalt, chromium, alloys thereof, and mixtures thereof.

Clause 278: The method of any one of clauses 273 to 276, wherein the second primer film is selected from the group consisting of titanium, silicon, tin, silicon dioxide, silicon nitride, silicon oxynitride, nickel, zirconium, zinc, aluminum, cobalt, chromium, alloys thereof, and mixtures thereof.

Clause 279: The method of any one of clauses 273, 274, 277, and 278, wherein when the first primer film comprises the patterned feature, the patterned feature of the first primer film comprises a thickness in a range of from 1 nm to 20 nm, such as from 1 nm to 15 nm, such as from 1 nm to 10 nm, or such as from 1 nm to 8 nm and the second primer film comprises a thickness in a range of from 0.5 nm to 10 nm, such as from 0.5 nm to 8 nm, or such as from 1 nm to 6 nm.

Clause 280: The method of any one of clauses 275 to 278, wherein when the second primer film comprises the patterned feature, the first primer film comprises a thickness in a range of from 0.5 nm to 10 nm, such as from 0.5 nm to 8 nm, or such as from 1 nm to 6 nm and the patterned feature of the second primer film comprises a thickness in the range of from 1 nm to 20 nm, such as from 1 nm to 15 nm, such as from 1 nm to 10 nm, or such as from 1 nm to 8 nm.

Clause 281: The method of any one of clauses 273 to 280, wherein the first primer film comprises titanium and the second primer film comprises aluminum zinc.

Clause 282: The method of any one of clauses 273 to 280, wherein the first primer film comprises titanium and the second primer film comprises tin.

Clause 283: The method of any one of clauses 273 to 280, wherein the first primer film comprises titanium and the second primer film comprises nickel chromium.

Clause 284: The method of any one of clauses 273 to 283, wherein the patterned feature is a symmetric pattern comprising stripes.

Clause 285: The method of clause 284, wherein the stripes comprise a width of at least 0.1 inch.

Clause 286: The method of clause 284 or 285, wherein the stripes are spaced apart from one another by at least 1.5 inches.

Clause 287: The method of any of clauses 284 to 286, wherein the stripes are positioned horizontally, vertically, or diagonally across the second surface.

Clause 288: The method of clause 287, wherein the stripes are positioned horizontally across the second surface.

Clause 289: The method of clause 287, wherein the stripes are positioned vertically across the second surface.

Clause 290: The method of any one of clauses 273 to 283, wherein the patterned feature is an asymmetric pattern.

Clause 291: The method of clause 272, wherein the patterned feature is formed in the first primer film of the second primer layer, wherein the patterned feature is formed by: positioning a mask over at least a portion of the substrate comprising the base layer, the first metallic layer, the first primer layer, the second layer, and the second metallic layer, wherein the mask comprises at least one opening; applying a material for forming the first primer film through the at least one opening of the mask and onto the second metallic layer; removing the mask from the substrate; and applying the second primer film over at least a portion of the first primer film.

Clause 292: The method of clause 272, wherein the patterned feature is formed in the first primer film of the second primer layer, wherein the patterned feature is formed by: positioning a mask between the substrate comprising the base layer, the first metallic layer, the first primer layer, the second layer, and the second metallic layer and a target comprising a material for forming the first primer film, wherein the mask comprises at least one opening; applying the material for forming the first primer film through the at least one opening of the mask and onto the second metallic layer to form the patterned feature; positioning the substrate comprising the base layer, the first metallic layer, the first primer layer, the second primer layer, the second metallic layer, and the first primer film comprising the patterned feature under a second target comprising a material for forming the second primer film; and applying the material for forming the second primer film over at least a portion of the patterned feature of the first primer film.

Clause 293: The method of clause 272, wherein the patterned feature is formed in the second primer film of the second primer layer, wherein the patterned feature is formed by: applying the first primer film over at least a portion of the second metallic layer; positioning a mask over at least a portion of the substrate comprising the base layer, the first metallic layer, the first primer layer, the second layer, the second metallic layer, and the first primer film, wherein the mask comprises at least one opening; applying a material for forming the second primer film through the at least one opening of the mask and onto the first primer film; and removing the mask from the substrate.

Clause 294: The method of clause 272, wherein the patterned feature is formed in the second primer film of the second primer layer, wherein the patterned feature is formed by: applying the first primer film over at least a portion of the second metallic layer; positioning a mask between the substrate comprising the base layer, the first metallic layer, the first primer layer, the second layer, the second metallic layer, and the first primer film and a target comprising a material for forming the second primer film, wherein the mask comprises at least one opening; and applying the material for the second primer film through the at least one opening of the mask and onto the first primer film.

Clause 295: The method of any one of clauses 291 to 294, wherein the first primer film is selected from the group consisting of titanium, silicon, tin, silicon dioxide, silicon nitride, silicon oxynitride, nickel, zirconium, zinc, aluminum, cobalt, chromium, alloys thereof, and mixtures thereof.

Clause 296: The method of any one of clauses 291 to 294, wherein the second primer film is selected from the group consisting of titanium, silicon, tin, silicon dioxide, silicon nitride, silicon oxynitride, nickel, zirconium, zinc, aluminum, cobalt, chromium, alloys thereof, and mixtures thereof.

Clause 297: The method of any one of clauses 291, 292, 295, and 296, wherein when the first primer film comprises the patterned feature, the patterned feature of the first primer film comprises a thickness in a range of from 1 nm to 20 nm, such as from 1 nm to 15 nm, such as from 1 nm to 10 nm, or such as from 1 nm to 8 nm and the second primer film comprises a thickness in a range of from 0.5 nm to 10 nm, such as from 0.5 nm to 8 nm, or such as from 1 nm to 6 nm.

Clause 298: The method of any one of clauses 293 to 296, wherein when the second primer film comprises the patterned feature, the first primer film comprises a thickness in a range of from 0.5 nm to 10 nm, such as from 0.5 nm to 8 nm, or such as from 1 nm to 6 nm and the patterned feature of the second primer film comprises a thickness in the range of from 1 nm to 20 nm, such as from 1 nm to 15 nm, such as from 1 nm to 10 nm, or such as from 1 nm to 8 nm.

Clause 299: The method of any one of clauses 291 to 298, wherein the first primer film comprises titanium and the second primer film comprises aluminum zinc.

Clause 300: The method of any one of clauses 291 to 298, wherein the first primer film comprises titanium and the second primer film comprises tin.

Clause 301: The method of any one of clauses 291 to 298, wherein the first primer film comprises titanium and the second primer film comprises nickel chromium.

Clause 302: The method of any one of clauses 291 to 301, wherein the patterned feature is a symmetric pattern comprising stripes.

Clause 303: The method of clause 302, wherein the stripes comprise a width of at least 0.1 inch.

Clause 304: The method of clause 302 or 303, wherein the stripes are spaced apart from one another by at least 1.5 inches.

Clause 305: The method of any of clauses 302 to 304, wherein the stripes are positioned horizontally, vertically, or diagonally across the second surface.

Clause 306: The method of clause 305, wherein the stripes are positioned horizontally across the second surface.

Clause 307: The method of clause 305, wherein the stripes are positioned vertically across the second surface.

Clause 308: The method of any one of clauses 291 to 301, wherein the patterned feature is an asymmetric pattern.

Clause 309: The method of clause 272, wherein the patterned feature is formed in the first primer film of the third primer layer, wherein the patterned feature is formed by: positioning a mask over at least a portion of the substrate comprising the base layer, the first metallic layer, the first primer layer, the second layer, the second metallic layer, the second primer layer, the third layer, and the third metallic layer, wherein the mask comprises at least one opening; applying a material for forming the first primer film through the at least one opening of the mask and onto the third metallic layer to form the patterned feature; removing the mask from the substrate; and applying the second primer film over at least a portion of the first primer film.

Clause 310: The method of clause 272, wherein the patterned feature is formed in the first primer film of the third primer layer, wherein the patterned feature is formed by: positioning a mask between the substrate comprising the base layer, the first metallic layer, the first primer layer, the second layer, the second metallic layer, the second primer layer, the third layer, and the third metallic layer and a target comprising a material for forming the first primer film, wherein the mask comprises at least one opening; applying the material for the first primer film through the at least one opening of the mask and onto the third metallic layer to form the patterned feature; positioning the substrate comprising the base layer, the first metallic layer, the first primer layer, the second layer, the second metallic layer, the second primer layer, the third layer, the third metallic layer, and the first film comprising the patterned feature under a second target comprising a material for forming the second primer film; and applying the material for forming the second primer film over at least a portion of the patterned feature of the first primer film.

Clause 311: The method of clause 272, wherein the patterned feature is formed in the second primer film of the third primer layer, wherein the patterned feature is formed by: applying the first primer film over at least a portion of the third metallic layer; positioning a mask over at least a portion of the substrate comprising the base layer, the first metallic layer, the first primer layer, the second layer, the second metallic layer, the second primer layer, the third layer, the third metallic layer, and the first primer film, wherein the mask comprises at least one opening; applying a material for forming the second primer film through the at least one opening of the mask and onto the first primer film; and removing the mask from the substrate.

Clause 312: The method of clause 272, wherein the patterned feature is formed in the second primer film of the third primer layer, wherein the patterned feature is formed by: applying the first primer film over at least a portion of the third metallic layer; positioning a mask between the substrate comprising the base layer, the first metallic layer, the first primer layer, the second layer, the second metallic layer, the second primer layer, the third layer, the third metallic layer, and the first primer film and a target comprising a material for forming the second primer film, wherein the mask comprises at least one opening; and applying the material for the second primer film through the at least one opening of the mask and onto the first primer film.

Clause 313: The method of any one of clauses 308 to 312, wherein the first primer film is selected from the group consisting of titanium, silicon, tin, silicon dioxide, silicon nitride, silicon oxynitride, nickel, zirconium, zinc, aluminum, cobalt, chromium, alloys thereof, and mixtures thereof.

Clause 314: The method of any one of clauses 308 to 312, wherein the second primer film is selected from the group consisting of titanium, silicon, tin, silicon dioxide, silicon nitride, silicon oxynitride, nickel, zirconium, zinc, aluminum, cobalt, chromium, alloys thereof, and mixtures thereof.

Clause 315: The method of any one of clauses 309, 310, 313, and 314, wherein when the first primer film comprises the patterned feature, the patterned feature of the first primer film comprises a thickness in a range of from 1 nm to 20 nm, such as from 1 nm to 15 nm, such as from 1 nm to 10 nm, or such as from 1 nm to 8 nm and the second primer film comprises a thickness in a range of from 0.5 nm to 10 nm, such as from 0.5 nm to 8 nm, or such as from 1 nm to 6 nm.

Clause 316: The method of any one of clauses 311 to 314, wherein when the second primer film comprises the patterned feature, the first primer film comprise a thickness in a range of from 0.5 nm to 10 nm, such as from 0.5 nm to 8 nm, or such as from 1 nm to 6 nm and the patterned feature of the second primer film comprises a thickness in the range of from 1 nm to 20 nm, such as from 1 nm to 15 nm, such as from 1 nm to 10 nm, or such as from 1 nm to 8 nm.

Clause 317: The method of any one of clauses 309 to 316, wherein the first primer film comprises titanium and the second primer film comprises aluminum zinc.

Clause 318: The method of any one of clauses 309 to 316, wherein the first primer film comprises titanium and the second primer film comprises tin.

Clause 319: The method of any one of clauses 309 to 316, wherein the first primer film comprises titanium and the second primer film comprises nickel chromium.

Clause 320: The method of any one of clauses 309 to 319, wherein the patterned feature is a symmetric pattern comprising stripes.

Clause 321: The method of clause 320, wherein the stripes comprise a width of at least 0.1 inch.

Clause 322: The method of clause 320 or 321, wherein the stripes are spaced apart from one another by at least 1.5 inches.

Clause 323: The method of any of clauses 320 to 322, wherein the stripes are positioned horizontally, vertically, or diagonally across the second surface.

Clause 324: The method of clause 323, wherein the stripes are positioned horizontally across the second surface.

Clause 325: The method of clause 323, wherein the stripes are positioned vertically across the second surface.

Clause 326: The method of any one of clauses 309 to 319, wherein the patterned feature is an asymmetric pattern.

Clause 327: The method of any one of clauses 272 to 326, wherein forming the second layer comprises forming a first film over at least a portion of the first primer layer, forming a second film over at least a portion of the first film, and forming a third film over at least a portion of the second film, wherein the first film comprises zinc oxide, the second film comprises zinc stannate, and the third film comprises zinc oxide.

Clause 328: The method of any one of clauses 272 to 327, wherein forming the third layer comprises forming a first film over at least a portion of the second primer layer, forming a second film over at least a portion of the first film, and forming a third film over at least a portion of the second film, wherein the first film comprises zinc oxide, the second film comprises zinc stannate, and the third film comprises zinc oxide.

Clause 329: The method of any one of clauses 272 to 328, wherein the first metallic layer, the second metallic layer, and the third metallic layer each independently comprise silver, gold, palladium, copper, alloys thereof, mixtures thereof, or combinations thereof.

Clause 330: The method of any one of clauses 272 to 329, wherein the first metallic layer is a continuous metallic layer.

Clause 331: The method of any one of clauses 272 to 330, wherein the second metallic layer is a continuous metallic layer.

Clause 332: The method of any one of clauses 272 to 330, wherein the second metallic layer is a discontinuous metallic layer.

Clause 333: The method of any one of clauses 272 to 332, wherein the third metallic layer is a continuous metallic layer.

Clause 334: The method of any one of clauses 272 to 332, wherein the third metallic layer is a discontinuous metallic layer.

Clause 335: The method of any one of clauses 195 to 229, wherein forming the functional coating over at least a portion of the second side comprises: forming the base layer over at least a portion of the second surface; forming a first metallic layer over at least a portion of the base layer; forming a first primer layer over at least a portion of the first metallic layer; forming a second layer over at least a portion of the first primer layer; forming a second metallic layer over at least a portion of the second layer; forming a second primer layer over at least a portion of the second metallic layer; forming a third layer over at least a portion of the second primer layer; forming a third metallic layer over at least a portion of the third layer; forming a third primer layer over at least a portion of the third metallic layer; forming a fourth layer over at least a portion of the third primer layer; forming a fourth metallic layer over at least a portion of the fourth layer; and forming a fourth primer layer over at least a portion of the fourth metallic layer, wherein the top layer is over at least a portion of the fourth primer layer, wherein one of the first primer layer, the second primer layer, the third primer layer, or the fourth primer layer comprises the patterned feature, the first primer film, and the second primer film, and wherein one of the first primer film or the second primer film comprises the patterned feature.

Clause 336: The method of clause 335, wherein the patterned feature is formed in the first primer film of the first primer layer, wherein the patterned feature is formed by: positioning a mask over at least a portion of the substrate comprising the base layer and the first metallic layer, wherein the mask comprises at least one opening; applying a material for forming the first primer film through the at least one opening of the mask and onto the first metallic layer; removing the mask from the substrate; and applying the second primer film over at least a portion of the first primer film.

Clause 337: The method of clause 335, wherein the patterned feature is formed in the first primer film of the first primer layer, wherein the patterned feature is formed by: positioning a mask between the substrate comprising the base layer and the first metallic layer and a target comprising a material for forming the first primer film, wherein the mask comprises at least one opening; applying the material for forming the first primer film through the at least one opening of the mask and onto the first metallic layer to form the patterned feature; positioning the substrate comprising the base layer, the first metallic layer, and the first primer film comprising the patterned feature under a second target comprising a material for forming the second primer film; and applying the material for forming the second primer film over at least a portion of the patterned feature of the first primer film.

Clause 338: The method of clause 335, wherein the patterned feature is formed in the second primer film of the first primer layer, wherein the patterned feature is formed by: applying the first primer film over at least a portion of the first metallic layer; positioning a mask over at least a portion of the substrate comprising the base layer, the first metallic layer, and the first primer film, wherein the mask comprises at least one opening; applying a material for forming the second primer film through the at least one opening of the mask and onto the first primer film; and removing the mask from the substrate.

Clause 339: The method of clause 335, wherein the patterned feature is formed in the second primer film of the first primer layer, wherein the patterned feature is formed by: applying the first primer film over at least a portion of the first metallic layer; positioning a mask between the substrate comprising the base layer, the first metallic layer, and the first primer film and a target comprising a material for forming the second primer film, wherein the mask comprises at least one opening; and applying the material for forming the second primer film through the at least one opening of the mask and onto the first primer film.

Clause 340: The method of any one of clauses 336 to 339, wherein the first primer film is selected from the group consisting of titanium, silicon, tin, silicon dioxide, silicon nitride, silicon oxynitride, nickel, zirconium, zinc, aluminum, cobalt, chromium, alloys thereof, and mixtures thereof.

Clause 341: The method of any one of clauses 336 to 339, wherein the second primer film is selected from the group consisting of titanium, silicon, tin, silicon dioxide, silicon nitride, silicon oxynitride, nickel, zirconium, zinc, aluminum, cobalt, chromium, alloys thereof, and mixtures thereof.

Clause 342: The method of any one of clauses 336, 337, 340, and 341, wherein when the first primer film comprises the patterned feature, the patterned feature of the first primer film comprises a thickness in a range of from 1 nm to 20 nm, such as from 1 nm to 15 nm, such as from 1 nm to 10 nm, or such as from 1 nm to 8 nm and the second primer film comprises a thickness in a range of from 0.5 nm to 10 nm, such as from 0.5 nm to 8 nm, or such as from 1 nm to 6 nm.

Clause 343: The method of any one of clauses 338 to 341, wherein when the second primer film comprises the patterned feature, the first primer film comprises a thickness in a range of from 0.5 nm to 10 nm, such as from 0.5 nm to 8 nm, or such as from 1 nm to 6 nm and the patterned feature of the second primer film comprises a thickness in the range of from 1 nm to 20 nm, such as from 1 nm to 15 nm, such as from 1 nm to 10 nm, or such as from 1 nm to 8 nm.

Clause 344: The method of any one of clauses 336 to 343, wherein the first primer film comprises titanium and the second primer film comprises aluminum zinc.

Clause 345: The method of any one of clauses 336 to 343, wherein the first primer film comprises titanium and the second primer film comprises tin.

Clause 346: The method of any one of clauses 336 to 343, wherein the first primer film comprises titanium and the second primer film comprises nickel chromium.

Clause 347: The method of any one of clauses 336 to 346, wherein the patterned feature is a symmetric pattern comprising stripes.

Clause 348: The method of clause 347, wherein the stripes comprise a width of at least 0.1 inch.

Clause 349: The method of clause 347 or 348, wherein the stripes are spaced apart from one another by at least 1.5 inches.

Clause 350: The method of any one of clauses 347 to 349, wherein the stripes are positioned horizontally, vertically, or diagonally across the second surface.

Clause 351: The method of clause 350, wherein the stripes are positioned horizontally across the second surface.

Clause 352: The method of clause 350, wherein the stripes are positioned vertically across the second surface.

Clause 353: The method of any one of clauses 336 to 346, wherein the patterned feature is an asymmetric pattern.

Clause 354: The method of clause 335, wherein the patterned feature is formed in the first primer film of the second primer layer, wherein the patterned feature is formed by: applying positioning a mask over at least a portion of the substrate comprising the base layer, the first metallic layer, the first primer layer, the second layer, and the second metallic layer, wherein the mask comprises at least one opening; applying a material for forming the first primer film through the at least one opening of the mask and onto the second metallic layer; removing the mask from the substrate; and applying the second primer film over at least a portion of the first primer film.

Clause 355: The method of clause 335, wherein the patterned feature is formed in the first primer film of the second primer layer, wherein the patterned feature is formed by: positioning a mask between the substrate comprising the base layer, the first metallic layer, the first primer layer, the second layer, and the second metallic layer and a target comprising a material for forming the first primer film, wherein the mask comprises at least one opening; applying the material for forming the first primer film through at least one opening of the mask and onto the second metallic layer to form the patterned feature; positioning the substrate comprising the base layer, the first metallic layer, the first primer layer, the second layer, the second metallic layer, and the first primer film comprising the patterned feature under a second target comprising a material for forming the second primer film; and applying the material for forming the second primer film over at least a portion of the patterned feature of the first primer film.

Clause 356: The method of clause 335, wherein the patterned feature is formed in the second primer film of the second primer layer, wherein the patterned feature is formed by: applying the first primer film over at least a portion of the second metallic layer; positioning a mask over at least a portion of the substrate comprising the base layer, the first metallic layer, the first primer layer, the second layer, the second metallic layer, and the first primer film, wherein the mask comprises at least one opening; applying a material for forming the second primer film through the at least one opening of the mask and onto the first primer film; and removing the mask from the substrate.

Clause 357: The method of clause 335, wherein the patterned feature is formed in the second primer film of the second primer layer, wherein the patterned feature is formed by: applying the first primer film over at least a portion of the second metallic layer; positioning a mask between the substrate comprising the base layer, the first metallic layer, the first primer layer, the second layer, the second metallic layer, and the first primer film and a target comprising a material for forming the second primer film, wherein the mask comprises at least one opening; and applying the material for forming the second primer film through the at least one opening of the mask and onto the first primer film.

Clause 358: The method of any one of clauses 354 to 357, wherein the first primer film is selected from the group consisting of titanium, silicon, tin, silicon dioxide, silicon nitride, silicon oxynitride, nickel, zirconium, zinc, aluminum, cobalt, chromium, alloys thereof, and mixtures thereof.

Clause 359: The method of any one of clauses 354 to 357, wherein the second primer film is selected from the group consisting of titanium, silicon, tin, silicon dioxide, silicon nitride, silicon oxynitride, nickel, zirconium, zinc, aluminum, cobalt, chromium, alloys thereof, and mixtures thereof.

Clause 360: The method of any one of clauses 354, 355, 358, and 359, wherein when the first primer film comprises the patterned feature, the patterned feature of the first primer film comprises a thickness in a range of from 1 nm to 20 nm, such as from 1 nm to 15 nm, such as from 1 nm to 10 nm, or such as from 1 nm to 8 nm and the second primer film comprises a thickness in a range of from 0.5 nm to 10 nm, such as from 0.5 nm to 8 nm, or such as from 1 nm to 6 nm.

Clause 361: The method of any one of clauses 356 to 359, wherein when the second primer film comprises the patterned feature, the first primer film comprises a thickness in a range of from 0.5 nm to 10 nm, such as from 0.5 nm to 8 nm, or such as from 1 nm to 6 nm and the patterned feature of the second primer film comprises a thickness in the range of from 1 nm to 20 nm, such as from 1 nm to 15 nm, such as from 1 nm to 10 nm, or such as from 1 nm to 8 nm.

Clause 362: The method of any one of clauses 354 to 361, wherein the first primer film comprises titanium and the second primer film comprises aluminum zinc.

Clause 363: The method of any one of clauses 354 to 361, wherein the first primer film comprises titanium and the second primer film comprises tin.

Clause 364: The method of any one of clauses 354 to 361, wherein the first primer film comprises titanium and the second primer film comprises nickel chromium.

Clause 365: The method of any one of clauses 354 to 364, wherein the patterned feature is a symmetric pattern comprising stripes.

Clause 366: The method of clause 365, wherein the stripes comprise a width of at least 0.1 inch.

Clause 367: The method of clause 365 or 366, wherein the stripes are spaced apart from one another by at least 1.5 inches.

Clause 368: The method of any one of clauses 365 to 367, wherein the stripes are positioned horizontally, vertically, or diagonally across the second surface.

Clause 369: The method of clause 368, wherein the stripes are positioned horizontally across the second surface.

Clause 370: The method of clause 368, wherein the stripes are positioned vertically across the second surface.

Clause 371: The method of any one of clauses 354 to 364, wherein the patterned feature is an asymmetric pattern.

Clause 372: The method of clause 335, wherein the patterned feature is formed in the first primer film of the third primer layer, wherein the patterned feature is formed by: positioning a mask over at least a portion of the substrate comprising the base layer, the first metallic layer, the first primer layer, the second layer, the second metallic layer, the second primer layer, the third layer, and the third metallic layer, wherein the mask comprises at least one opening; applying a material for forming the first primer film through the at least one opening of the mask and onto the third metallic layer; removing the mask from the substrate; and applying the second primer film over at least a portion of the first primer film.

Clause 373: The method of clause 335, wherein the patterned feature is formed in the first primer film of the third primer layer, wherein the patterned feature is formed by: positioning a mask between the substrate comprising the base layer, the first metallic layer, the first primer layer, the second layer, the second metallic layer, the second primer layer, the third layer, and the third metallic layer and a target comprising a material for forming the first primer film, wherein the mask comprises at least one opening; applying the material for the first primer film through the at least one opening of the mask and onto the third metallic layer to form the patterned feature; positioning the substrate comprising the base layer, the first metallic layer, the first primer layer, the second layer, the second metallic layer, the second primer layer, the third layer, the third metallic layer, and the first primer film comprising the patterned feature under a second target comprising a material for forming the second primer film; and applying the material for forming the second primer film over at least a portion of the patterned feature of the first primer film.

Clause 374: The method of clause 335, wherein the patterned feature is formed in the second primer film of the third primer layer, wherein the patterned feature is formed by: applying the first primer film over at least a portion of the third metallic layer; positioning a mask over at least a portion of the substrate comprising the base layer, the first metallic layer, the first primer layer, the second layer, the second metallic layer, the second primer layer, the third layer, the third metallic layer, and the first primer film, wherein the mask comprises at least one opening; applying a material for forming the second primer film through the at least one opening of the mask and onto the first primer film; and removing the mask from the substrate.

Clause 375: The method of clause 335, wherein the patterned feature is formed in the second primer film of the third primer layer, wherein the patterned feature is formed by: applying the first primer film over at least a portion of the third metallic layer; positioning a mask between the substrate comprising the base layer, the first metallic layer, the first primer layer, the second layer, the second metallic layer, the second primer layer, the third layer, the third metallic layer, and the first primer film and a target comprising a material for forming the second primer film, wherein the mask comprises at least one opening; and applying the material for forming the second primer film through the at least one opening of the mask and onto the first primer film.

Clause 376: The method of any one of clauses 372 to 375, wherein the first primer film is selected from the group consisting of titanium, silicon, tin, silicon dioxide, silicon nitride, silicon oxynitride, nickel, zirconium, zinc, aluminum, cobalt, chromium, alloys thereof, and mixtures thereof.

Clause 377: The method of any one of clauses 372 to 375, wherein the second primer film is selected from the group consisting of titanium, silicon, tin, silicon dioxide, silicon nitride, silicon oxynitride, nickel, zirconium, zinc, aluminum, cobalt, chromium, alloys thereof, and mixtures thereof.

Clause 378: The method of any one of clauses 372, 373, 376, and 377, wherein when the first primer film comprises the patterned feature, the patterned feature of the first primer film comprises a thickness in a range of from 1 nm to 20 nm, such as from 1 nm to 15 nm, such as from 1 nm to 10 nm, or such as from 1 nm to 8 nm and the second primer film comprises a thickness in a range of from 0.5 nm to 10 nm, such as from 0.5 nm to 8 nm, or such as from 1 nm to 6 nm.

Clause 379: The method of any one of clauses 374 to 377, wherein when the second primer film comprises the patterned feature, the first primer film comprises a thickness in a range of from 0.5 nm to 10 nm, such as from 0.5 nm to 8 nm, or such as from 1 nm to 6 nm and the patterned feature of the second primer film comprises a thickness in the range of from 1 nm to 20 nm, such as from 1 nm to 15 nm, such as from 1 nm to 10 nm, or such as from 1 nm to 8 nm.

Clause 380: The method of any one of clauses 372 to 379, wherein the first primer film comprises titanium and the second primer film comprises aluminum zinc.

Clause 381: The method of any one of clauses 372 to 379, wherein the first primer film comprises titanium and the second primer film comprises tin.

Clause 382: The method of any one of clauses 372 to 379, wherein the first primer film comprises titanium and the second primer film comprises nickel chromium.

Clause 383: The method of any one of clauses 372 to 282, wherein the patterned feature is a symmetric pattern comprising stripes.

Clause 384: The method of clause 383, wherein the stripes comprise a width of at least 0.1 inch.

Clause 385: The method of clause 383 or 384, wherein the stripes are spaced apart from one another by at least 1.5 inches.

Clause 386: The method of any one of clauses 383 to 385, wherein the stripes are positioned horizontally, vertically, or diagonally across the second surface.

Clause 387: The method of clause 386, wherein the stripes are positioned horizontally across the second surface.

Clause 388: The method of clause 386, wherein the stripes are positioned vertically across the second surface.

Clause 389: The method of any one of clauses 272 to 282, wherein the patterned feature is an asymmetric pattern.

Clause 390: The method of clause 335, wherein the patterned feature is formed in the first primer film of the fourth primer layer, wherein the patterned feature is formed by: positioning a mask over at least a portion of the substrate comprising the base layer, the first metallic layer, the first primer layer, the second layer, the second metallic layer, the second primer layer, the third layer, the third metallic layer, the third primer layer, the fourth layer, and the fourth metallic layer, wherein the mask comprises at least one opening; applying a material for forming the first primer film through the at least one opening of the mask and onto the fourth metallic layer; removing the mask from the substrate; and applying the second primer film over at least a portion of the first primer film.

Clause 391: The method of clause 335, wherein the patterned feature is formed in the first primer film of the fourth primer layer, wherein the patterned feature is formed by: positioning a mask between the substrate comprising the base layer, the first metallic layer, the first primer layer, the second layer, the second metallic layer, the second primer layer, the third layer, the third metallic layer, the third primer layer, the fourth layer, and the fourth metallic layer and a target comprising a material for forming the first primer film, wherein the mask comprises at least one opening; applying the material for forming the first primer film through the at least one opening of the mask and onto the fourth metallic layer; positioning the substrate comprising the base layer, the first metallic layer, the first primer layer, the second layer, the second metallic layer, the second primer layer, the third layer, the third metallic layer, the third primer layer, the fourth layer, the fourth metallic layer, and the first primer film comprising the patterned feature under a second target comprising a material for forming the second primer film; and applying the material for forming the second primer film over at least a portion of the patterned feature of the first primer film.

Clause 392: The method of clause 335, wherein the patterned feature is formed in the second primer film of the fourth primer layer, wherein the patterned feature is formed by: applying the first primer film over at least a portion of the fourth metallic layer; positioning a mask over at least a portion of the substrate comprising the base layer, the first metallic layer, the first primer layer, the second layer, the second metallic layer, the second primer layer, the third layer, the third metallic layer, the third primer layer, the fourth layer, the fourth metallic layer, and the first primer film, wherein the mask comprises at least one opening; applying a material for forming the second primer film through the at least one opening of the mask and onto the first primer film; and removing the mask from the substrate.

Clause 393: The method of clause 335, wherein the patterned feature is formed in the second primer film of the fourth primer layer, wherein the patterned feature is formed by: applying the first primer film over at least a portion of the fourth metallic layer; positioning a mask between the substrate comprising the base layer, the first metallic layer, the first primer layer, the second layer, the second metallic layer, the second primer layer, the third layer, the third metallic layer, the third primer layer, the fourth layer, the fourth metallic layer, and the first primer film and a target comprising a material for forming the second primer film, wherein the mask comprises at least one opening; and applying the material for the second primer film through the at least one opening of the mask and onto the first primer film.

Clause 394: The method of any one of clauses 390 to 393, wherein the first primer film is selected from the group consisting of titanium, silicon, tin, silicon dioxide, silicon nitride, silicon oxynitride, nickel, zirconium, zinc, aluminum, cobalt, chromium, alloys thereof, and mixtures thereof.

Clause 395: The method of any one of clauses 390 to 393, wherein the second primer film is selected from the group consisting of titanium, silicon, tin, silicon dioxide, silicon nitride, silicon oxynitride, nickel, zirconium, zinc, aluminum, cobalt, chromium, alloys thereof, and mixtures thereof.

Clause 396: The method of any one of clauses 390, 391, 394, and 395, wherein when the first primer film comprises the patterned feature, the patterned feature of the first primer film comprises a thickness in a range of from 1 nm to 20 nm, such as from 1 nm to 15 nm, such as from 1 nm to 10 nm, or such as from 1 nm to 8 nm and the second primer film comprises a thickness in a range of from 0.5 nm to 10 nm, such as from 0.5 nm to 8 nm, or such as from 1 nm to 6 nm.

Clause 397: The method of any one of clauses 392 to 395, wherein when the second primer film comprises the patterned feature, the first primer film comprises a thickness in a range of from 0.5 nm to 10 nm, such as from 0.5 nm to 8 nm, or such as from 1 nm to 6 nm and the patterned feature of the second primer film comprises a thickness in the range of from 1 nm to 20 nm, such as from 1 nm to 15 nm, such as from 1 nm to 10 nm, or such as from 1 nm to 8 nm.

Clause 398: The method of any one of clauses 390 to 397, wherein the first primer film comprises titanium and the second primer film comprises aluminum zinc.

Clause 399: The method of any one of clauses 390 to 397, wherein the first primer film comprises titanium and the second primer film comprises tin.

Clause 400: The method of any one of clauses 390 to 397, wherein the first primer film comprises titanium and the second primer film comprises nickel chromium.

Clause 401: The method of any one of clauses 390 to 400, wherein the patterned feature is a symmetric pattern comprising stripes.

Clause 402: The method of clause 401, wherein the stripes comprise a width of at least 0.1 inch.

Clause 403: The method of clause 401 or 402, wherein the stripes are spaced apart from one another by at least 1.5 inches.

Clause 404: The method of any one of clauses 401 to 403, wherein the stripes are positioned horizontally, vertically, or diagonally across the second surface.

Clause 405: The method of clause 404, wherein the stripes are positioned horizontally across the second surface.

Clause 406: The method of clause 404, wherein the stripes are positioned vertically across the second surface.

Clause 407: The method of any one of clauses 390 to 400, wherein the patterned feature is an asymmetric pattern.

Clause 408: The method of any one of clauses 195 to 407, wherein forming the second layer comprises forming a first film over at least a portion of the first primer layer, forming a second film over at least a portion of the first film, and forming a third film over at least a portion of the second film, wherein the first film comprises zinc oxide, the second film comprises zinc stannate, and the third film comprises zinc oxide.

Clause 409: The method of any one of clauses 195 to 408, wherein forming the third layer comprises forming a first film over at least a portion of the second primer layer, forming a second film over at least a portion of the first film, and forming a third film over at least a portion of the second film, wherein the first film comprises zinc oxide, the second film comprises zinc stannate, and the third film comprises zinc oxide.

Clause 410: The method of any one of clauses 195 to 409, wherein forming the fourth layer comprises forming a first film over at least a portion of the third primer layer, forming a second film over at least a portion of the first film, and forming a third film over at least a portion of the second film.

Clause 411: The method of clause 410, wherein the first film comprises zinc oxide, the second film comprises zinc stannate, and the third film comprises zinc oxide.

Clause 412: The method of any one of clauses 195 to 411, wherein the first metallic layer, the second metallic layer, the third metallic layer, and the fourth metallic layer each independently comprise silver, gold, palladium, copper, alloys thereof, mixtures thereof, or combinations thereof.

Clause 413: The method of any one of clauses 195 to 412, wherein the first metallic layer is a continuous metallic layer.

Clause 414: The method of any one of clauses 195 to 413, wherein the second metallic layer is a continuous metallic layer.

Clause 415: The method of any one of clauses 195 to 413, wherein the second metallic layer is a discontinuous metallic layer.

Clause 416: The method of any one of clauses 195 to 415, wherein the third metallic layer is a continuous metallic layer.

Clause 417: The method of any one of clauses 195 to 415, wherein the third metallic layer is a discontinuous metallic layer.

Clause 418: The method of any one of clauses 195 to 417, wherein the fourth metallic layer is a continuous metallic layer.

Clause 419: An insulating glass unit comprising: a first ply comprising a first side comprising a No. 1 surface and a second side comprising a No. 2 surface, wherein the No. 2 surface is opposite the No. 1 surface; a second ply comprising a first side comprising a No. 3 surface and a second side comprising a No. 4 surface, wherein the No. 4 surface opposite the No. 3 surface, wherein the first ply and second ply are connected together; and a functional coating positioned over at least a portion of the second side comprising the No. 2 surface, the functional coating comprising: a base layer positioned over at least a portion of the No. 2 surface; a metallic layer positioned over at least a portion of the base layer; a primer layer comprising a patterned feature positioned over at least a portion of the metallic layer, wherein the primer layer comprises: a first primer film positioned over at least a portion of the metallic layer, and a second primer film positioned over at least a portion of the first primer film, wherein one of the first primer film or the second primer film comprises the patterned feature; and a top layer positioned over at least a portion of the metallic layer.

Clause 420: The insulating glass unit of clause 419, wherein the first primer film is selected from the group consisting of titanium, silicon, tin, silicon dioxide, silicon nitride, silicon oxynitride, nickel, zirconium, zinc, aluminum, cobalt, chromium, alloys thereof, and mixtures thereof.

Clause 421: The insulating glass unit of clause 419, wherein the second primer film is selected from the group consisting of titanium, silicon, tin, silicon dioxide, silicon nitride, silicon oxynitride, nickel, zirconium, zinc, aluminum, cobalt, chromium, alloys thereof, and mixtures thereof.

Clause 422: The insulating glass unit of any one of clauses 419 to 421, wherein when the first primer film comprises the patterned feature, the patterned feature of the first primer film comprises a thickness in a range of from 1 nm to 20 nm, such as from 1 nm to 15 nm, such as from 1 nm to 10 nm, or such as from 1 nm to 8 nm and the second primer film comprises a thickness in a range of from 0.5 nm to 10 nm, such as from 0.5 nm to 8 nm, or such as from 1 nm to 6 nm.

Clause 423: The insulating glass unit of any one of clauses 419 to 421, wherein when the second primer film comprises the patterned feature, the first primer film comprises a thickness in a range of from 0.5 nm to 10 nm, such as from 0.5 nm to 8 nm, or such as from 1 nm to 6 nm and the patterned feature of the second primer film comprises a thickness in the range of from 1 nm to 20 nm, such as from 1 nm to 15 nm, such as from 1 nm to 10 nm, or such as from 1 nm to 8 nm.

Clause 424: The insulating glass unit of any one of clauses 419 to 423, wherein the first primer film comprises titanium and the second primer film comprises aluminum zinc.

Clause 425: The insulating glass unit of any one of clauses 419 to 423, wherein the first primer film comprises titanium and the second primer film comprises tin.

Clause 426: The insulating glass unit of any one of clauses 419 to 423, wherein the first primer film comprises titanium and the second primer film comprises nickel chromium.

Clause 427: The insulating glass unit of any one of clauses 419 to 426, wherein the patterned feature is a symmetric feature comprising stripes.

Clause 428: The insulating glass unit of clause 427, wherein the stripes comprise a width of at least 0.1 inch.

Clause 429: The insulating glass unit of clause 427 or 428, wherein the stripes are spaced apart from one another by at least 1.5 inches.

Clause 430: The insulating glass unit of any of clauses 427 to 429, wherein the stripes are positioned horizontally, vertically, or diagonally across the second surface.

Clause 431: The insulating glass unit of clause 430, wherein the stripes are positioned horizontally across the second surface.

Clause 432: The insulating glass unit of clause 430, wherein the stripes are positioned vertically across the second surface.

Clause 433: The insulating glass unit of any one of clauses 419 to 426, wherein the patterned feature is an asymmetric pattern.

Clause 434: The insulating glass unit of any one of clauses 419 to 433, wherein the base layer comprises a first film positioned over at least a portion of the No. 2 surface and a second film over at least a portion of the first film.

Clause 435: The insulating glass unit of clause 434, wherein the first film comprises zinc stannate, silicon nitride, silicon oxide, silicon aluminum nitride, silicon aluminum oxide, silicon oxynitride, silicon aluminum oxynitride, or tin oxide and the second film comprises zinc oxide or aluminum zinc oxide.

Clause 436: The insulating glass unit of clause 434, wherein the base layer further comprises a third film over at least a portion of the second film, wherein the first film comprises zinc stannate, silicon nitride, silicon oxide, silicon aluminum nitride, silicon aluminum oxide, silicon oxynitride, silicon aluminum oxynitride, or tin oxide, the second film comprises zinc stannate, and the third film comprises zinc oxide or aluminum zinc oxide.

Clause 437: The insulating glass unit of any of clauses 419 to 436, wherein the metallic layer comprises silver, gold, palladium, copper, alloys thereof, mixtures thereof, or combinations thereof.

Clause 438: The insulating glass unit of any of clauses 419 to 437, wherein the metallic layer comprises silver.

Clause 439: The insulating glass unit of any of clauses 419 to 438, wherein the top layer comprises a first film over at least a portion of the primer layer and a second film over at least a portion of the first film.

Clause 440: The insulating glass unit of clause 439, wherein the first film comprises zinc oxide.

Clause 441: The insulating glass unit of clause 439, wherein the second film comprises zinc stannate or tin oxide.

Clause 442: The insulating glass unit of any of clauses 419 to 441, wherein the functional coating further comprises an outermost protective coating comprising a protective layer, wherein the protective layer comprises at least one of Si₃N₄, SiAlN, SiAlON, SiAlO, TiAlO, titania, alumina, silica, zirconia, or combinations thereof.

Clause 443: The insulating glass unit of clause 442, wherein the protective layer comprises titania.

Clause 444: The insulating glass unit of clause 442, wherein the protective layer comprises a first protective film and a second protective film, wherein the second protective film is positioned over at least a portion of the first protective film.

Clause 445: The insulating glass unit of clause 444, wherein the first protective film comprises SiAlO.

Clause 446: The insulating glass unit of clause 444, wherein the second protective film comprises TiAlO.

Clause 447: The insulating glass unit of any of clauses 419 to 446, wherein the substrate comprises glass.

Clause 448: The insulating glass unit of any of clauses 419 to 447, wherein the insulating glass unit is an architectural glazing.

Clause 449: The insulating glass unit of any of clauses 419 to 448, wherein the patterned feature is visible to birds.

Clause 450: The insulating glass unit of any of clauses 419 to 449, wherein the functional coating positioned over at least a portion of the second side comprises: the base layer positioned over at least a portion of the No. 2 surface; a first metallic layer positioned over at least a portion of the base layer; a first primer layer positioned over at least a portion of the first metallic layer; a second layer over at least a portion of the first primer layer; a second metallic layer over at least a portion of the second layer; and a second primer layer over at least a portion of the second metallic layer, wherein the top layer is over at least a portion of the second primer layer, wherein one of the first primer layer or the second primer layer comprises the patterned feature, the first primer film, and the second primer film, and wherein one of the first primer film or the second primer film comprises the patterned feature.

Clause 451: The insulating glass unit of clause 450, wherein the patterned feature is formed in the first primer layer positioned over at least a portion of the first metallic layer, wherein the first primer layer comprises the first primer film positioned over at least a portion of the first metallic layer and the second primer film positioned over at least a portion of the first primer film.

Clause 452: The insulating glass unit of clause 451, wherein the first primer film is selected from the group consisting of titanium, silicon, tin, silicon dioxide, silicon nitride, silicon oxynitride, nickel, zirconium, zinc, aluminum, cobalt, chromium, alloys thereof, and mixtures thereof.

Clause 453: The insulating glass unit of clause 451, wherein the second primer film is selected from the group consisting of titanium, silicon, tin, silicon dioxide, silicon nitride, silicon oxynitride, nickel, zirconium, zinc, aluminum, cobalt, chromium, alloys thereof, and mixtures thereof.

Clause 454: The insulating glass unit of any one of clauses 451 to 453, wherein when the first primer film comprises the patterned feature, the patterned feature of the first primer film comprises a thickness in a range of from 1 nm to 20 nm, such as from 1 nm to 15 nm, such as from 1 nm to 10 nm, or such as from 1 nm to 8 nm and the second primer film comprises a thickness in a range of from 0.5 nm to 10 nm, such as from 0.5 nm to 8 nm, or such as from 1 nm to 6 nm.

Clause 455: The insulating glass unit of any one of clauses 451 to 453, wherein when the second primer film comprises the patterned feature, the first primer film comprises a thickness in a range of from 0.5 nm to 10 nm, such as from 0.5 nm to 8 nm, or such as from 1 nm to 6 nm and the patterned feature of the second primer film comprises a thickness in the range of from 1 nm to 20 nm, such as from 1 nm to 15 nm, such as from 1 nm to 10 nm, or such as from 1 nm to 8 nm.

Clause 456: The insulating glass unit of any one of clauses 451 to 455, wherein the first primer film comprises titanium and the second primer film comprises aluminum zinc.

Clause 457: The insulating glass unit of any one of clauses 451 to 455, wherein the first primer film comprises titanium and the second primer film comprises tin.

Clause 458: The insulating glass unit of any one of clauses 451 to 455, wherein the first primer film comprises titanium and the second primer film comprises nickel chromium.

Clause 459: The insulating glass unit of any one of clauses 451 to 458, wherein the patterned feature is a symmetric feature comprising stripes.

Clause 460: The insulating glass unit of clause 459, wherein the stripes comprise a width of at least 0.1 inch.

Clause 461: The insulating glass unit of clause 459 or 460, wherein the stripes are spaced apart from one another by at least 1.5 inches.

Clause 462: The insulating glass unit of any of clauses 459 to 461, wherein the stripes are positioned horizontally, vertically, or diagonally across the second surface.

Clause 463: The insulating glass unit of clause 462, wherein the stripes are positioned horizontally across the second surface.

Clause 464: The insulating glass unit of clause 462, wherein the stripes are positioned vertically across the second surface.

Clause 465: The insulating glass unit of any one of clauses 451 to 458, wherein the patterned feature is an asymmetric pattern.

Clause 466: The insulating glass unit of clause 450, wherein the patterned feature is formed in the second primer layer positioned over at least a portion of the second metallic layer, wherein the second primer layer comprises the first primer film positioned over at least a portion of the second metallic layer and the second primer film positioned over at least a portion of the first primer film.

Clause 467: The insulating glass unit of clause 466, wherein the first primer film is selected from the group consisting of titanium, silicon, tin, silicon dioxide, silicon nitride, silicon oxynitride, nickel, zirconium, zinc, aluminum, cobalt, chromium, alloys thereof, and mixtures thereof.

Clause 468: The insulating glass unit of clause 466, wherein the second primer film is selected from the group consisting of titanium, silicon, tin, silicon dioxide, silicon nitride, silicon oxynitride, nickel, zirconium, zinc, aluminum, cobalt, chromium, alloys thereof, and mixtures thereof.

Clause 469: The insulating glass unit of any one of clauses 466 to 468, wherein when the first primer film comprises the patterned feature, the patterned feature of the first primer film comprises a thickness in a range of from 1 nm to 20 nm, such as from 1 nm to 15 nm, such as from 1 nm to 10 nm, or such as from 1 nm to 8 nm and the second primer film comprises a thickness in a range of from 0.5 nm to 10 nm, such as from 0.5 nm to 8 nm, or such as from 1 nm to 6 nm.

Clause 470: The insulating glass unit of any one of clauses 466 to 468, wherein when the second primer film comprises the patterned feature, the first primer film comprises a thickness in a range of from 0.5 nm to 10 nm, such as from 0.5 nm to 8 nm, or such as from 1 nm to 6 nm and the patterned feature of the second primer film comprises a thickness in the range of from 1 nm to 20 nm, such as from 1 nm to 15 nm, such as from 1 nm to 10 nm, or such as from 1 nm to 8 nm.

Clause 471: The insulating glass unit of any one of clauses 466 to 470, wherein the first primer film comprises titanium and the second primer film comprises aluminum zinc.

Clause 472: The insulating glass unit of any one of clauses 466 to 470, wherein the first primer film comprises titanium and the second primer film comprises tin.

Clause 473: The insulating glass unit of any one of clauses 466 to 470, wherein the first primer film comprises titanium and the second primer film comprises nickel chromium.

Clause 474: The insulating glass unit of any one of clauses 466 to 473, wherein the patterned feature is a symmetric feature comprising stripes.

Clause 475: The insulating glass unit of clause 474, wherein the stripes comprise a width of at least 0.1 inch.

Clause 476: The insulating glass unit of clause 474 or 475, wherein the stripes are spaced apart from one another by at least 1.5 inches.

Clause 477: The insulating glass unit of any of clauses 474 to 476, wherein the stripes are positioned horizontally, vertically, or diagonally across the second surface.

Clause 478: The insulating glass unit of clause 477, wherein the stripes are positioned horizontally across the second surface.

Clause 479: The insulating glass unit of clause 477, wherein the stripes are positioned vertically across the second surface.

Clause 480: The insulating glass unit of any one of clauses 466 to 473, wherein the patterned feature is an asymmetric pattern.

Clause 481: The insulating glass unit of any one of clauses 450 to 480, wherein the second layer comprises a first film over at least a portion of the first primer layer, a second film over at least a portion of the first film, and a third film over at least a portion of the second film, wherein the first film comprises zinc oxide, the second film comprises zinc stannate, and the third film comprises zinc oxide.

Clause 482: The insulating glass unit of any of clauses 450 to 481, wherein the first metallic layer and the second metallic layer each independently comprise silver, gold, palladium, copper, alloys thereof, mixtures thereof, or combinations thereof.

Clause 483: The insulating glass unit of any of clauses 450 to 482, wherein the first metallic layer and the second metallic layer comprise silver.

Clause 484: The insulating glass unit of any of clauses 450 to 483, wherein the second metallic layer is a continuous layer.

Clause 485: The insulating glass unit of any of clauses 450 to 483, wherein the second metallic layer is a discontinuous layer.

Clause 486: The insulating glass unit of any one of clauses 419 to 449, wherein the functional coating positioned over at least a portion of the second side comprises: the base layer positioned over a least a portion of the No. 2 surface; a first metallic layer positioned over at least a portion of the base layer; a first primer layer positioned over at least a portion of the first metallic layer; a second layer positioned over at least a portion of the first primer layer; a second metallic layer positioned over at least a portion of the second layer; a second primer layer positioned over at least a portion of the second metallic layer; a third layer positioned over at least a portion of the second primer layer; a third metallic layer positioned over at least a portion of the third layer; and a third primer layer positioned over at least a portion of the third metallic layer, wherein the top layer is over at least a portion of the third primer layer, wherein one of the first primer layer, the second primer layer, or the third primer layer comprises the patterned feature, the first primer film, and the second primer film, and wherein one of the first primer film or the second primer film comprises the patterned feature.

Clause 487: The insulating glass unit of clause 486, wherein the patterned feature is formed in the first primer layer positioned over at least a portion of the first metallic layer, wherein the first primer layer comprises the first primer film positioned over at least a portion of the first metallic layer and the second primer film positioned over at least a portion of the first primer film.

Clause 488: The insulating glass unit of clause 487, wherein the first primer film is selected from the group consisting of titanium, silicon, tin, silicon dioxide, silicon nitride, silicon oxynitride, nickel, zirconium, zinc, aluminum, cobalt, chromium, alloys thereof, and mixtures thereof.

Clause 489: The insulating glass unit of clause 487, wherein the second primer film is selected from the group consisting of titanium, silicon, tin, silicon dioxide, silicon nitride, silicon oxynitride, nickel, zirconium, zinc, aluminum, cobalt, chromium, alloys thereof, and mixtures thereof.

Clause 490: The insulating glass unit of any one of clauses 487 to 489, wherein when the first primer film comprises the patterned feature, the patterned feature of the first primer film comprises a thickness in a range of from 1 nm to 20 nm, such as from 1 nm to 15 nm, such as from 1 nm to 10 nm, or such as from 1 nm to 8 nm and the second primer film comprises a thickness in a range of from 0.5 nm to 10 nm, such as from 0.5 nm to 8 nm, or such as from 1 nm to 6 nm.

Clause 491: The insulating glass unit of any one of clauses 487 to 489, wherein when the second primer film comprises the patterned feature, the first primer film comprises a thickness in a range of from 0.5 nm to 10 nm, such as from 0.5 nm to 8 nm, or such as from 1 nm to 6 nm and the patterned feature of the second primer film comprises a thickness in the range of from 1 nm to 20 nm, such as from 1 nm to 15 nm, such as from 1 nm to 10 nm, or such as from 1 nm to 8 nm.

Clause 492: The insulating glass unit of any one of clauses 487 to 491, wherein the first primer film comprises titanium and the second primer film comprises aluminum zinc.

Clause 493: The insulating glass unit of any one of clauses 487 to 491, wherein the first primer film comprises titanium and the second primer film comprises tin.

Clause 494: The insulating glass unit of any one of clauses 487 to 491, wherein the first primer film comprises titanium and the second primer film comprises nickel chromium.

Clause 495: The insulating glass unit of any one of clauses 487 to 494, wherein the patterned feature is a symmetric feature comprising stripes.

Clause 496: The insulating glass unit of clause 495, wherein the stripes comprise a width of at least 0.1 inch.

Clause 497: The insulating glass unit of clause 495 or 496, wherein the stripes are spaced apart from one another by at least 1.5 inches.

Clause 498: The insulating glass unit of any of clauses 495 to 497, wherein the stripes are positioned horizontally, vertically, or diagonally across the second surface.

Clause 499: The insulating glass unit of clause 498, wherein the stripes are positioned horizontally across the second surface.

Clause 500: The insulating glass unit of clause 498, wherein the stripes are positioned vertically across the second surface.

Clause 501: The insulating glass unit of any one of clauses 487 to 494, wherein the patterned feature is an asymmetric pattern.

Clause 502: The insulating glass unit of clause 486, wherein the patterned feature is formed in the second primer layer positioned over at least a portion of the second metallic layer, wherein the second primer layer comprises the first primer film positioned over at least a portion of the second metallic layer and the second primer film positioned over at least a portion of the first primer film.

Clause 503: The insulating glass unit of clause 502, wherein the first primer film is selected from the group consisting of titanium, silicon, tin, silicon dioxide, silicon nitride, silicon oxynitride, nickel, zirconium, zinc, aluminum, cobalt, chromium, alloys thereof, and mixtures thereof.

Clause 504: The insulating glass unit of clause 502, wherein the second primer film is selected from the group consisting of titanium, silicon, tin, silicon dioxide, silicon nitride, silicon oxynitride, nickel, zirconium, zinc, aluminum, cobalt, chromium, alloys thereof, and mixtures thereof.

Clause 505: The insulating glass unit of any one of clauses 502 to 504, wherein when the first primer film comprises the patterned feature, the patterned feature of the first primer film comprises a thickness in a range of from 1 nm to 20 nm, such as from 1 nm to 15 nm, such as from 1 nm to 10 nm, or such as from 1 nm to 8 nm and the second primer film comprises a thickness in a range of from 0.5 nm to 10 nm, such as from 0.5 nm to 8 nm, or such as from 1 nm to 6 nm.

Clause 506: The insulating glass unit of any one of clauses 502 to 504, wherein when the second primer film comprises the patterned feature, the first primer film comprises a thickness in a range of from 0.5 nm to 10 nm, such as from 0.5 nm to 8 nm, or such as from 1 nm to 6 nm and the patterned feature of the second primer film comprises a thickness in the range of from 1 nm to 20 nm, such as from 1 nm to 15 nm, such as from 1 nm to 10 nm, or such as from 1 nm to 8 nm.

Clause 507: The insulating glass unit of any one of clauses 502 to 506, wherein the first primer film comprises titanium and the second primer film comprises aluminum zinc.

Clause 508: The insulating glass unit of any one of clauses 502 to 506, wherein the first primer film comprises titanium and the second primer film comprises tin.

Clause 509: The insulating glass unit of any one of clauses 502 to 506, wherein the first primer film comprises titanium and the second primer film comprises nickel chromium.

Clause 510: The insulating glass unit of any one of clauses 502 to 509, wherein the patterned feature is a symmetric feature comprising stripes.

Clause 511: The insulating glass unit of clause 510, wherein the stripes comprise a width of at least 0.1 inch.

Clause 512: The insulating glass unit of clause 510 or 511, wherein the stripes are spaced apart from one another by at least 1.5 inches.

Clause 513: The insulating glass unit of any of clauses 510 to 512, wherein the stripes are positioned horizontally, vertically, or diagonally across the second surface.

Clause 514: The insulating glass unit of clause 513, wherein the stripes are positioned horizontally across the second surface.

Clause 515: The insulating glass unit of clause 513, wherein the stripes are positioned vertically across the second surface.

Clause 516: The insulating glass unit of any one of clauses 502 to 509, wherein the patterned feature is an asymmetric pattern.

Clause 517: The insulating glass unit of clause 486, wherein the patterned feature is formed in the third primer layer positioned over at least a portion of the third metallic layer, wherein the third primer layer comprises the first primer film positioned over at least a portion of the third metallic layer and the second primer film positioned over at least a portion of the first primer film.

Clause 518: The insulating glass unit of clause 517, wherein the first primer film is selected from the group consisting of titanium, silicon, tin, silicon dioxide, silicon nitride, silicon oxynitride, nickel, zirconium, zinc, aluminum, cobalt, chromium, alloys thereof, and mixtures thereof.

Clause 519: The insulating glass unit of clause 517, wherein the second primer film is selected from the group consisting of titanium, silicon, tin, silicon dioxide, silicon nitride, silicon oxynitride, nickel, zirconium, zinc, aluminum, cobalt, chromium, alloys thereof, and mixtures thereof.

Clause 520: The insulating glass unit of any one of clauses 517 to 519, wherein when the first primer film comprises the patterned feature, the patterned feature of the first primer film comprises a thickness in a range of from 1 nm to 20 nm, such as from 1 nm to 15 nm, such as from 1 nm to 10 nm, or such as from 1 nm to 8 nm and the second primer film comprises a thickness in a range of from 0.5 nm to 10 nm, such as from 0.5 nm to 8 nm, or such as from 1 nm to 6 nm.

Clause 521: The insulating glass unit of any one of clauses 517 to 519, wherein when the second primer film comprises the patterned feature, the first primer film comprises a thickness in a range of from 0.5 nm to 10 nm, such as from 0.5 nm to 8 nm, or such as from 1 nm to 6 nm and the patterned feature of the second primer film comprises a thickness in the range of from 1 nm to 20 nm, such as from 1 nm to 15 nm, such as from 1 nm to 10 nm, or such as from 1 nm to 8 nm.

Clause 522: The insulating glass unit of any one of clauses 517 to 521, wherein the first primer film comprises titanium and the second primer film comprises aluminum zinc.

Clause 523: The insulating glass unit of any one of clauses 517 to 521, wherein the first primer film comprises titanium and the second primer film comprises tin.

Clause 524: The insulating glass unit of any one of clauses 517 to 521, wherein the first primer film comprises titanium and the second primer film comprises nickel chromium.

Clause 525: The insulating glass unit of any one of clauses 517 to 524, wherein the patterned feature is a symmetric feature comprising stripes.

Clause 526: The insulating glass unit of clause 525, wherein the stripes comprise a width of at least 0.1 inch.

Clause 527: The insulating glass unit of clause 525 or 526, wherein the stripes are spaced apart from one another by at least 1.5 inches.

Clause 528: The insulating glass unit of any of clauses 525 to 527, wherein the stripes are positioned horizontally, vertically, or diagonally across the second surface.

Clause 529: The insulating glass unit of clause 528, wherein the stripes are positioned horizontally across the second surface.

Clause 530: The insulating glass unit of clause 528, wherein the stripes are positioned vertically across the second surface.

Clause 531: The insulating glass unit of any one of clauses 517 to 524, wherein the patterned feature is an asymmetric pattern.

Clause 532: The insulating glass unit of any one of clauses 486 to 531, wherein the second layer comprises a first film positioned over at least a portion of the first primer layer, a second film positioned over at least a portion of the first film, and a third film positioned over at least a portion of the second film, wherein the first film comprises zinc oxide, the second film comprises zinc stannate, and the third film comprises zinc oxide.

Clause 533: The insulating glass unit of any one of clauses 486 to 532, wherein the third layer comprises a first film positioned over at least a portion of the second primer layer, a second film positioned over at least a portion of the first film, and a third film positioned over at least a portion of the second film, wherein the first film comprises zinc oxide, the second film comprises zinc stannate, and the third film comprises zinc oxide.

Clause 534: The insulating glass unit of any one of clauses 486 to 533, wherein the first metallic layer, the second metallic layer, and the third metallic layer each independently comprise silver, gold, palladium, copper, alloys thereof, mixtures thereof, or combinations thereof.

Clause 535: The insulating glass unit of any one of clauses 486 to 534, wherein the first metallic layer is a continuous metallic layer.

Clause 536: The insulating glass unit of any one of clauses 486 to 535, wherein the second metallic layer is a continuous metallic layer.

Clause 537: The insulating glass unit of any one of clauses 486 to 535, wherein the second metallic layer is a discontinuous metallic layer.

Clause 538: The insulating glass unit of any one of clauses 486 to 537, wherein the third metallic layer is a continuous metallic layer.

Clause 539: The insulating glass unit of any one of clauses 486 to 537, wherein the third metallic layer is a discontinuous metallic layer.

Clause 540: The insulating glass unit of any one of clauses 419 to 449, wherein the functional coating positioned over at least a portion of the second side comprises: the base layer positioned over at least a portion of the No. 2 surface; a first metallic layer positioned over at least a portion of the base layer; a first primer layer positioned over at least a portion of the first metallic layer; a second layer positioned over at least a portion of the first primer layer; a second metallic layer positioned over at least a portion of the second layer; a second primer layer positioned over at least a portion of the second metallic layer; a third layer positioned over at least a portion of the second primer layer; a third metallic layer positioned over at least a portion of the third layer; a third primer layer positioned over at least a portion of the third metallic layer; a fourth layer positioned over at least a portion of the third primer layer; a fourth metallic layer positioned over at least a portion of the fourth layer; and a fourth primer layer positioned over at least a portion of the fourth metallic layer, wherein the top layer is over at least a portion of the fourth primer layer, wherein one of the first primer layer, the second primer layer, the third primer layer, or the fourth primer layer comprises the patterned feature, the first primer film, and the second primer film, and wherein one of the first primer film or the second primer film comprises the patterned feature.

Clause 541: The insulating glass unit of clause 540, wherein the patterned feature is formed in the first primer layer positioned over at least a portion of the first metallic layer, wherein the first primer layer comprises the first primer film positioned over at least a portion of the first metallic layer and the second primer film positioned over at least a portion of the first primer film.

Clause 542: The insulating glass unit of clause 541, wherein the first primer film is selected from the group consisting of titanium, silicon, tin, silicon dioxide, silicon nitride, silicon oxynitride, nickel, zirconium, zinc, aluminum, cobalt, chromium, alloys thereof, and mixtures thereof.

Clause 543: The insulating glass unit of clause 541, wherein the second primer film is selected from the group consisting of titanium, silicon, tin, silicon dioxide, silicon nitride, silicon oxynitride, nickel, zirconium, zinc, aluminum, cobalt, chromium, alloys thereof, and mixtures thereof.

Clause 544: The insulating glass unit of any one of clauses 541 to 543, wherein when the first primer film comprises the patterned feature, the patterned feature of the first primer film comprises a thickness in a range of from 1 nm to 20 nm, such as from 1 nm to 15 nm, such as from 1 nm to 10 nm, or such as from 1 nm to 8 nm and the second primer film comprises a thickness in a range of from 0.5 nm to 10 nm, such as from 0.5 nm to 8 nm, or such as from 1 nm to 6 nm.

Clause 545: The insulating glass unit of any one of clauses 541 to 543, wherein when the second primer film comprises the patterned feature, the first primer film comprises a thickness in a range of from 0.5 nm to 10 nm, such as from 0.5 nm to 8 nm, or such as from 1 nm to 6 nm and the patterned feature of the second primer film comprises a thickness in the range of from 1 nm to 20 nm, such as from 1 nm to 15 nm, such as from 1 nm to 10 nm, or such as from 1 nm to 8 nm.

Clause 546: The insulating glass unit of any one of clauses 541 to 545, wherein the first primer film comprises titanium and the second primer film comprises aluminum zinc.

Clause 547: The insulating glass unit of any one of clauses 541 to 545, wherein the first primer film comprises titanium and the second primer film comprises tin.

Clause 548: The insulating glass unit of any one of clauses 541 to 545, wherein the first primer film comprises titanium and the second primer film comprises nickel chromium.

Clause 549: The insulating glass unit of any one of clauses 541 to 548, wherein the patterned feature is a symmetric feature comprising stripes.

Clause 550: The insulating glass unit of clause 549, wherein the stripes comprise a width of at least 0.1 inch.

Clause 551: The insulating glass unit of clause 549 or 550, wherein the stripes are spaced apart from one another by at least 1.5 inches.

Clause 552: The insulating glass unit of any of clauses 549 to 551, wherein the stripes are positioned horizontally, vertically, or diagonally across the second surface.

Clause 553: The insulating glass unit of clause 552, wherein the stripes are positioned horizontally across the second surface.

Clause 554: The coated article of clause 552, wherein the stripes are positioned vertically across the second surface.

Clause 555: The insulating glass unit of any one of clauses 541 to 548, wherein the patterned feature is an asymmetric pattern.

Clause 556: The insulating glass unit of clause 540, wherein the patterned feature is formed in the second primer layer positioned over at least a portion of the second metallic layer, wherein the second primer layer comprises the first primer film positioned over at least a portion of the second metallic layer and the second primer film positioned over at least a portion of the first primer film.

Clause 557: The insulating glass unit of clause 556, wherein the first primer film is selected from the group consisting of titanium, silicon, tin, silicon dioxide, silicon nitride, silicon oxynitride, nickel, zirconium, zinc, aluminum, cobalt, chromium, alloys thereof, and mixtures thereof.

Clause 558: The insulating glass unit of clause 556, wherein the second primer film is selected from the group consisting of titanium, silicon, tin, silicon dioxide, silicon nitride, silicon oxynitride, nickel, zirconium, zinc, aluminum, cobalt, chromium, alloys thereof, and mixtures thereof.

Clause 559: The insulating glass unit of any one of clauses 556 to 558, wherein when the first primer film comprises the patterned feature, the patterned feature of the first primer film comprises a thickness in a range of from 1 nm to 20 nm, such as from 1 nm to 15 nm, such as from 1 nm to 10 nm, or such as from 1 nm to 8 nm and the second primer film comprises a thickness in a range of from 0.5 nm to 10 nm, such as from 0.5 nm to 8 nm, or such as from 1 nm to 6 nm.

Clause 560: The insulating glass unit of any one of clauses 556 to 558, wherein when the second primer film comprises the patterned feature, the first primer film comprises a thickness in a range of from 0.5 nm to 10 nm, such as from 0.5 nm to 8 nm, or such as from 1 nm to 6 nm and the patterned feature of the second primer film comprises a thickness in the range of from 1 nm to 20 nm, such as from 1 nm to 15 nm, such as from 1 nm to 10 nm, or such as from 1 nm to 8 nm.

Clause 561: The insulating glass unit of any one of clauses 556 to 560, wherein the first primer film comprises titanium and the second primer film comprises aluminum zinc.

Clause 562: The insulating glass unit of any one of clauses 556 to 560, wherein the first primer film comprises titanium and the second primer film comprises tin.

Clause 563: The insulating glass unit of any one of clauses 556 to 560, wherein the first primer film comprises titanium and the second primer film comprises nickel chromium.

Clause 564: The insulating glass unit of any one of clauses 556 to 563, wherein the patterned feature is a symmetric feature comprising stripes.

Clause 565: The insulating glass unit of clause 564, wherein the stripes comprise a width of at least 0.1 inch.

Clause 566: The insulating glass unit of clause 564 or 565, wherein the stripes are spaced apart from one another by at least 1.5 inches.

Clause 567: The insulating glass unit of any of clauses 564 to 566, wherein the stripes are positioned horizontally, vertically, or diagonally across the second surface.

Clause 568: The insulating glass unit of clause 567, wherein the stripes are positioned horizontally across the second surface.

Clause 569: The insulating glass unit of clause 567, wherein the stripes are positioned vertically across the second surface.

Clause 570: The insulating glass unit of any one of clauses 556 to 563, wherein the patterned feature is an asymmetric pattern.

Clause 571: The insulating glass unit of clause 540, wherein the patterned feature is formed in the third primer layer positioned over at least a portion of the third metallic layer, wherein the third primer layer comprises the first primer film positioned over at least a portion of the third metallic layer and the second primer film positioned over at least a portion of the first primer film.

Clause 572: The insulating glass unit of clause 571, wherein the first primer film is selected from the group consisting of titanium, silicon, tin, silicon dioxide, silicon nitride, silicon oxynitride, nickel, zirconium, zinc, aluminum, cobalt, chromium, alloys thereof, and mixtures thereof.

Clause 573: The insulating glass unit of clause 571, wherein the second primer film is selected from the group consisting of titanium, silicon, tin, silicon dioxide, silicon nitride, silicon oxynitride, nickel, zirconium, zinc, aluminum, cobalt, chromium, alloys thereof, and mixtures thereof.

Clause 574: The insulating glass unit of any one of clauses 571 to 573, wherein when the first primer film comprises the patterned feature, the patterned feature of the first primer film comprises a thickness in a range of from 1 nm to 20 nm, such as from 1 nm to 15 nm, such as from 1 nm to 10 nm, or such as from 1 nm to 8 nm and the second primer film comprises a thickness in a range of from 0.5 nm to 10 nm, such as from 0.5 nm to 8 nm, or such as from 1 nm to 6 nm.

Clause 575: The insulating glass unit of any one of clauses 571 to 573, wherein when the second primer film comprises the patterned feature, the first primer film comprises a thickness in a range of from 0.5 nm to 10 nm, such as from 0.5 nm to 8 nm, or such as from 1 nm to 6 nm and the patterned feature of the second primer film comprises a thickness in the range of from 1 nm to 20 nm, such as from 1 nm to 15 nm, such as from 1 nm to 10 nm, or such as from 1 nm to 8 nm.

Clause 576: The insulating glass unit of any one of clauses 571 to 575, wherein the first primer film comprises titanium and the second primer film comprises aluminum zinc.

Clause 577: The insulating glass unit of any one of clauses 571 to 575, wherein the first primer film comprises titanium and the second primer film comprises tin.

Clause 578: The insulating glass unit of any one of clauses 571 to 575, wherein the first primer film comprises titanium and the second primer film comprises nickel chromium.

Clause 579: The insulating glass unit of any one of clauses 571 to 578, wherein the patterned feature is a symmetric feature comprising stripes.

Clause 580: The insulating glass unit of clause 579, wherein the stripes comprise a width of at least 0.1 inch.

Clause 581: The insulating glass unit of clause 579 or 580, wherein the stripes are spaced apart from one another by at least 1.5 inches.

Clause 582: The insulating glass unit of any of clauses 579 to 581, wherein the stripes are positioned horizontally, vertically, or diagonally across the second surface.

Clause 583: The insulating glass unit of clause 582, wherein the stripes are positioned horizontally across the second surface.

Clause 584: The insulating glass unit of clause 582, wherein the stripes are positioned vertically across the second surface.

Clause 585: The insulating glass unit of any one of clauses 571 to 578, wherein the patterned feature is an asymmetric pattern.

Clause 586: The insulating glass unit of clause 540, wherein the patterned feature is formed in the fourth primer layer positioned over at least a portion of the fourth metallic layer, wherein the fourth primer layer comprises the first primer film positioned over at least a portion of the fourth metallic layer and the second primer film positioned over at least a portion of the first primer film.

Clause 587: The insulating glass unit of clause 586, wherein the first primer film is selected from the group consisting of titanium, silicon, tin, silicon dioxide, silicon nitride, silicon oxynitride, nickel, zirconium, zinc, aluminum, cobalt, chromium, alloys thereof, and mixtures thereof.

Clause 588: The insulating glass unit of clause 586, wherein the second primer film is selected from the group consisting of titanium, silicon, tin, silicon dioxide, silicon nitride, silicon oxynitride, nickel, zirconium, zinc, aluminum, cobalt, chromium, alloys thereof, and mixtures thereof.

Clause 589: The insulating glass unit of any one of clauses 586 to 588, wherein when the first primer film comprises the patterned feature, the patterned feature of the first primer film comprises a thickness in a range of from 1 nm to 20 nm, such as from 1 nm to 15 nm, such as from 1 nm to 10 nm, or such as from 1 nm to 8 nm and the second primer film comprises a thickness in a range of from 0.5 nm to 10 nm, such as from 0.5 nm to 8 nm, or such as from 1 nm to 6 nm.

Clause 590: The insulating glass unit of any one of clauses 586 to 588601, wherein when the second primer film comprises the patterned feature, the first primer film comprises a thickness in a range of from 0.5 nm to 10 nm, such as from 0.5 nm to 8 nm, or such as from 1 nm to 6 nm and the patterned feature of the second primer film comprises a thickness in the range of from 1 nm to 20 nm, such as from 1 nm to 15 nm, such as from 1 nm to 10 nm, or such as from 1 nm to 8 nm.

Clause 591: The insulating glass unit of any one of clauses 586 to 590, wherein the first primer film comprises titanium and the second primer film comprises aluminum zinc.

Clause 592: The insulating glass unit of any one of clauses 586 to 590, wherein the first primer film comprises titanium and the second primer film comprises tin.

Clause 593: The insulating glass unit of any one of clauses 586 to 590, wherein the first primer film comprises titanium and the second primer film comprises nickel chromium.

Clause 594: The insulating glass unit of any one of clauses 586 to 593, wherein the patterned feature is a symmetric feature comprising stripes.

Clause 595: The insulating glass unit of clause 594, wherein the stripes comprise a width of at least 0.1 inch.

Clause 596: The insulating glass unit of clause 594 or 595, wherein the stripes are spaced apart from one another by at least 1.5 inches.

Clause 597: The insulating glass unit of any of clauses 594 to 596, wherein the stripes are positioned horizontally, vertically, or diagonally across the second surface.

Clause 598: The insulating glass unit of clause 597, wherein the stripes are positioned horizontally across the second surface.

Clause 599: The insulating glass unit of clause 597, wherein the stripes are positioned vertically across the second surface.

Clause 600: The insulating glass unit of any one of clauses 586 to 593, wherein the patterned feature is an asymmetric pattern.

Clause 601: The insulating glass unit of any one of clauses 540 to 600, wherein the second layer comprises a first film positioned over at least a portion of the first primer layer, a second film positioned over at least a portion of the first film, and the third film positioned over at least a portion of the second film, wherein the first film comprises zinc oxide, the second film comprises zinc stannate, and the third film comprises zinc oxide.

Clause 602: The insulating glass unit of any one of clauses 540 to 601, wherein the third layer comprises a first film positioned over at least a portion of the second primer layer, a second film positioned over at least a portion of the first film, and a third film positioned over at least a portion of the second film, wherein the first film comprises zinc oxide, the second film comprises zinc stannate, and the third film comprises zinc oxide.

Clause 603: The insulating glass unit of any one of clauses 540 to 602, wherein the fourth layer comprises a first film positioned over at least a portion of the third primer layer, a second film positioned over at least a portion of the first film, and a third film positioned over at least a portion of the second film.

Clause 604: The insulating glass unit of clause 603, wherein the first film comprises zinc oxide, the second film comprises zinc stannate, and the third film comprises zinc oxide.

Clause 605: The insulating glass unit of any one of clauses 540 to 604, wherein the first metallic, the second metallic layer, the third metallic layer, and the fourth metallic layer each independently comprise silver, gold, palladium, copper, alloys thereof, mixtures thereof, or combinations thereof.

Clause 606: The insulating glass unit of any one of clauses 540 to 605, wherein the first metallic layer is a continuous metallic layer.

Clause 607: The insulating glass unit of any one of clauses 540 to 606, wherein the second metallic layer is a continuous metallic layer.

Clause 608: The insulating glass unit of any one of clauses 540 to 606, wherein the second metallic layer is a discontinuous metallic layer.

Clause 609: The insulating glass unit of any one of clauses 540 to 608, wherein the third metallic layer is a continuous metallic layer.

Clause 610: The insulating glass unit of any one of clauses 540 to 608, wherein the third metallic layer is a discontinuous metallic layer.

Clause 611: The insulating glass unit of any one of clauses 540 to 610, wherein the fourth metallic layer is a continuous metallic layer.

### EXAMPLES

Coated articles having functional coatings according to Tables 1 and 2 were prepared. The functional coatings were applied to the No. 2 surface of a clear glass substrate, wherein the glass substrate had a thickness of 6 mm. A stainless steel sheet having strips removed was prepared as a mask.

For Examples 1, 2, 5, and 6, the mask was positioned between the target and the substrate, and the target was used to deposit the material for forming the second primer film (aluminum zinc (AZ)). The mask was positioned between the target and the glass substrate having the first primer film. The material for forming the second primer film (AZ) was then applied through the openings of the mask and deposited onto the first primer film to form a symmetric patterned feature. Therefore, the second AZ primer film was patterned. The AZ primer film comprised 97 wt. % zinc and 3 wt. % aluminum. The first film of the second layer (zinc oxide) was then deposited over the first primer film and the second primer film.

For Examples 3 and 4, the mask was positioned between the target and the substrate, and the target was used to deposit the material for forming the first primer film (AZ). The mask was positioned between the target and the substrate having the first metallic layer. The material for forming the first primer film (AZ) was then applied through the openings of the mask and deposited onto the first metallic layer to form a symmetric patterned feature. The second primer film (titanium (Ti)) was then deposited over the first primer film. Therefore, the first AZ primer film was patterned.

In Tables 1 and 2, tin oxide is designated as SnOₓ, zinc stannate is designated as ZnSn, zinc oxide is designated as Zn90, aluminum zinc is designated as AZ, titanium is designated as Ti, and titania is designated as TiOₓ.

TABLE 1

| Layer | | Sample 1 | Sample 2 | Sample 3 | Sample 4 | Sample 5 |
|---|---|---|---|---|---|---|
| Base Layer | 1^{st} Film | SnOₓ | SnOₓ | SnOₓ | SnOₓ | SnOₓ |
| | 2^{nd} Film | ZnSn | ZnSn | ZnSn | ZnSn | ZnSn |
| | 3^{rd} Film | Zn90 | Zn90 | Zn90 | Zn90 | Zn90 |
| First Metallic Layer | | Silver | Silver | Silver | Silver | Silver |
| First Primer | 1^{st} Primer Film | Ti | Ti | AZ | AZ | Ti |
| Layer | | | | (2.5 nm) | (3.5 nm) | |
| | 2^{nd} Primer Film | AZ | AZ | Ti | Ti | AZ |
| | | (2.5 nm) | (3.5 nm) | | | (3.5 nm) |
| Second Layer | 1^{st} Film | Zn90 | Zn90 | Zn90 | Zn90 | Zn90 |
| | 2^{nd} Film | ZnSn | ZnSn | ZnSn | ZnSn | ZnSn |
| | 3^{rd} Film | Zn90 | Zn90 | Zn90 | Zn90 | Zn90 |
| Second Metallic Layer | | Silver | Silver | Silver | Silver | Silver |
| Second Primer Layer | | Ti | Ti | Ti | Ti | Ti |
| Top Layer | 1^{st} Film | Zn90 | Zn90 | Zn90 | Zn90 | Zn90 |
| | 2^{nd} Film | ZnSn | ZnSn | ZnSn | ZnSn | ZnSn |

| | | | | | |
|---|---|---|---|---|---|
| Outermost Protective Coating | TiOₓ | TiOₓ | TiOₓ | TiOₓ | TiOₓ |

TABLE 2

| | |
|---|---|
| Layer | Sample 6 |

| | Base Layer | 1^{st} Film | SnOₓ |
|---|---|---|---|
| | | 2^{nd} Film | ZnSn |
| | | 3^{rd} Film | Zn90 |
| First Metallic Layer | | | Silver |
| | First Primer | 1^{st} Primer Film | Ti |
| | Layer | 2^{nd} Primer Film | AZ (2 nm) |
| | Second Layer | 1^{st} Film | Zn90 |
| | | 2^{nd} Film | ZnSn |
| | | 3^{rd} Film | Zn90 |
| Second Metallic Layer | | | Silver |
| Second Primer Layer | | | Ti |
| | Third Layer | 1^{st} Film | Zn90 |
| | | 2^{nd} Film | ZnSn |
| | | 3^{rd} Film | Zn90 |
| Third Metallic Layer | | | Silver |
| Third Primer Layer | | | Ti |
| | Top Layer | 1^{st} Film | Zn90 |
| | | 2^{nd} Film | ZnSn |

| | |
|---|---|
| Outermost Protective Coating | TiOₓ |

When Samples 1, 2, 5, and 6 were placed outside, the patterned feature was visible. When Samples 3 and 4 were placed outside, the patterned feature was not visible.

Sample 5 was subjected to Tunnel Testing at the American Bird Conservancy to test the ability of glass substrates to deter bird collisions. Sample 5 exhibited a threat factor of less than 30, which indicated that the coated article had the ability to deter bird collisions.

Insulating glass units (IGU) were modeled using Samples 1 and 2 as the first substrate of the IGU. The second substrate of the IGU was a clear glass substrate having a 6 mm thickness. The No. 3 surface of the second glass substrate faced the functional coating on the No. 2 surface of the first substrate. The first and second substrates were spaced apart using a 0.5 inch air gap. IGU 1 utilized the coated article of Sample 1 and IGU 2 utilized the coated article of Sample 2. A reference IGU was also modeled. The reference IGU used a first clear glass substrate having a functional coating without a patterned primer layer on the No. 2 surface, a second clear glass substrate, and the 0.5 inch air gap. The resulting optical properties of the modeled IGUs are provided in Table 3. In Table 2, LTA is the visible light transmittance, Rₑₓₜ is the exterior reflection, Rᵢₙₜ is the interior reflection, LSG is the light to solar gain ratio, and SHGC is the solar heat gain coefficient.

TABLE 3

| | | | | | | U Factor | | | |
|---|---|---|---|---|---|---|---|---|---|
| | LTA | Rₑₓₜ | Rᵢₙₜ | | | Winter | | Summer | |
| IGU | (%) | (%) | (%) | LSG | SHGC | Btu/h · ft² · F | W/m² · K | Btu/h · ft² · F | W/m² · K |
| 1 | 53.6 | 15.9 | 10.8 | 1.71 | 0.314 | 0.288 | 1.638 | 0.269 | 1.528 |
| 2 | 57.8 | 15.9 | 11.9 | 1.75 | 0.330 | 0.288 | 1.638 | 0.269 | 1.528 |
| Ref. | 69.5 | 14.3 | 15.0 | 1.97 | 0.352 | 0.289 | 1.639 | 0.269 | 1.529 |

IGU 1 and IGU 2 each had a lower interior reflectance, lower LSG, and lower SHGC than the Reference IGU.

The color properties of the modeled IGUs can be found in Table 4.

TABLE 4

| | Transmitted | | | Reflected Exterior | | |
|---|---|---|---|---|---|---|
| IGU | L* | a* | b* | L* | a* | b* |
| 1 | 78.25 | −3.17 | 2.02 | 47.05 | 2.27 | −11.26 |
| 2 | 80.62 | −2.63 | 2.86 | 47.02 | 2.63 | −11.69 |
| Ref. | 86.75 | −4.14 | 3.44 | 44.83 | −1.92 | −6.92 |

### Prophetic Examples

Substrates may be coated with the functional coatings according to Tables 5 and 6. The substrates may be glass.

In Tables 5 and 6, the * indicates the primer film that comprises the patterned feature, Ag represents silver, AZ represents aluminum zinc, and NiCr represents nickel chromium. The base layer, second layer, third layer, fourth layer, top layer, and outermost protective coating may be any of the base layers, second layers, third layers, fourth layers, top layers, and outermost protective layers described herein. The compositions of the first primer film and second primer film of any of the examples provided in Tables 5 and 6 may optionally be switched.

TABLE 5

| Ex. | Ex. | Ex. | Ex. | Ex. | Ex. | Ex. | Ex. | Ex. | Ex. | Ex. | Ex. | Ex. | Ex. | Ex. | Ex. | Ex. |
|---|---|---|---|---|---|---|---|---|---|---|---|---|---|---|---|---|
| 1 | 2 | 3 | 4 | 5 | 6 | 7 | 8 | 9 | 10 | 11 | 12 | 13 | 14 | 15 | 16 | 17 |

Base Layer

| First Metallic | | Ag | Ag | Ag | Ag | Ag | Ag | Ag | Ag | Ag | Ag | Ag | Ag | Ag | Ag | Ag | Ag | Ag |
|---|---|---|---|---|---|---|---|---|---|---|---|---|---|---|---|---|---|---|
| Layer | | | | | | | | | | | | | | | | | | |
| First | 1^{st} | Ti | Ti | Ti* | Ti* | Ti* | Ti | Ti | Ti | Ti | Ti | Ti | Ti | Ti | Ti | Ti | Ti | Ti |
| Pri- | Pri- | | | | | | | | | | | | | | | | | |
| mer | mer | | | | | | | | | | | | | | | | | |
| Layer | Film | | | | | | | | | | | | | | | | | |
| | 2^{nd} | Tin* | NiCr* | AZ | Tin | NiCr | — | — | — | — | — | — | — | — | — | — | — | — |
| | Pri- | | | | | | | | | | | | | | | | | |
| | mer | | | | | | | | | | | | | | | | | |
| | Film | | | | | | | | | | | | | | | | | |

Second Layer

| Second Metallic | | Ag | Ag | Ag | Ag | Ag | Ag | Ag | Ag | Ag | Ag | Ag | Ag | Ag | Ag | Ag | Ag | Ag |
|---|---|---|---|---|---|---|---|---|---|---|---|---|---|---|---|---|---|---|
| Layer | | | | | | | | | | | | | | | | | | |
| Second | 1^{st} | Ti | Ti | Ti | Ti | Ti | Ti | Ti | Ti | Ti* | Ti* | Ti* | Ti | Ti | Ti | | Ti | Ti |
| Pri- | Pri- | | | | | | | | | | | | | | | | | |
| mer | mer | | | | | | | | | | | | | | | | | |
| Layer | Film | | | | | | | | | | | | | | | | | |
| | 2^{nd} | — | — | — | — | — | AZ* | Tin* | NiCr* | AZ | Tin | NiCr | — | — | — | — | — | — |
| | Pri- | | | | | | | | | | | | | | | | | |
| | mer | | | | | | | | | | | | | | | | | |
| | Film | | | | | | | | | | | | | | | | | |

Third Layer

| Third Metallic | | Ag | Ag | Ag | Ag | Ag | Ag | Ag | Ag | Ag | Ag | Ag | Ag | Ag | Ag | Ag | Ag | Ag |
|---|---|---|---|---|---|---|---|---|---|---|---|---|---|---|---|---|---|---|
| Layer | | | | | | | | | | | | | | | | | | |
| Third | 1^{st} | Ti | Ti | Ti | Ti | Ti | Ti | Ti | Ti | Ti | Ti | Ti | Ti | Ti | Ti | Ti* | Ti* | Ti* |
| Pri- | Pri- | | | | | | | | | | | | | | | | | |
| mer | mer | | | | | | | | | | | | | | | | | |
| layer | Film | | | | | | | | | | | | | | | | | |
| | 2^{nd} | — | — | — | — | — | — | — | — | — | — | — | AZ* | Tin* | NiCr* | AZ | Tin | NiCr |
| | Pri- | | | | | | | | | | | | | | | | | |
| | mer | | | | | | | | | | | | | | | | | |
| | Film | | | | | | | | | | | | | | | | | |

Top Layer
Outermost Protective Coating

TABLE 6

| Ex. | Ex. | Ex. | Ex. | Ex | Ex. | Ex. | Ex. | Ex. | Ex. | Ex. | Ex. |
|---|---|---|---|---|---|---|---|---|---|---|---|
| 18 | 19 | 20 | 21 | 22 | 23 | 24 | 25 | 26 | 27 | 28 | 29 |

Base

| Fist Metallic | | Ag | Ag | Ag | Ag | Ag | Ag | Ag | Ag | Ag | Ag | Ag | Ag |
|---|---|---|---|---|---|---|---|---|---|---|---|---|---|
| Layer | | | | | | | | | | | | | |
| First | 1^{st} | Ti | Ti | Ti | Ti* | Ti* | Ti* | Ti | Ti | Ti | Ti | Ti | Ti |
| Pri- | Pri- | | | | | | | | | | | | |
| mer | mer | | | | | | | | | | | | |
| Layer | Film | | | | | | | | | | | | |
| | 2^{nd} | AZ* | Tin* | NiCr* | AZ | Tin | NiCr | — | — | — | — | — | — |
| | Pri- | | | | | | | | | | | | |
| | mer | | | | | | | | | | | | |
| | Film | | | | | | | | | | | | |

Second Layer

| Second | | Ag | Ag | Ag | Ag | Ag | Ag | Ag | Ag | Ag | Ag | Ag | Ag |
|---|---|---|---|---|---|---|---|---|---|---|---|---|---|
| Metallic | | | | | | | | | | | | | |
| Layer | | | | | | | | | | | | | |
| Second | 1^{st} | Ti | Ti | Ti | Ti | Ti | Ti | Ti | Ti | Ti | Ti* | Ti* | Ti* |
| Pri- | Pri- | | | | | | | | | | | | |
| mer | mer | | | | | | | | | | | | |
| Layer | Film | | | | | | | | | | | | |
| | 2^{nd} | — | — | — | — | — | — | AZ* | Tin* | NiCr* | AZ | Tin | NiCr |
| | Pri- | | | | | | | | | | | | |
| | mer | | | | | | | | | | | | |
| | Film | | | | | | | | | | | | |

Third Layer

| Third | | Ag | Ag | Ag | Ag | Ag | Ag | Ag | Ag | Ag | Ag | Ag | Ag |
|---|---|---|---|---|---|---|---|---|---|---|---|---|---|
| Metallic | | | | | | | | | | | | | |
| Layer | | | | | | | | | | | | | |
| Third | 1^{st} | Ti | Ti | Ti | Ti | Ti | Ti | Ti | Ti | Ti | Ti | Ti | Ti |
| Pri- | Pri- | | | | | | | | | | | | |
| mer | mer | | | | | | | | | | | | |
| Layer | Film | | | | | | | | | | | | |
| | 2^{nd} | — | — | — | — | — | — | — | — | — | — | — | — |
| | Pri- | | | | | | | | | | | | |
| | mer | | | | | | | | | | | | |
| | Film | | | | | | | | | | | | |

Fourth Layer

| Fourth | | Ag | Ag | Ag | Ag | Ag | Ag | Ag | Ag | Ag | Ag | Ag | Ag |
|---|---|---|---|---|---|---|---|---|---|---|---|---|---|
| Metallic | | | | | | | | | | | | | |
| Layer | | | | | | | | | | | | | |
| Fourth | 1^{st} | Ti | Ti | Ti | Ti | Ti | Ti | Ti | Ti | Ti | Ti | Ti | Ti |
| Pri- | Pri- | | | | | | | | | | | | |
| mer | mer | | | | | | | | | | | | |
| Layer | Film | | | | | | | | | | | | |
| | 2^{nd} | — | — | — | — | — | — | — | — | — | — | — | — |
| | Pri- | | | | | | | | | | | | |
| | mer | | | | | | | | | | | | |
| | Film | | | | | | | | | | | | |

Top Layer
Outermost Protective Layer

| | | | | | | | | | | | |
|---|---|---|---|---|---|---|---|---|---|---|---|
| Ex. | Ex. | Ex. | Ex. | Ex. | Ex. | Ex | Ex. | Ex. | Ex. | ER. | Ex |
| 30 | 31 | 32 | 33 | 34 | 35 | 36 | 37 | 38 | 39 | 40 | 41 |

Base

| Fist Metallic | | Ag | Ag | Ag | Ag | Ag | Ag | Ag | Ag | Ag | Ag | Ag | Ag |
|---|---|---|---|---|---|---|---|---|---|---|---|---|---|
| Layer | | | | | | | | | | | | | |
| First | 1^{st} | Ti | Ti | Ti | Ti | Ti | Ti | Ti | Ti | Ti | Ti | Ti | Ti |
| Pri- | Pri- | | | | | | | | | | | | |
| mer | mer | | | | | | | | | | | | |
| Layer | Film | | | | | | | | | | | | |
| | 2^{nd} | — | — | — | — | — | — | — | — | — | — | — | — |
| | Pri- | | | | | | | | | | | | |
| | mer | | | | | | | | | | | | |
| | Film | | | | | | | | | | | | |

Second Layer

| Second | | Ag | Ag | Ag | Ag | Ag | Ag | Ag | Ag | Ag | Ag | Ag | Ag |
|---|---|---|---|---|---|---|---|---|---|---|---|---|---|
| Metallic | | | | | | | | | | | | | |
| Layer | | | | | | | | | | | | | |
| Second | 1^{st} | Ti | Ti | Ti | Ti | Ti | Ti | Ti | Ti | Ti | Ti | Ti | Ti |
| Pri- | Pri- | | | | | | | | | | | | |
| mer | mer | | | | | | | | | | | | |
| Layer | Film | | | | | | | | | | | | |
| | 2^{nd} | — | — | — | — | — | — | — | — | — | — | — | — |
| | Pri- | | | | | | | | | | | | |
| | mer | | | | | | | | | | | | |
| | Film | | | | | | | | | | | | |

Third Layer

| Third Metallic | | Ag | Ag | Ag | Ag | Ag | Ag | Ag | Ag | Ag | Ag | Ag | Ag |
|---|---|---|---|---|---|---|---|---|---|---|---|---|---|
| Layer | | | | | | | | | | | | | |
| Third | 1^{st} | Ti | Ti | Ti | Ti | Ti | Ti | Ti | Ti | Ti | Ti | Ti | Ti |
| Pri- | Pri- | | | | | | | | | | | | |
| mer | mer | | | | | | | | | | | | |
| Layer | Film | | | | | | | | | | | | |
| | 2^{nd} | AZ* | Tin* | NiCr* | AZ | Tin | NiCr | — | — | — | — | — | — |
| | Pri- | | | | | | | | | | | | |
| | mer | | | | | | | | | | | | |
| | Film | | | | | | | | | | | | |

Fourth Layer

| Fourth | | Ag | Ag | Ag | Ag | Ag | Ag | Ag | Ag | Ag | Ag | Ag | Ag |
|---|---|---|---|---|---|---|---|---|---|---|---|---|---|
| Metallic | | | | | | | | | | | | | |
| Layer | | | | | | | | | | | | | |
| Fourth | 1^{st} | Ti | Ti | Ti | Ti | Ti | Ti | Ti | Ti | Ti | Ti | Ti | Ti |
| Pri- | Pri- | | | | | | | | | | | | |
| mer | mer | | | | | | | | | | | | |
| Layer | Film | | | | | | | | | | | | |
| | 2^{nd} | — | — | — | — | — | — | AZ* | Tin* | NiCr* | AZ | Tin | NiCr |
| | Pri- | | | | | | | | | | | | |
| | mer | | | | | | | | | | | | |
| | Film | | | | | | | | | | | | |

Top Layer
Outermost Protective Layer

It will be readily appreciated by those skilled in the art that modification may be made to the invention without departing from the concepts disclosed in the foregoing description. Accordingly, the particular embodiments described in detail herein are illustrative only and are not limiting to the scope of the invention, which is to be given the full breadth of the appended claims and any and all equivalents thereof.

What is claimed is:

1. A coated article comprising: a substrate comprising a first side comprising a first surface and a second side comprising a second surface, wherein the second surface is opposite the first surface; and a functional coating positioned over at least a portion of the second side, the functional coating comprising: a base layer positioned over at least a portion of the second surface; a metallic layer positioned over at least a portion of the base layer; a primer layer comprising a patterned feature positioned over at least a portion of the metallic layer, wherein the primer layer comprises: a first primer film positioned over at least a portion of the metallic layer, and a second primer film positioned over at least a portion of the first primer film, wherein one of the first primer film or the second primer film comprises the patterned feature; and a top layer positioned over at least a portion of the primer layer.

2. The coated article of claim 1, wherein the first primer film is selected from the group consisting of titanium, silicon, tin, silicon dioxide, silicon nitride, silicon oxynitride, nickel, zirconium, zinc, aluminum, cobalt, chromium, alloys thereof, and mixtures thereof, and wherein the second primer film is selected from the group consisting of titanium, silicon, tin, silicon dioxide, silicon nitride, silicon oxynitride, nickel, zirconium, zinc, aluminum, cobalt, chromium, alloys thereof, and mixtures thereof.

3. The coated article of claim 1, wherein when the first primer film comprises the patterned feature, the patterned feature of the first primer film comprises a thickness in a range of from 1 nm to 20 nm and the second primer film comprises a thickness in a range of from 0.5 nm to 10 nm, or wherein when the second primer film comprises the patterned feature, the first primer film comprises a thickness in a range of from 0.5 nm to 10 nm and the patterned feature of the second primer film comprises a thickness in the range of from 1 nm to 20 nm.

4. The coated article of claim 1, wherein the patterned feature is a symmetric pattern comprising stripes, or wherein the patterned feature is an asymmetric pattern.

5. The coated article of claim 1, wherein the functional coating further comprises an outermost protective coating comprising a protective layer positioned over at least a portion of the top layer, where the protective layer comprises at least one of Si₃N₄, SiAlN, SiAlON, SiAlO, TiAlO, titania, alumina, silica, zirconia, or combinations thereof.

6. The coated article of claim 1, wherein the patterned feature is visible to birds.

7. The coated article of claim 1, wherein the functional coating positioned over at least a portion of the second side comprises: the base layer positioned over at least a portion of the second surface; a first metallic layer positioned over at least a portion of the base layer; a first primer layer positioned over at least a portion of the first metallic layer; a second layer over at least a portion of the first primer layer; a second metallic layer over at least a portion of the second layer; and a second primer layer over at least a portion of the second metallic layer, wherein the top layer is over at least a portion of the second primer layer, wherein one of the first primer layer or the second primer layer comprises the patterned feature, the first primer film, and the second primer film, and wherein one of the first primer film or the second primer film comprises the patterned feature.

8. The coated article of claim 7, wherein the patterned feature is formed in the first primer layer positioned over at least a portion of the first metallic layer, wherein the first primer layer comprises the first primer film positioned over at least a portion of the first metallic layer and the second primer film positioned over at least a portion of the first primer film; wherein when the first primer film comprises the patterned feature, the patterned feature of the first primer film comprises a thickness in a range of from 1 nm to 20 nm and the second primer film comprises a thickness in a range of from 0.5 nm to 10 nm, or wherein when the second primer film comprises the patterned feature, the first primer film comprises a thickness in a range of from 0.5 nm to 10 nm and the patterned feature of the second primer film comprises a thickness in the range of from 1 nm to 20 nm.

9. The coated article of claim 7, wherein the patterned feature is formed in the second primer layer positioned over at least a portion of the second metallic layer, wherein the second primer layer comprises the first primer film positioned over at least a portion of the second metallic layer and the second primer film positioned over at least a portion of the first primer film; wherein when the first primer film comprises the patterned feature, the patterned feature of the first primer film comprises a thickness in a range of from 1 nm to 20 nm and the second primer film comprises a thickness in a range of from 0.5 nm to 10 nm, or wherein when the second primer film comprises the patterned feature, the first primer film comprises a thickness in a range of from 0.5 nm to 10 nm and the patterned feature of the second primer film comprises a thickness in the range of from 1 nm to 20 nm.

10. The coated article of claim 7, wherein the functional coating positioned over at least a portion of the second side further comprises: a third layer positioned over at least a portion of the second primer layer; a third metallic layer positioned over at least a portion of the third layer; and a third primer layer positioned over at least a portion of the third metallic layer, wherein the top layer is over at least a portion of the third primer layer, wherein one of the first primer layer, the second primer layer, or the third primer layer comprises the patterned feature, the first primer film, and the second primer film, and wherein one of first primer film or the second primer film comprises the patterned feature.

11. The coated article of claim 10, wherein the patterned feature is formed in the first primer layer positioned over at least a portion of the first metallic layer, wherein the first primer layer comprises the first primer film positioned over at least a portion of the first metallic layer and the second primer film positioned over at least a portion of the first primer film; wherein when the first primer film comprises the patterned feature, the patterned feature of the first primer film comprises a thickness in a range of from 1 nm to 20 nm and the second primer film comprises a thickness in a range of from 0.5 nm to 10 nm, or wherein when the second primer film comprises the patterned feature, the first primer film comprises a thickness in a range of from 0.5 nm to 10 nm and the patterned feature of the second primer film comprises a thickness in the range of from 1 nm to 20 nm.

12. The coated article of claim 10, wherein the patterned feature is formed in the second primer layer positioned over at least a portion of the second metallic layer, wherein the second primer layer comprises the first primer film positioned over at least a portion of the second metallic layer and the second primer film positioned over at least a portion of the first primer film; wherein when the first primer film comprises the patterned feature, the patterned feature of the first primer film comprises a thickness in a range of from 1 nm to 20 nm and the second primer film comprises a thickness in a range of from 0.5 nm to 10 nm, or wherein when the second primer film comprises the patterned feature, the first primer film comprises a thickness in a range of from 0.5 nm to 10 nm and the patterned feature of the second primer film comprises a thickness in the range of from 1 nm to 20 nm.

13. The coated article of claim 10, wherein the patterned feature is formed in the third primer layer positioned over at least a portion of the third metallic layer, wherein the third primer layer comprises the first primer film positioned over at least a portion of the third metallic layer and the second primer film positioned over at least a portion of the first primer film; wherein when the first primer film comprises the patterned feature, the patterned feature of the first primer film comprises a thickness in a range of from 1 nm to 20 nm and the second primer film comprises a thickness in a range of from 0.5 nm to 10 nm, or wherein when the second primer film comprises the patterned feature, the first primer film comprises a thickness in a range of from 0.5 nm to 10 nm and the patterned feature of the second primer film comprises a thickness in the range of from 1 nm to 20 nm.

14. The coated article of claim 10, wherein the functional coating positioned over at least a portion of the second side further comprises: a fourth layer positioned over at least a portion of the third primer layer; a fourth metallic layer positioned over at least a portion of the fourth layer; and a fourth primer layer positioned over at least a portion of the fourth metallic layer, wherein the top layer is over at least a portion of the fourth primer layer, wherein one of the first primer layer, the second primer layer, the third primer layer, or the fourth primer layer comprises the patterned feature, the first primer film, and the second primer film, and wherein one of the first primer film or the second primer film comprises the patterned feature.

15. The coated article of claim 14, wherein the patterned feature is formed in the first primer layer positioned over at least a portion of the first metallic layer, wherein the first primer layer comprises the first primer film positioned over at least a portion of the first metallic layer and the second primer film positioned over at least a portion of the first primer film; wherein when the first primer film comprises the patterned feature, the patterned feature of the first primer film comprises a thickness in a range of from 1 nm to 20 nm and the second primer film comprises a thickness in a range of from 0.5 nm to 10 nm, or wherein when the second primer film comprises the patterned feature, the first primer film comprises a thickness in a range of from 0.5 nm to 10 nm and the patterned feature of the second primer film comprises a thickness in the range of from 1 nm to 20 nm.

16. The coated article of claim 14, wherein the patterned feature is formed in the second primer layer positioned over at least a portion of the second metallic layer, wherein the second primer layer comprises the first primer film positioned over at least a portion of the second metallic layer and the second primer film positioned over at least a portion of the first primer film; wherein when the first primer film comprises the patterned feature, the patterned feature of the first primer film comprises a thickness in a range of from 1 nm to 20 nm and the second primer film comprises a thickness in a range of from 0.5 nm to 10 nm, or wherein when the second primer film comprises the patterned feature, the first primer film comprises a thickness in a range of from 0.5 nm to 10 nm and the patterned feature of the second primer film comprises a thickness in the range of from 1 nm to 20 nm.

17. The coated article of claim 14, wherein the patterned feature is formed in the third primer layer positioned over at least a portion of the third metallic layer, wherein the third primer layer comprises the first primer film positioned over at least a portion of the third metallic layer and the second primer film positioned over at least a portion of the first primer film; wherein when the first primer film comprises the patterned feature, the patterned feature of the first primer film comprises a thickness in a range of from 1 nm to 20 nm and the second primer film comprises a thickness in a range of from 0.5 nm to 10 nm, or wherein when the second primer film comprises the patterned feature, the first primer film comprises a thickness in a range of from 0.5 nm to 10 nm and the patterned feature of the second primer film comprises a thickness in the range of from 1 nm to 20 nm.

18. The coated article of claim 14, wherein the patterned feature is formed in the fourth primer layer positioned over at least a portion of the fourth metallic layer, wherein the fourth primer layer comprises the first primer film positioned over at least a portion of the fourth metallic layer and the second primer film positioned over at least a portion of the first primer film; wherein when the first primer film comprises the patterned feature, the patterned feature of the first primer film comprises a thickness in a range of from 1 nm to 20 nm and the second primer film comprises a thickness in a range of from 0.5 nm to 10 nm, or wherein when the second primer film comprises the patterned feature, the first primer film comprises a thickness in a range of from 0.5 nm to 10 nm and the patterned feature of the second primer film comprises a thickness in the range of from 1 nm to 20 nm.

19. A method of making a coated article, the method comprising: providing a substrate comprising a first side comprising a first surface and a second side comprising a second surface, wherein the second surface is opposite the first surface; and forming a functional coating over at least a portion of the second side, wherein forming the functional coating comprises: forming a base layer over at least a portion of the second surface; forming a metallic layer over at least a portion of the base layer; forming a primer layer comprising a patterned feature over at least a portion of the metallic layer, wherein forming the primer layer comprises: forming a first primer film over at least a portion of the metallic layer, and forming a second primer film over at least a portion of the first primer film, wherein one of the first primer film or the second primer film comprises the patterned feature; and forming a top layer over at least a portion of the metallic layer.

20. An insulating glass unit comprising: a first ply comprising a first side comprising a No. 1 surface and a second side comprising a No. 2 surface, wherein the No. 2 surface is opposite the No. 1 surface; a second ply comprising a first side comprising a No. 3 surface and a second side comprising a No. 4 surface, wherein the No. 4 surface opposite the No. 3 surface, wherein the first ply and second ply are connected together; and a functional coating positioned over at least a portion of the second side comprising the No. 2 surface, the functional coating comprising: a base layer positioned over at least a portion of the No. 2 surface; a metallic layer positioned over at least a portion of the base layer; a primer layer comprising a patterned feature positioned over at least a portion of the metallic layer, wherein the primer layer comprises: a first primer film positioned over at least a portion of the metallic layer, and a second primer film positioned over at least a portion of the first primer film, wherein one of the first primer film or the second primer film comprises the patterned feature; and a top layer positioned over at least a portion of the metallic layer.
